(19) United States
(12) Patent Application Publication
(10) Pub. No.: US 2026/0162556 A1
(43) Pub. Date: Jun. 11, 2026

(54) SYSTEMS, METHODS, AND STORAGE MEDIA FOR CREATING AND MANAGING AN ARTIFICIAL INTELLIGENCE (AI) EDUCATIONAL GUIDANCE SYSTEM USING A COMPUTING PLATFORM

(71) Applicant: Knowledge Factor Inc., Boulder, CO (US)

(72) Inventors: Matthew Jensen Hays, Los Angeles, CA (US); Nicholas Hjort, Parker, CO (US); Robert Keele Burgin, Boulder, CO (US); Charles J. Smith, Encinitas, CA (US)

(73) Assignee: Knowledge Factor Inc., Boulder, CO (US)

(21) Appl. No.: 18/974,074

(22) Filed: Dec. 9, 2024

(51) Int. Cl. G09B 7/12; G09B 7/077

(52) U.S. Cl. CPC G09B 7/12; G09B 7/077

(57) ABSTRACT

The present disclosure is broadly directed to an Artificial Intelligence (AI) based educational guidance system that is configured to employ cognitive scientific learning principles for assisting and guiding learners by enhancing their long-term retention of educational material and/or enhancing their ability to transfer their understanding to new applications, situations, and/or educational scenarios. In some embodiments, the AI-based educational guidance system may be implemented as a conversational educational platform (e.g., chatbot-enhanced educational platform) and/or digital tutor, where the digital tutor may be used to supplement or entirely replace a human tutor. Additionally, or alternatively, the AI-based educational guidance system may be configured for use with an electronic-learning (e-learning) system. The disclosed AI-based educational guidance system may be implemented in hardware, software, or a combination thereof.

### FIELD OF THE DISCLOSURE

The present disclosure generally relates to an Artificial Intelligence (AI) educational guidance system implemented using a computing platform. More specifically, but without limitation, the present disclosure relates to systems, methods, and storage media for creating and managing an AI educational guidance system using a computing platform.

### BACKGROUND

Educational experiences can vary in many ways. For example, one tennis instructor could choose to provide immediate feedback to a trainee after each swing of the racquet. Another instructor could choose to wait until the student has made several swings, then provide summarized feedback about the student's technique. The above example concerns a single element of an educational experience: the timing of feedback. Researchers in the fields of cognitive science, cognitive psychology, and education have discovered optimal practices for many such elements. Delayed and summarized feedback, for example, is ultimately better than immediate feedback for improving one's tennis game.

Unfortunately, most people are unaware of such optimal teaching practices because they are often unintuitive to students and instructors. As a result, even as technology has improved, educational practice has often remained sub-optimal. Much of the work in the field of digital tutoring systems, for example, consists of adapting to a learner, but the adaptation is often based on the systems'developers'intuition regarding how learning works. In other words, currently used e-learning systems and learning management systems (LMSs) frequently suffer the same deficiencies as older, less technologically advanced educational solutions (e.g., educational videos, lecture slides, textbooks) because they generally tend to favor popular sub-optimal learning techniques over unintuitive optimal learning principles.

Recent technological advances in the field of generative artificial intelligence (generative AI or genAI) promise to improve education by being able to serve as a digital, adaptive, one-on-one instructor, coach, and tutor for any learner on any topic. Given input (e.g., chat messages, spoken questions, screenshares, pictures, live webcam video, etc.) from a learner, genAI can create relevant, appropriate responses that help a learner understand the topic under discussion.

To achieve this capability, genAI is exposed to (i.e., trained on) large corpuses of material, including educational material (e.g., textbooks, explanatory webpages, lecture notes, encyclopedias, course readers, academic journal articles, etc.). Statistical patterns in that material (e.g., what word is most likely to occur next, given the sequence of words that came before it along with other contextual information) inform the underlying model the AI uses to produce novel output (e.g., text descriptions, spoken explanations, illustrative images, etc.).

But because most historical/extant educational material is structured around the use of suboptimal learning principles, genAI models can suffer the same deficiencies prevalent in their training datasets (e.g., textbooks that mass topics rather than spacing them; quizzes that immediately display the correct answer after the user has answered the question; passive video- and/or slideshow-based training experiences; online forum posts that describe “cramming” study material the night before an examination; educational courses that simply display answers to questions without imploring the user to consider their answer choice, for instance, by asking a different but related question, to name a few non-limiting examples). Thus, in some aspects, the high prevalence of suboptimal learning techniques in classrooms, slideshows, books, etc., prevents genAI from creating optimal educational interactions. Instead, genAI inherently gravitates towards more popular and well-known, albeit misguided and suboptimal, teaching and learning techniques. That is, typically, generative-AI-based education platforms imitate the sub-optimal teaching and learning principles that are so prevalent in their datasets. Thus, a refined genAI system is needed—one that is constrained to employ optimal learning principles and use their application to each learner's experience to dynamically modify how it educates.

The description provided in the background section should not be assumed to be prior art merely because it is mentioned in or associated with the background section. The background section may include information that describes one or more aspects of the subject technology.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

As used herein, the terms “AI,” “AI/LLM,” “genAI,” and/or “generative AI” may be used interchangeably throughout the disclosure.

As used herein, the terms “learning management system,” “LMS”, “digital instruction tools”, “electronic learning system”, “e-learning system”, and/or “digital tutoring system” may be used interchangeably throughout the disclosure.

Furthermore, the terms “learner”, “user”, and/or “student” may be used interchangeably throughout the disclosure. In some cases, the term “user” may alternatively be used to refer to an instructor, a teacher, a professor, and/or a tutor.

Additionally, the terms “user device”, user equipment”, “UE”, “mobile device”, “personal computing device”, “computing device”, “computing platform”, and/or “remoting computing platform” may be used interchangeably throughout the disclosure.

As noted above, currently used LMSs, digital instructional tools, and/or Artificial Intelligence (AI) based learning platforms, may simply do what a human instructor and a human learner expects, despite that behavior being sub-optimal for learning. In some regards, currently used computer-based learning platforms often approach the task (i.e., teaching or learning) in the same way a human would. Currently used LMSs can provide input and guidance to a learner that makes the learner feel like they are learning optimally, which may be misguided. Said another way, the ease or fluency with which information comes to a learner's mind is often not indicative of the learner's true grasp of the educational material. In some aspects, currently used digital instructional tools or LMSs may give learners a false sense of their grasp of the educational material. Research has shown that this feeling of fluency does not predict long-term retention, nor the ability to transfer knowledge to other applications. In fact, the feeling of fluency during learning is often counterproductive to those goals.

Additionally, existing electronic learning platforms often aim to improve a learner's performance during training. Unfortunately, conditions of training that are focused on rapid improvements typically do not produce long-lasting, generalizable learning. As a result, learners and instructors alike are misled into sacrificing long-term learning for immediate gains. For example, they sequence instruction or practice on a topic so that it is massed (e.g., devoting a study session to a single topic) rather than spaced and interleaved (e.g., shuffling together study on multiple topics over multiple sessions). Indeed, the table of contents of any textbook demonstrates that massed practice is the default for arranging instruction-even cognitive psychology textbooks that themselves report on the superiority of spacing over massing.

For decades, scientists have lamented the underutilization of unintuitive but powerful educational practices. In many cases, the superior educational approach simply never occurs to the teacher (or the learner). That is, it is not that both options are considered, and the sub-optimal one is selected. Instead, the sub-optimal approach often seems to be the only possible approach. Indeed, the optimal approach is often so counterintuitive that even the firsthand experience of its benefit is not enough to convince learners it is superior. As a result, neither human instructors nor software-based instructional tools typically employ unintuitive but well-established cognitive scientific learning principles.

Some aspects of the present disclosure are directed to an Artificial Intelligence (AI) based educational guidance system that is configured to employ counterintuitive principles of cognitive science (or cognitive scientific learning principles) that may help learners enhance their long-term retention of educational material and/or enhance their ability to transfer their understanding to new applications and situations. In some embodiments, the AI-based educational guidance system may be implemented as a conversational educational platform (e.g., chatbot-enhanced educational platform) and digital tutor. Additionally, or alternatively, the AI-based educational guidance system may be configured for use with an electronic-learning (e-learning) system.

In some aspects, the techniques described herein relate to an AI educational guidance system, including: one or more hardware processors configured by machine-readable instructions to: receive a plurality of user datasets from a user device, wherein the plurality of user datasets includes at least a first user dataset, and wherein each of the plurality of user datasets is related to: (1) a direct user input to a conversational educational agent, (2) or a user interaction with a user interface (UI) associated with an electronic learning (e-learning) system, wherein the e-learning system is configured to measure a user's confidence level. In some implementations, the one or more hardware processors are configured by machine-readable instructions to access a plurality of rulesets, wherein at least one of the plurality of rulesets is associated with at least one cognitive scientific learning principle, and wherein the at least one cognitive scientific learning principle includes one or more of: a spacing effect, a pretesting effect, a delayed corrective feedback effect, a retrieval practice effect, an interleaving effect, and a generation effect. Furthermore, the one or more hardware processors are configured by machine-readable instructions to apply one or more of the plurality of rulesets to one or more of the plurality of user datasets and generate a first personalized response, wherein generating the first personalized response is based on applying at least one ruleset associated with at least one cognitive scientific learning principle to the first user dataset. In some implementations of the AI educational guidance system, the first personalized response is associated with the first user dataset and the at least one ruleset applied to the first user dataset. In some implementations, the one or more hardware processors are further configured to transmit the first personalized response to the user device.

In some aspects, the techniques described herein relate to the AI educational guidance system, wherein the one or more hardware processors are further configured to receive a plurality of data inputs, wherein each of the plurality of data inputs includes one of an educational-content-specific dataset or a learner-specific dataset.

In some aspects, the techniques described herein relate to the AI educational guidance system, wherein the one or more hardware processors are further configured to: apply the at least one ruleset applied to the first user dataset to at least one of the plurality of data inputs; and wherein the first personalized response is associated with one or more of the educational-content-specific dataset or the learner-specific dataset.

In some aspects, the techniques described herein relate to the AI educational guidance system, wherein each educational-content-specific dataset includes content data and analytics information for an educational course or educational module, the content data and analytics information including one or more of: learning material for the educational course or educational module, a difficulty level for the educational course or educational module, a difficulty level per learner module for one or more learner modules associated with the educational course or educational module, a difficulty level per question for one or more questions associated with the educational course or educational module, a difficulty level per quiz for one or more quizzes associated with the educational course or educational module, submission time per question for one or more first-time users of the educational course or educational module, and submission time per question for one or more repeat users of the educational course or educational module.

In some aspects, the techniques described herein relate to the AI educational guidance system, wherein each learner-specific dataset includes information related to one or more of: a learner history for a user associated with the user device, a user interaction history for the user with one or more of the UI, the e-learning system, and the AI educational guidance system.

In some aspects, the techniques described herein relate to the AI educational guidance system, wherein the one or more hardware processors are further configured to: generate a second personalized response associated with a second user dataset, wherein the first personalized response and the second personalized response are associated with different rulesets of the plurality of rulesets.

In some aspects, the techniques described herein relate to the AI educational guidance system, wherein receiving the plurality of user datasets includes receiving a second user dataset, and wherein the one or more hardware processors are further configured by machine-readable instructions to: apply one or more rulesets to the second user dataset; and suppress generating a personalized response in response to applying the one or more rulesets to the second user dataset.

In some aspects, the techniques described herein relate to the AI educational guidance system, wherein, the plurality of user datasets includes the first user dataset and a second user dataset. In some implementations, one of the first or the second user dataset is related to a user interaction with the UI associated with the e-learning system, while the other one of the first or the second user dataset is related to a direct user input to the conversational educational agent. In some implementations, the user interaction with the UI associated with the e-learning system includes a user making at least one selection on the user device, and the direct user input includes one of: a text input or textual input from the user device, an audio input from the user device, a video input from the user device, or a screenshare from the user device.

In some aspects, the techniques described herein relate to the AI educational guidance system, wherein the user device is associated with a user, and wherein the user is one of a new user or a repeat user, and wherein each of the plurality of user datasets is associated with one of: the user responding to a question; or the user answering a question; or the user incorrectly answering a question; or the user correctly answering a question; or the user submitting an answer to a question; or the user providing a self-assessed confidence level for an answer choice selected by the user; or the user providing a self-assessed confidence level for a set of answer choices selected by the user; or the user providing an off-topic input, wherein the off-topic input is unrelated to one or more of a learning module displayed on the user device, a question displayed on the user device, a pre-defined topic, and the e-learning system.

In some aspects, the techniques described herein relate to the AI educational guidance system, wherein, when the first user dataset is associated with a new user accessing a learning module, the first personalized response is associated with a first ruleset, and when the first user dataset is associated with a repeat user accessing a learning module, the first personalized response is associated with a second ruleset different from the first ruleset.

In some aspects, the techniques described herein relate to the AI educational guidance system, wherein, when the first user dataset is associated with a user incorrectly answering a question, the first personalized response is associated with a first ruleset, and when the first user dataset is associated with a user correctly answering a question, the first personalized response is associated with a second ruleset different from the first ruleset.

In some aspects, the techniques described herein relate to the AI educational guidance system, wherein the first user dataset is associated with the user's response to the question, and a second user dataset is associated with the self-assessed confidence level provided by the user, based on the user's response to the question, and wherein the one or more hardware processors are further configured to: compare the user's response to a correct response for the question, wherein: a first ruleset is applied to the first user dataset based on determining that the user's response matches the correct response for the question; or a second ruleset, different from the first ruleset, is applied to the first user dataset based on determining that the user's response does not match the correct response; compare the self-assessed confidence level provided by the user to a confidence level threshold; and access one of: a third ruleset, based on determining that the self-assessed confidence level is below the confidence level threshold, or a fourth ruleset, different from the third ruleset, based on determining that the self-assessed confidence level is at or above the confidence level threshold; and wherein the first personalized response is further associated with the second user dataset associated with the self-assessed confidence level provided by the user, and: one of the first ruleset or the second ruleset; and one of the third ruleset or the fourth ruleset.

In some aspects, the techniques described herein relate to the AI educational guidance system, wherein, when the first dataset is associated with the off-topic input, the first personalized response is associated with a ruleset for re-engaging a learner.

In some aspects, the techniques described herein relate to the AI educational guidance system, wherein the first user dataset includes timestamp data.

In some aspects, the techniques described herein relate to the AI educational guidance system, wherein the timestamp data is associated with a user requesting feedback on educational content within a threshold duration of accessing the educational content, and wherein the at least one cognitive scientific learning principle associated with the first personalized response includes one or more of the delayed corrective feedback effect and the spacing effect.

In some aspects, the techniques described herein relate to the AI educational guidance system, wherein the one or more hardware processors are further configured to: compare the timestamp data to a user disengagement threshold duration; and access, based on the comparing, a first ruleset for re-engaging the learner, wherein the first personalized response is associated with the first ruleset.

In some aspects, the techniques described herein relate to the AI educational guidance system, wherein measuring the user confidence level is based at least in part on assessing one or more of: a plurality of user interactions with educational content displayed via the UI on the user device, and wherein the educational content includes one or more questions associated with one or more courses or modules; and one or more direct user inputs to the conversational educational agent.

In some aspects, the techniques described herein relate to the AI educational guidance system, wherein generating the first personalized response includes: generating an AI prompt, wherein generating the AI prompt includes providing one or more constraints to an AI module; and generating the first personalized response using the one or more constraints.

In some aspects, the techniques described herein relate to the AI educational guidance system, wherein at least one constraint of the plurality of constraints is associated with a cognitive scientific learning principle.

In some aspects, the techniques described herein relate to the AI educational guidance system, wherein generating the first personalized response includes: generating an AI prompt, wherein generating the AI prompt includes providing one or more constraints to an AI module, wherein at least one constraint of the plurality of constraints is associated with a cognitive scientific learning principle; receiving, from the AI module, one or more intermediary responses for the one or more constraints; and utilizing the one or more intermediary responses to generate the first personalized response.

In some aspects, the techniques described herein relate to the AI educational guidance system, wherein the one or more intermediary responses include a plurality of intermediary responses, and wherein the one or more hardware processors are further configured to: concatenate the plurality of intermediary responses to generate the first personalized response.

In some aspects, the techniques described herein relate to the AI educational guidance system, wherein generating the first personalized response is further based at least in part on receiving one or more of: analytics data for one or more of a question, a quiz, a topic, an educational module, an educational course, a practice assignment, and a practice exam; interaction history data for a user associated with the user device; learner history data for the user associated with the user device; and a UI-understanding level of the user, wherein the UI-understanding level comprises or includes a quantitative score corresponding to the user's comprehension level of the user with one or more UI elements of the UI associated with the e-learning system (i.e., UI-understanding level comprises a quantitative score corresponding to the comprehension level of the user.

In some aspects, the techniques described herein relate to a computer-implemented method for guiding learning using cognitive scientific learning principles, the computer-implemented method including: receiving a plurality of user datasets from a user device, wherein the plurality of user datasets includes at least a first user dataset, and wherein each of the plurality of user datasets is related to: a direct user input to a conversational educational agent; or a user interaction with a user interface (UI) associated with an electronic learning (e-learning) system, wherein the e-learning system is configured to measure a user's confidence level; accessing a plurality of rulesets, wherein at least one of the plurality of rulesets is associated with at least one cognitive scientific learning principle, and wherein the at least one cognitive scientific learning principle include one or more of: a spacing effect, a pretesting effect, a delayed corrective feedback effect, a retrieval practice effect, an interleaving effect, and a generation effect; applying one or more of the plurality of rulesets to one or more of the plurality of user datasets; generating a first personalized response, wherein generating the first personalized response is based on applying at least one ruleset associated with at least one cognitive scientific learning principle to the first user dataset, and wherein the first personalized response is associated with the first user dataset and the at least one ruleset applied to the first user dataset; and transmitting the first personalized response to the user device, wherein transmitting the first personalized response includes displaying the first personalized response on the user device.

In some aspects, the techniques described herein relate to a computer-implemented method, wherein the user device is associated with a user, and wherein the user is one of a new user or a repeat user, and wherein each of the plurality of user datasets is associated with one of: the user responding to a question; or the user answering a question; or the user incorrectly answering a question; or the user correctly answering a question; or the user submitting an answer to a question; or the user providing a self-assessed confidence level for an answer choice selected by the user; or the user providing a self-assessed confidence level for a set of answer choices selected by the user; or the user providing an off-topic input, wherein the off-topic input is unrelated to one or more of a learning module displayed on the user device, a question displayed on the user device, a pre-defined topic, and the e-learning system.

In some aspects, the techniques described herein relate to a computer-implemented method, wherein the first user dataset is associated with the user's response to the question, and a second user dataset is associated with the self-assessed confidence level provided by the user, based on the user's response to the question, and wherein the computer-implemented method further includes: comparing the user's response to a correct response for the question, wherein: a first ruleset is applied to the first user dataset based on determining that the user's response matches the correct response for the question; or a second ruleset, different from the first ruleset, is applied to the first user dataset based on determining that the user's response does not match the correct response; comparing the self-assessed confidence level provided by the user to a confidence level threshold; and accessing one of: a third ruleset, based on determining that the self-assessed confidence level is below the confidence level threshold, or a fourth ruleset, different from the third ruleset, based on determining that the self-assessed confidence level is at or above the confidence level threshold; and wherein the first personalized response is further associated with the second user dataset associated with the self-assessed confidence level provided by the user, and: one of the first ruleset or the second ruleset; and one of the third ruleset or the fourth ruleset.

In some aspects, the techniques described herein relate to a computer-implemented method, wherein, when the first user dataset is associated with a user incorrectly answering a question, the first personalized response is associated with a first ruleset, and when the first user dataset is associated with a user correctly answering a question, the first personalized response is associated with a second ruleset different from the first ruleset.

In some aspects, the techniques described herein relate to a computer-implemented method, wherein the first user dataset includes timestamp data, wherein the timestamp data is associated with a user requesting feedback on educational content within a threshold duration of accessing the educational content, and wherein the at least one cognitive scientific learning principle associated with the first personalized response includes one or more of the delayed corrective feedback effect and the spacing effect.

In some aspects, the techniques described herein relate to a computer-implemented method, wherein generating the first personalized response is further based on: generating an Artificial Intelligence (AI) prompt, wherein generating the AI prompt includes providing a plurality of constraints to an AI module, wherein at least one constraint of the plurality of constraints is associated with a cognitive scientific learning principle; and utilizing one or more of the plurality of constraints, including the at least one constraint associated with the cognitive scientific learning principle, to generate the first personalized response.

In some aspects, the techniques described herein relate to a computer-implemented method, wherein generating the first personalized response is further based at least in part on receiving one or more of: analytics data for one or more of a question, a quiz, a topic, an educational module, an educational course, a practice assignment, and a practice exam; interaction history data for a user with the e-learning system or an AI guidance system; learner history data for the user associated with the user device; and a UI-understanding level of the user, wherein the UI-understanding level includes a quantitative score corresponding to the user's comprehension level of one or more UI elements of the UI associated with the e-learning system.

In some aspects, the techniques described herein relate to a non-transient computer-readable storage medium having instructions embodied thereon, the instructions being executable by one or more processors to perform a method for guiding learning using an Artificial Intelligence (AI) guidance system employing cognitive scientific learning principles, the method including: receiving a plurality of user datasets from a user device, wherein the plurality of user datasets includes at least a first user dataset, and wherein each of the plurality of user datasets is related to: a direct user input to a conversational educational agent; or a user interaction with a user interface (UI) associated with an electronic learning (e-learning) system, wherein the e-learning system is configured to measure a user confidence level; accessing a plurality of rulesets, wherein at least one of the plurality of rulesets is associated with at least one cognitive scientific learning principle, and wherein the at least one cognitive scientific learning principle include one or more of: a spacing effect, a pretesting effect, a delayed corrective feedback effect, a retrieval practice effect, an interleaving effect, and a generation effect; applying one or more of the plurality of rulesets to one or more of the plurality of user datasets; generating a first personalized response, wherein generating the first personalized response is based on applying at least one ruleset associated with at least one cognitive scientific learning principle to the first user dataset, and wherein the first personalized response is associated with the first user dataset and the at least one ruleset applied to the first user dataset; and transmitting the first personalized response to the user device, wherein transmitting the first personalized response includes displaying the first personalized response on the user device.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a high-level block diagram of an Artificial Intelligence (AI) educational guidance system implemented using a computing platform, in accordance with various aspects of the disclosure.

FIG. 2A illustrates an example of a process flow associated with the AI educational guidance system in FIG. 1, where the AI educational guidance system is configured to be used with an electronic learning (e-learning) system, in accordance with various aspects of the disclosure.

FIG. 2B illustrates another example of a process flow associated with the AI educational guidance system in FIG. 1, in accordance with various aspects of the disclosure.

FIG. 3 illustrates an example of a method implemented using the AI educational guidance system in FIG. 1, in accordance with various aspects of the disclosure.

FIG. 4 illustrates another example of a method implemented using the AI educational guidance system in FIG. 1, in accordance with various aspects of the disclosure.

FIG. 5 illustrates a block diagram of a behavior classifier module of an AI educational guidance system, as well as some examples of data inputs that can be provided to the behavior classifier module, in accordance with various aspects of the disclosure.

FIG. 6 illustrates an example of a process flow implemented using the AI educational guidance system in FIG. 1, in accordance with various aspects of the disclosure.

FIG. 7 illustrates an example of a computer-implemented method for guiding learning using cognitive scientific learning principles, in accordance with various aspects of the disclosure.

FIG. 8 illustrates a block diagram showing an AI rules module and a response guidance module, as well as some example data inputs for each of the AI rules module and the response guidance module, in accordance with various aspects of the disclosure.

FIG. 9 illustrates an example of a process flow for an AI educational guidance system, where the process flow is associated with the generation of a solicited personalized response, in accordance with various aspects of the disclosure.

FIG. 10 illustrates an example of a process flow for an AI educational guidance system, where the AI educational guidance system utilizes a plurality of AI modules, one per front-end state, in accordance with various aspects of the disclosure.

FIG. 11 illustrates an example of a process flow for an AI educational guidance system, where the process flow is associated with the generation of an unsolicited personalized response, in accordance with various aspects of the disclosure.

FIG. 12 illustrates an example of a process flow for an AI educational guidance system, such as the system in FIG. 1, in accordance with various aspects of the disclosure.

FIG. 13 illustrates an example of a process flow for an AI educational guidance system, such as the system in FIG. 1, in accordance with various aspects of the disclosure.

FIG. 14 illustrates a diagrammatic representation of a computer system configured for use with an Artificial Intelligence (AI) educational guidance system, in accordance with various aspects of the disclosure.

FIG. 15A illustrates another example of a computer-implemented method for guiding learning using cognitive scientific learning principles, in accordance with various aspects of the disclosure.

FIG. 15B illustrates another example of a computer-implemented method for guiding learning using cognitive scientific learning principles, in accordance with various aspects of the disclosure.

FIG. 16 illustrates a block diagram of an AI architecture that can be utilized to implement the AI educational guidance system described in relation to at least FIG. 1, in accordance with various aspects of the disclosure.

FIG. 17 illustrates an example of a system employing the AI architecture described in relation to FIG. 16, in accordance with various aspects of the disclosure.

FIG. 18 illustrates an example of a user interface (UI) associated with the AI educational guidance system described in relation to at least FIG. 1, in accordance with various aspects of the disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The words “for example” is used herein to mean “serving as an example, instant, or illustration.” Any embodiment described herein as “for example” or any related term is not necessarily to be construed as preferred or advantageous over other embodiments. Additionally, a reference to a “device”, “computing device”, “user device”, or “mobile device” is not meant to be limiting to a single such device. It is contemplated that numerous devices may comprise a single “device” as described herein.

The embodiments described below are not intended to limit the disclosure to the precise form disclosed, nor are they intended to be exhaustive. Rather, the embodiment is presented to provide a description so that others skilled in the art may utilize its teachings. Technology continues to develop, and elements of the described and disclosed embodiments may be replaced by optimized and enhanced items, however, the teaching of the present disclosure inherently discloses elements used in embodiments incorporating technology available at the time of this disclosure.

The detailed descriptions which follow are presented in part in terms of algorithms and symbolic representations of operations on data within a computer memory wherein such data often represents numerical quantities, alphanumeric characters or character strings, logical states, data structures, or the like. A computer generally includes one or more processing mechanisms for executing instructions, and memory for storing instructions and data.

When a general-purpose computer has a series of machine-specific encoded instructions stored in its memory, the computer executing such encoded instructions may become a specific type of machine, namely a computer particularly configured to perform the operations embodied by the series of instructions. Some of the instructions may be adapted to produce signals that control operation of other machines and thus may operate through those control signals to transform materials or influence operations far removed from the computer itself. These descriptions and representations are the means used by those skilled in the data processing arts to convey the substance of their work most effectively to others skilled in the art.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are often described in terms, such as comparing, sorting, selecting, or adding, which are commonly associated with mental operations performed by a human operator. However, it should be understood that these terms are employed to provide a clear description of an embodiment of the present disclosure, and no such human operator is required or necessary. In fact, most, if not all, of the operations and processes described in this disclosure are even capable of being performed by a human operator.

This requirement for machine implementation for the practical application of the algorithms is understood by those persons of skill in this art as not a duplication of human thought, rather as significantly more than such human capability. Useful machines for performing the operations of one or more embodiments of the present disclosure include general purpose digital computers or other similar devices. In all cases, the distinction between the method operations in operating a computer and the method of computation itself should be recognized. One or more embodiments of the present disclosure relate to methods and apparatus for operating a computer in processing electrical or other (e.g., mechanical, chemical) physical signals to generate other desired physical manifestations or signals. The computer operates on software modules, which are collections of signals stored on a non-transient computer-readable storage medium that represent a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, where some aspects of the algorithm are performed by the circuitry itself rather than as a result of an instruction.

Some embodiments of the present disclosure rely on an apparatus for performing disclosed operations. This apparatus may be specifically constructed for the required purposes, or it may comprise a general purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. The required structure for a variety of these machines will be apparent from the description below.

In the following description, several terms which are used frequently have specialized meanings in the present context.

In the description of embodiments herein, frequent use is made of the terms “server”, “client”, and “client/server architecture”. In this context, each of a server and client is an instantiation of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that the client (e.g., user device) and server perform distinct, but complementary functions to accomplish a task or provide a service (e.g., AI-based educational guidance system that constrains AI to employ one or more established cognitive scientific learning principles, which can help enhance user learning by implementing learning techniques, such as, but not limited to, spacing effect, corrective delayed feedback effect, interleaving effect, etc.). The client and server accomplish this by exchanging data (e.g., user datasets), messages (e.g., personalized responses, such as unsolicited personalized responses and/or solicited responses), and often state information (e.g., user or learner interaction history with the system) using a computer network, or multiple networks. It should be appreciated that in a client/server architecture for distributed computing, there are typically multiple servers and multiple clients (e.g., user devices, which may be configured to connect to the internet using wired and/or wireless communication technologies), and they do not map to each other and further there may be more servers than clients or more clients than servers. A server is typically designed to interact with multiple clients (e.g., client devices, mobile devices, user devices, tablet computers, UEs). In some cases, the system of the present disclosure may be configured to support (or be used with) client devices utilizing different communication protocols (e.g., mobile data, mobile hotspot, ethernet, Wi-Fi, or any other communication protocols known or contemplated in the art), different operating systems and/or different versions of operating systems (e.g., Windows 11, Windows 10, Android, iOS, mac OS, MAC OS X, different variants of Linux, Ubuntu, and different variants of Operating Systems that are specific to tablets). Additionally, client devices may or may not include a video camera and/or an audio input device (e.g., microphone, headset, or earbuds with a built-in microphone), but the system may nonetheless be compatible with a wide range of client devices known or contemplated in the art.

In some cases, the system may be configured to receive user datasets in the form of a verbal message, a video feed from a camera of the user device, or a combination thereof. In some cases, the system 100 may be designed to allow learners with hearing, visual, and/or speech impediments to use the system by supporting features that can help enhance their user experience, as compared to prior art systems. For instance, the AI educational guidance system 100 may implement a speech-to-text module that can allow a user to into a microphone embedded within, or connected to, the mobile device. The audio input received from the user device may be converted from audio signals to text, where parsing the audio signals may involve isolating the frequencies and respective amplitudes (e.g., loudness level per frequency or range of frequencies) detected in the speech, data processing of the raw audio waveform using fast Fourier Transformations (FFT) to generate a spectrogram, applying one or more acoustic models to assist in reducing real-time performance, enhancing accuracy (e.g., reducing false positives or false negatives), and/or optimizing computing and processor performance by helping reduce the memory size needed to perform the same or even more complex calculations compared to the prior art. In some cases, the AI educational guidance system may also provide the user or learner with an intro module that asks the user to pronounce certain words, for instance, to gauge the user's accent, accurately identify the same word in different accents (e.g., in British English, the ‘t’ in water has a ‘t’ sound, whereas in American English, the ‘t’ sounds more like a ‘d’; aluminium in British English vs aluminum in American English). In some instances, the output of the acoustic models may be fed into a decoder and a language model, where the decoder and language models may be implemented as a single unit or separate units that are electrically, logically, and/or communicatively coupled to each other. Some non-limiting examples of decoders include beam search and greedy decoders, and some non-limiting examples of language models include n-gram language and neural scoring. Decoders may assist in generating top/most relevant words, which are then passed to the language models to predict the sentence within the audio signal. Similarly, in some embodiments, the AI educational guidance system 100 may be configured to assess a user's facial expressions (e.g., to determine an engagement level, a tiredness or sleepiness level), body language (e.g., is the user fidgeting a lot, which may be a sign of stress), and/or sign language (e.g., American Sign Language or ASL), which can further enhance user experience, as compared to the prior art.

In networks, bi-directional data communication (i.e., traffic) often occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

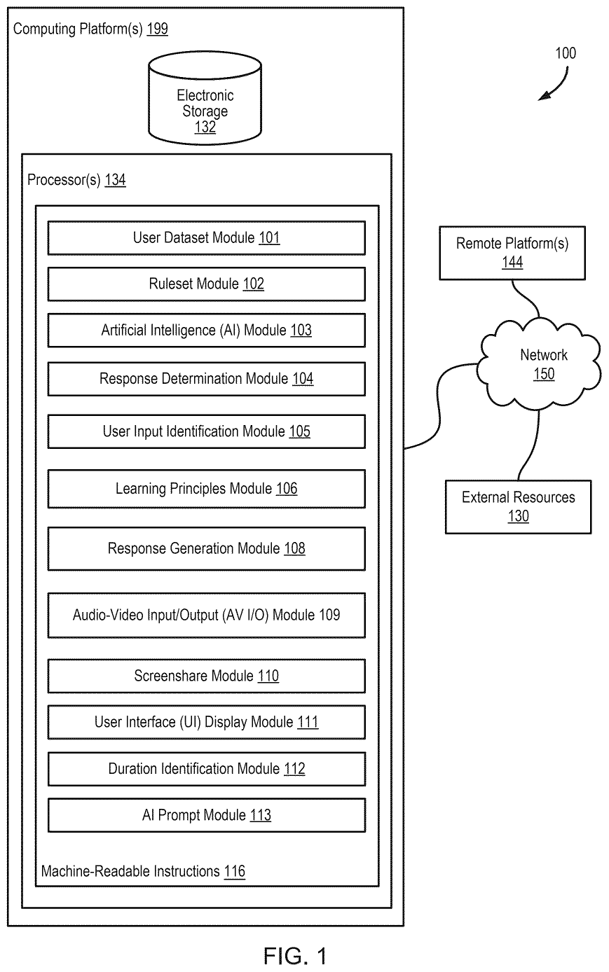

FIG. 1 illustrates a block diagram of an artificial intelligence (AI) educational guidance system 100 implemented using a computing platform, in accordance with various aspects of the present disclosure. In some implementations, the AI educational guidance system 100 (or simply, system 100) may include one or more computing platform(s) 199. Computing platform(s) 199 may be configured to communicate with one or more remote platforms 144 according to a client/server architecture, a peer-to-peer architecture, and/or other architectures. Remote platform(s) 144 may be configured to communicate with other remote platforms via computing platform(s) 199 and/or according to a client/server architecture, a peer-to-peer architecture, and/or other architectures. In some embodiments, users (e.g., students or learners, teachers, instructors, etc.) may access system 100 via remote platform(s) 144. In some examples, the terms “remote computing platform”, “remote platform”, “user device”, and “user equipment” may be used interchangeably throughout the disclosure. Some non-limiting examples of remote platform(s) include laptops, desktop computers, smartphones, and/or computer tablets.

Computing platform(s) 199 may be configured by machine-readable instructions 116. Machine-readable instructions 116 may include one or more instruction modules. The instruction modules may include computer program modules. The instruction modules may include one or more of a user dataset module 101, a ruleset module 102, an AI module 103, a response determination module 104, a user input identification module 105, a learning principles module 106, a response generation module 108, an audio-video input/output module 109 (also referred to as AV I/O module 109), a screenshare module 110, a user interface (UI) display module 111, a duration identification module 112, an AI prompt module 113, and/or other instruction modules. It should be noted that one or more of the instruction modules described herein may be optional. Alternatively, in some embodiments, a single instruction module may be utilized to effectuate the functions of a plurality of instruction modules.

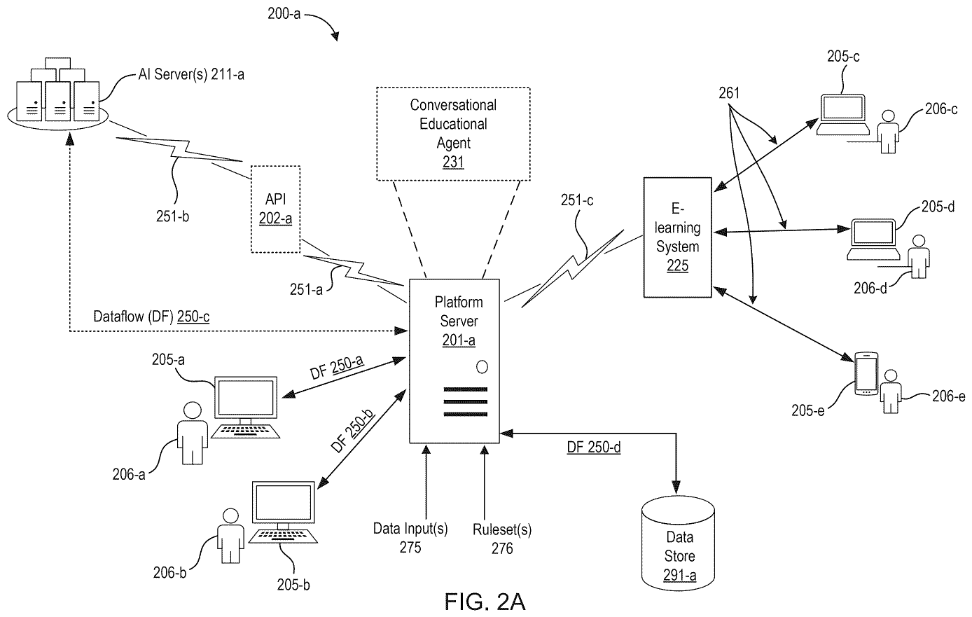

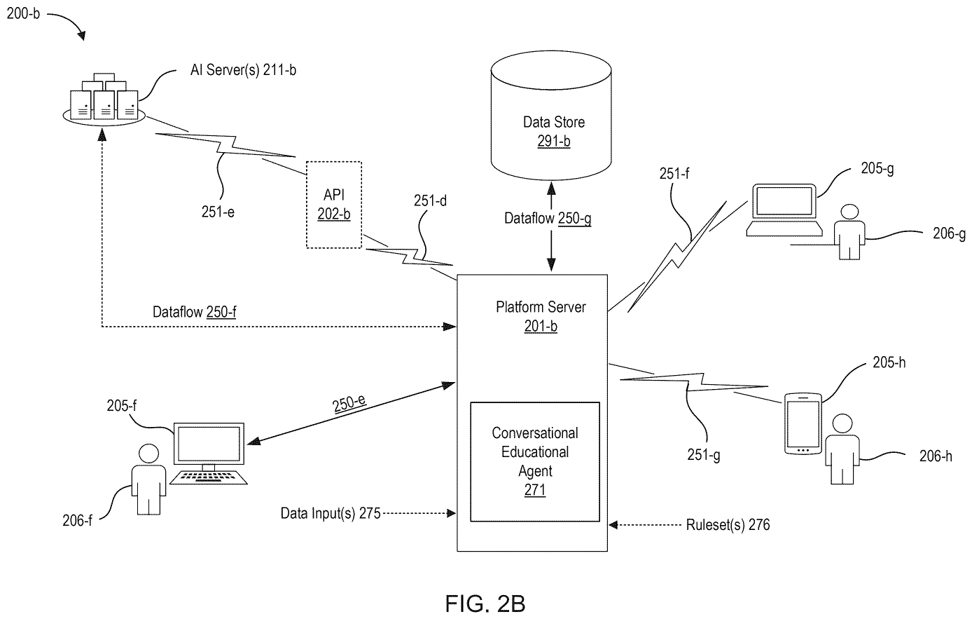

User dataset module 101 may be configured to receive a plurality of user datasets from a user device, where each of the plurality of user datasets is related to a direct user input to a conversational educational agent, or a user interaction with a user interface (UI) associated with an electronic learning (e-learning) system, such as e-learning system 225 in FIG. 2A. In some cases, the e-learning system may also be referred to as a learning management system (LMS). In some examples, the e-learning system 225 is configured to measure a user's confidence level.

In some examples, the one or more user datasets may include a plurality of user datasets, including at least a first user dataset and a second user dataset. In some embodiments, the second user dataset may be received after the first user dataset. For instance, the first user dataset may be related to a user answering a first question and the second user dataset may be related to a user answering a second question, where the user answers the first question before the second question. In another example, the first user dataset may be related to a user entering a first chat message and the second user dataset may be related to the user entering a second chat message, where the second chat message is sent after the first chat message. Other variants and/or configurations are contemplated in different embodiments and the examples listed herein are not intended to limit the scope and/or spirit of the present disclosure. For example, in some cases, the first user dataset may be related to a chat message from a user and the second user dataset may be related to a user interaction with the UI (e.g., user selecting an answer choice of a multiple-choice question). Alternatively, the first user dataset may be related to a user interaction (e.g., a user selecting an answer choice for a multiple-choice question via the UI displayed on the user device) and the second user dataset may be related to a user input (e.g., a user typing an answer into a text box via the UI displayed on the user device).

In some implementations, one of the first or the second user dataset is related to a user interaction with the UI associated with the e-learning system. As noted above, the e-learning system, such as e-learning system 225, may be configured to measure a user's confidence level.

In some implementations, another of the first or the second user dataset is related to a direct user input to a conversational educational agent, where the corresponding dataset is received from the user via the user device (e.g., remote platform 144, user device 205-g, user device 205-h). In some implementations, the user interaction with the e-learning system comprises the user making at least one selection on the UI display via the user device. In some implementations, the user input comprises the user typing a chat message or text input into the user device.

In some implementations, the one or more user datasets comprise a first user dataset associated with a first user interaction with the UI and a second user dataset associated with a second user interaction with the UI, where the UI is associated with the e-learning system.

In some implementations, the direct user input may comprise receiving an audio input and/or a video input from the user device. In some examples, a direct user input can also include a screenshare from the user device. In some cases, the AI educational guidance system may be configured to utilize the video input to interpret sign language and/or user engagement with the system (e.g., by monitoring user eye movement or gaze), to name two non-limiting examples.

The ruleset module 102 may be configured to access a plurality of rulesets, where at least one of the plurality of rulesets is associated with at least one cognitive scientific learning principle. Some non-limiting examples of scientific learning principles may include one or more of a spacing effect, a pretesting effect, a delayed corrective feedback effect, a retrieval practice effect, an interleaving effect, and a generation effect. In some examples, the ruleset module 102 may be configured to work in conjunction with the learning principles module 106.

The AI module 103 (also referred to as the conversational educational agent module 103, in some embodiments) may be configured to apply one or more of the plurality of rulesets to one or more of the plurality of user datasets. In some cases, applying the one or more rulesets to the one or more user datasets enables determining, for each of the user datasets, whether a personalized response is required. In other words, determining whether the personalized response is required is based on applying the at least one ruleset to each of the plurality of user datasets. In accordance with aspects of the present disclosure, a user may interact with the AI educational guidance system 100 using a variety of techniques, including, but not limited to, chat-based interactions (e.g., direct user input to a conversational educational agent) or user interactions with a UI associated with an e-learning system or LMS. For example, a user may be able to access a learning module, a quiz, an exam, or a practice assignment for an educational course using the AI educational guidance system 100.

In some embodiments, the AI educational guidance system 100 may employ cognitive scientific learning principles to facilitate optimal learning for the user. Numerous studies have shown that currently employed techniques in some e-learning or learning management systems are lacking in several regards since they do not employ well-proven and well-established scientific learning principles. Furthermore, it has been difficult to design AI platforms to properly apply such well-established (albeit non-intuitive) cognitive scientific learning principles despite the vigorous research supporting their use in a learning environment. For instance, as noted above, currently used genAI is typically trained using large corpuses of material, including education-related material (e.g., textbooks, explanatory webpages, lecture notes, encyclopedias, course readers, academic journal articles, etc.). Statistical patterns in that material (e.g., what word is most likely to occur next, given the sequence of words that came before it along with other contextual information) is then used inform the underlying model the AI uses to produce novel output (e.g., text descriptions, spoken explanations, illustrative images, etc.). However, because most historical/extant educational material is structured around the use of suboptimal learning principles, existing genAI models suffer the same deficiencies prevalent in their training datasets (e.g., textbooks that mass topics rather than spacing them; quizzes that immediately display the correct answer after the user has answered the question; passive video-and/or slideshow-based training experiences; online forum posts that describe “cramming” study material the night before an examination; educational courses that simply display answers to questions without imploring the user to consider their answer choice, for instance, by asking a different but related question, to name a few non-limiting examples). To alleviate these issues, aspects of the present disclosure are directed to an AI educational guidance system (e.g., system 100) that is configured to (1) receive one or more user datasets from a user device, (2) determine whether a personalized response is required for each of the user datasets, where determining whether the personalized response is required is based on applying at least one ruleset to each of the user datasets, (3) generate, for at least one user dataset, at least one personalized response, where generating the at least one personalized response is based on applying the at least one ruleset to each of the user datasets, and (4) transmit the at least one personalized response to the user device. In some cases, at least one of the plurality of rulesets is associated with at least one cognitive scientific learning principle. As an example, the plurality of rulesets may include a first ruleset associated with a first scientific learning principle (e.g., spacing effect), a second ruleset associated with a second scientific learning principles (e.g., pretesting effect), a third ruleset associated with a third scientific learning principles (e.g., feedback delay effect), a fourth ruleset associated with a fourth scientific learning principles (e.g., retrieval practice effect), a fifth ruleset associated with a fifth scientific learning principles (e.g., interleaving effect), a sixth ruleset associated with a sixth scientific learning principles (e.g., generation effect).

In some cases, the plurality of rulesets may also include one or more rulesets that are not associated with a cognitive scientific learning principle. For example, the plurality of rulesets may include a seventh ruleset that should be executed when a new user accesses a learning module for the first time via the e-learning system and/or an eighth ruleset that should be executed when a repeat user accesses a learning module via the e-learning system. Some other types of rulesets may also include a ninth ruleset that should be executed when a user answers a question via a chat message (i.e., direct user input to a conversational educational agent), a tenth ruleset that should be executed when a user answers a question (e.g., by selecting or clicking an answer choice for a multiple-choice question) via the UI associated with the e-learning system, an eleventh ruleset that should be executed when a user incorrectly answers a question, a twelfth ruleset that should be executed when a user correctly answers a question, and/or a thirteenth ruleset that should be executed when a user provides an off-topic input (e.g., types or enters an off-topic input, verbally communicates an off-topic input, to name two non-limiting examples), where the off-topic input is unrelated to one or more of the learning module displayed on the user device, the question displayed on the user device, a pre-defined topic, and the e-learning system.

In some implementations, one or more rulesets may be utilized when the timestamp data within the user dataset meets certain pre-defined criteria. In one non-limiting example, the AI educational guidance system 100 may be configured to generate a personalized response for re-engaging the learner when the timestamp data indicates that the user or learner is selecting answer choices without fully reading the questions (e.g., the system 100 may determine that the learner is not engaged with the learning module based on detecting that the learner has answered a question that typically takes at least 40 seconds to read within 3 seconds of accessing the question). In another example, the AI educational guidance system 100 may be configured to generate another personalized response for re-engaging the learner or display a timeout message when the timestamp data indicates that the user has not interacted (e.g., via a direct user input, such as a chat message, to the conversational educational agent; via a UI-based interaction on the user device) with a learning module for a user disengagement threshold duration or pre-defined duration (e.g., at least 2 minutes for selecting an answer choice on a multiple choice question that typically takes <45 seconds for most users; at least 15 minutes for selecting an answer choice on the first question on a reading passage that typically takes other users <7 minutes, to name two non-limiting examples). As can be appreciated, the AI educational guidance system 100 may be configured to generate personalized responses for other detectable disengaged user behaviors (i.e., indicating “I don't know yet” without reading the question, exclusively submitting responses while indicating full confidence, randomly clicking/selecting answer choices, timestamp data indicating that the user is either providing a response to a question too soon or too late), which may be indicative of the user being disengaged from the AI educational guidance system 100. That is, the AI educational guidance system 100 can be configured to assess and analyze the plurality of user datasets in view of one or more of the rulesets to detect other types of user behaviors that are usually associated with user disengagement from the educational material. As described herein, detection of user disengagement can be achieved using a plurality of means known or contemplated in the art, such as, but not limited to, analyzing the audio input data (e.g., spectrum analysis, 3rd party voice and/or speech recognition tools, headsets or microphones with dedicated built in voice-to-text (or speech-to-text) features, or other applicable hardware components or modules known or contemplated in the art. In some examples, analysis of audio input data may be implementing using a module (e.g., AV I/O module 109) of the AI educational guidance system 100, where the AV I/O module 109 comprises a variety of filters (e.g., bandpass filters, noise reduction filters) as well as machine-readable instructions employing digital signal processing techniques (DSP techniques) known or contemplated in the art to isolate the various components of the audio input (e.g., multiple voices from multiple people, including the user; audio signals associated with background music, television, streaming websites, gaming consoles, and/or sports commentary, etc.) and compare, for instance, the relative amplitude of the speech or voice associated with the user relative to the other audio components isolated from the audio input to detect user disengagement. Similarly, video input data can also be utilized by the AI educational guidance system 100 to detect user behavior that may be indicative of user disengagement. For instance, some user behaviors that may be flagged or identified as being associated with user disengagement may include, but not limited to, video data indicating that a user is not looking at the user device; video data indicating a user's slouched posture; and/or video input data indicating mouth or lip movement during a non-verbal quiz or educational module. In yet other cases, browser-focus data and/or keystroke monitoring can also be used to detect that the user is typing the same or substantially the same question into another window (e.g., web browser window), or if the user is using the copy-paste function to copy the text of the question and paste it in another window, or any other applicable means). As can be appreciated, a plurality of means of detecting user disengagement behaviors are contemplated and described herein. Additionally, multiple means for detecting user disengagement behaviors can be utilized simultaneously; or, alternatively, a first means (e.g., monitoring eye gaze movement) can be utilized and a second, different means (e.g., analyzing timestamp data, analyzing audio input data) can be utilized to verify or validate the assessment output of the first means.

In some cases, the personalized response may include a New-User Welcome Message to display a warm and friendly greeting on the user device when the user is a new or first-time user of the e-learning system (e.g., e-learning system 225). Furthermore, the New-User Welcome Message may also include a message that provides the user with additional details on one or more of the AI educational guidance system 100, the conversational educational agent, the learning module or task selected by the user, the educational course, and any other applicable information for familiarizing the user with the disclosed platform.

In some other cases, the personalized response may include a Repeat-User Welcome Message to greet a user returning to a learning module or the platform, where the Repeat-User Welcome Message may be different from the New-User Welcome Message. Besides greeting the user, the Repeat-User Welcome Message may include one or more of a recap of the previous learning session, details related to where the user left off at the end of the previous/last learning session, and a question asking if the user was comfortable/familiar with the UI or if they needed a tutorial or refresher on the same. In some embodiments, the user may indicate a binary response (e.g., Yes, I understand the UI; No, I need a refresher). Alternatively, the user may indicate a scaled response (e.g., a number between 1 to 10, where 1 may indicate minimal to no understanding of the UI, 6 may indicate some proficiency, but still need assistance on some occasions, and 10 indicates a high-level of proficiency with the UI, typical of TAs, professors, instructors, and students with significant experience with the platform. In this way, the AI educational guidance system 100 can provide a user that indicates a lower number (e.g., 1 or 2) with regards to their UI understanding level a more in-depth guidance on the UI, as compared to another user that indicates a higher number (e.g., 5 or 6).

It should be understood that the exact phrasing or language used in the personalized responses (e.g., New-User Welcome Message, Repeat-User Welcome Message) is not as important, but rather how the AI module 103 and/or ruleset module 102 determine which ruleset(s) should be applied for a particular situation or scenario. In some aspects, the ruleset(s) used for a certain scenario (e.g., a front-end state) may be executed to generate an Artificial Intelligence (AI) prompt. Specifically, but without limitation, the AI module (e.g., AI module 103 in FIG. 1) and/or the AI prompt module (e.g., AI prompt module 113) may employ Large Language Models (LLMs) and generate specific language (i.e., words, sentences, phrases, etc.) based on the determined ruleset(s). Said another way, determining the appropriate ruleset(s) to be used for a particular scenario can assist in constraining the AI or LLM, thereby resulting in the AI prompt transmitted to the AI servers (e.g., AI servers 211-a, AI servers 211-b) also being constrained, which in turn results in a more optimal personalized response. In some instances, executing the ruleset(s) to generate the AI prompt may comprise applying one or more of the plurality of rulesets to one or more of the plurality of user datasets. In some embodiments, the AI prompt can then be utilized to generate a personalized response for that specific scenario. In some embodiments, the AI module 103 may be configured to communicate the AI prompt to the response determination module 104 (or alternatively, a third-party AI service). One non-limiting example of such a third-party AI service can be implemented using the AI servers 211-a and/or AI servers 211-b, described in relation to FIGS. 2A and 2B, respectively. As can be appreciated, the ruleset module 102, AI module 103, and response determination module 104 may be configured to work in conjunction with each other, in some embodiments.

User input identification module 105 may be configured to receive a direct user input to a conversational educational agent. As noted above, a direct user input can include a text message or chat message, although other types of user inputs are also contemplated in different embodiments. For instance, the user input identification module 105 may be configured to receive audio input (i.e., a direct user input) from a user via a microphone embedded within, or connected to, their user device. Additionally, the audio input received from the user device may be converted from audio signals to a text input, which can then be parsed and interpreted by the conversational educational agent. In some cases, the user input identification module 105 may also be configured to receive other types of direct user inputs, including, but not limited to, sign language (e.g., American Sign Language or ASL), which can further enhance user experience, as compared to the prior art.

In some cases, a direct user input received by the user input identification module 105 can include a speech or audio signal transmitted (e.g., using a wired or wireless communication link) from the user device to the conversational educational agent. In another example, a direct user input received by the user input identification module 105 can include a video signal transmitted (e.g., using a wired or wireless communication link) from the user device to the conversational educational agent. The video signal may or may not include an embedded audio signal. For example, a video signal associated with sign language gesture(s) may only include video data, but not audio data. As used herein, the terms “video data”, “video signals”, and “video signal data” typically refer to data or information containing both audio and video related data and may be referred to as AV data (or alternatively A-V data, or A-V information).

In some cases, the AI educational guidance system 100 may be configured to receive user datasets in the form of a verbal message, a video feed from a camera of the user device, or a combination thereof. In some circumstances, the direct input received by the conversational educational agent may be misspelled, unclear, poorly worded, or even ambiguous (e.g., due to the lack of proper punctuation), to name a few non-limiting examples. In such cases, the AI educational guidance system 100 and/or the conversational educational agent are configured to suggest one or more alternate ways for the user to communicate the direct user input (i.e., received by the user input identification module 105). Some non-limiting examples of such alternatives may include: 1) requesting the user to speak into a microphone instead of sending a text or chat message, 2) requesting the user to use their webcam and/or microphone, and/or 3) requesting the user to use one or more the screenshare feature, webcam, and microphone, to name a few non-limiting examples.

The AI educational guidance system 100 is also configured to be cognizant of an impairment or disability (if any) of a user. Additionally, the AI educational guidance system 100 (or the user input identification module 105) is configured to suggest appropriate alternatives to the user to communicate (or alternatively, recommunicate) the direct user input to the conversational educational agent, based at least in part on the impairment or disability related data for the user. In some examples, the AI educational guidance system 100 may also consider one or more hardware and/or software features of that user's computer system (i.e., user device) to determine an optimal way for the impaired user to transmit the direct user input to the conversational educational agent. For example, if the conversational educational agent receives a direct user input in the form of a text or chat message from a mute user, the AI educational guidance system 100 may suggest the user to transmit the direct user input in the form of a screenshare, video signal having sign language data (e.g., ASL data), or both. In another example, for a visually impaired user, the AI educational guidance system may be configured to request the user to transmit the direct user input in the form of an audio or speech signal. In this case, however, the personalized response transmitted to the visually impaired user may be in the form of an audio signal or a text/chat message, where the text/chat message is converted into an audio signal and played back to the user through headphones or speakers of the user device. In this way, the AI educational guidance system 100 may also enable learners with hearing, visual, and/or speech impediments to use the AI educational guidance system, as intended, which can facilitate an enhanced learning experience.

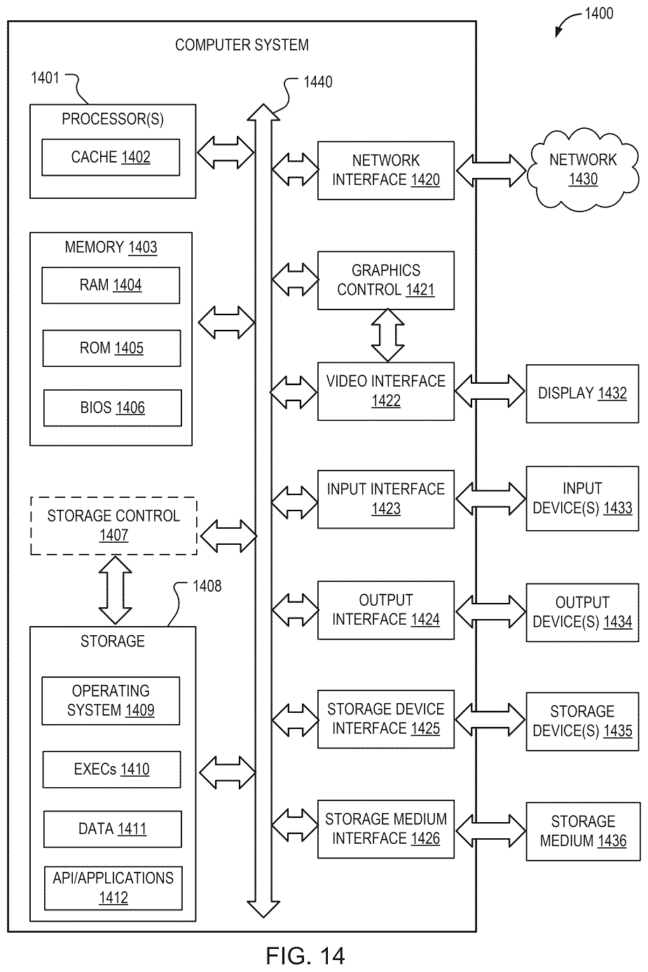

In accordance with aspects of the disclosure, each of the AI educational guidance system 100, the computing platform (e.g., computing platform(s) 199), platform server (e.g., platform server 201-a, platform server 201-b), user device(s) (e.g., any of the user devices 205-a through 205-e in FIG. 2A, any of the user devices 205-f through 205-h in FIG. 2B), remote platform (e.g., remote platform 144), as well as other applicable systems, servers, platforms, UEs, data stores, and/or databases can be implemented using a respective computer system (also referred to as a computing system). One non-limiting example of such a computer system may include the computer system 1400 described below in relation to FIG. 14. In some instances, a plurality of computer systems (or different variants of the computer system) can be employed to effectuate the various aspects of the present disclosure. Additionally, one or more subcomponents (e.g., input device(s) 1433, output device(s) 1434, storage 1408, operating system 1409, etc.) of the different computer systems may be different (e.g., configured differently), for instance, depending on the functionality of the specific computer system (e.g., whether the computer system is a user device, e-learning system, platform server, AI server, etc.). In one non-limiting example, the input device(s) 1433 and/or output device(s) 1434 of a first computer system (e.g., used to implement the user device 205-a) may be configured differently than the input and/or output devices for a second, different computer system (e.g., used to implement the platform server 201-a). In another example, computer systems of the same type (e.g., user device) may have different operating systems (e.g., WINDOWS, MAC, LINUX, ANDROID, etc.), APIs or applications, storage devices (e.g., magnetic disk drive, solid-state drive), network interfaces (e.g., ethernet, Wi-Fi, 4G or 5G cellular technology), to name a few non-limiting examples. In other words, the AI educational guidance system 100 of the present disclosure may be an example of a cross-platform computer system that is configured to operate with disparate computer systems using disparate hardware components, software systems (e.g., BIOS, OS, applications), and/or networking technology.

Learning principles module 106 may be configured to identify one or more cognitive scientific learning principles (e.g., established learning principles that are supported by published or unpublished academic or industry research). In many cases, such cognitive scientific learning principles are often unintuitive to most users (i.e., instructors, students), even though there is rigorous research demonstrating them. Some non-limiting examples of cognitive scientific learning principles may comprise a spacing effect, a pretesting effect, a delayed corrective feedback effect, a retrieval practice effect, an interleaving effect, and a generation effect. Furthermore, each of the scientific learning principles may be linked to one or more rulesets. For instance, the spacing effect may be associated with a Spacing Ruleset, the pretesting effect may be associated with a Pretesting Ruleset, the delayed corrective feedback effect may be associated with a Delayed Corrective Feedback Effect Ruleset, the retrieval practice effect may be associated with a Retrieval Practice Ruleset, the interleaving effect may be associated with an Interleaving Ruleset, and the generation effect may be associated with a Generation Ruleset. It should be noted that other types of scientific learning principles and their corresponding rulesets can be employed in different embodiments, and the examples listed herein are not intended to limit the scope and/or spirit of the present disclosure.

Response generation module 108 may be configured to generate a first personalized response, where generating the first personalized response is based on applying at least one ruleset associated with at least one cognitive scientific learning principle to the first user dataset. In some examples, the first personalized response is associated with the first user dataset of the plurality of user datasets and the least one ruleset applied to the first user dataset. The response generation module 108 (or UI display module 111) may be further configured to transmit the first personalized response for display on the user device. In some cases, generating the first personalized response is further based on one or more of an educational-content-specific dataset and a learner-specific dataset.

Audio-video input/output module 109 (or AV I/O module 109) is configured to generate an audio output signal that can be transmitted and subsequently played back through an audio output (e.g., headphones, speakers) of the user device. In some cases, the AV I/O module 109 may be configured to receive an audio input signal (e.g., via a microphone) of the user device. Furthermore, the AV I/O module 109 may be configured to automatically parse any audio or speech input, extract the words (if any) present in the audio input signal, filter out any background noise (if needed), and any other applicable tasks associated with speech recognition. In some cases, the AV I/O module 109 may be configured to recognize the user's voice and filter out speech input or voice's associated with other people in the user's vicinity (e.g., if the user or learner is in a public setting, such as a library or a cafe), as well as background noises (e.g., noise of cars or traffic passing by, background noise of machinery, such as a lawn mower or a hair dryer, operating in the background, to name a few non-limiting examples. The AV I/O module 109 may be configured to work in conjunction with one or more of the user dataset module 101 and the user input identification module 105, which can serve to optimize processing of user datasets, since user datasets may be associated with different types of information (e.g., audio, video, audio-video, facial gestures, or hand gestures, such as American Sign Language (ASL), to name a few non-limiting examples.

Screenshare module 110 is configured to analyze screenshare data (e.g., received as a direct user input) received from the user device.

In some embodiments, the one or more user datasets may comprise a first user dataset having timestamp data. In some implementations, the timestamp data may be associated with a first user interaction with the UI associated with the e-learning system.

Duration identification module 112 may be configured to identify, based on the timestamp data, that the first user interaction corresponds to a user requesting feedback on educational content within a first threshold duration of accessing the educational content. The educational content may comprise any of a question, a quiz, a topic, a module, a practice assignment, and a practice exam. In such cases, the ruleset module 102 may be configured to access a first ruleset corresponding to a first cognitive scientific learning principle (e.g., delayed corrective feedback effect), where accessing the first ruleset is based on identifying that the user has requested near-immediate feedback which does not align with the “delayed corrective feedback effect” cognitive scientific learning principle. Furthermore, the response determination module 104 may be configured to determine that a first personalized response associated with the first ruleset corresponding to the delayed corrective feedback effect should be generated. The response generation module 108 may be configured to generate the first personalized response, based on applying the ruleset associated with the delayed corrective feedback effect (i.e., cognitive scientific learning principle) to the user dataset (i.e., direct user input related to a request for near-immediate feedback). The response generation module 108 may also transmit the first personalized response to the user device. In one non-limiting example, the first personalized response may include a message (e.g., “Glad to hear that you want some feedback! However, let us continue with the rest of this module, and we can revisit this question soon.”) that can be displayed on the user device.

In another example, the duration identification module 112 may be configured to identify, based on the timestamp data, that the first user interaction corresponds to a user requesting guidance on educational content within a first threshold duration of accessing the educational content. In such cases, the ruleset module 102 may be configured to access a first ruleset corresponding to a first cognitive scientific learning principle (e.g., spacing effect), where accessing the first ruleset is based on identifying that the user has requested guidance sooner than would be optimal according to the “spacing effect” cognitive scientific learning principle. Furthermore, the response determination module 104 may be configured to determine that a first personalized response associated with the first ruleset corresponding to the spacing effect should be generated. The response generation module 108 may be configured to generate the first personalized response, based on applying the ruleset associated with the spacing effect (i.e., cognitive scientific learning principle, or simply scientific learning principle) to the user dataset (i.e., direct user input related to a request for sub-optimally timed guidance). The response generation module 108 may also transmit the first personalized response to the user device (e.g., remote platform 144, user device 205-c, user device 205-d). In one non-limiting example, the first personalized response may include a message (e.g., “I see that you're eager to learn, but waiting a little longer will help the information stick. Let's keep going for now, but we'll come back to that in a bit.”) that can be displayed on the user device.

In another example, the duration identification module 112 may be configured to compare the timestamp data to a threshold duration corresponding to a system timeout (i.e., the user has not interacted with the e-learning system for a pre-defined duration, such as, 5 minutes, 10 minutes, etc.). In such cases, the ruleset module 102 may be configured to access a ruleset for re-engaging the learner. Furthermore, the personalized response generated by the response determination module 104 may be associated with said ruleset for re-engaging the learner. In one non-limiting example, the personalized response may include generating and transmitting a message (e.g., “Let's try to continue with this module, if you still have some energy! If not, treat yourself to a short break and I'll be here when you are ready to resume. Nice work today!”) to the user device.

AI prompt module 113 is configured to generate an AI prompt, where generating the AI prompt comprises providing one or more constraints, for instance, from one or more of the AI module 103, the ruleset module 102, and/or learning principles module 106. In some embodiments, the AI prompt is associated with, comprises, and/or related to the one or more constraints. For example, the AI prompt may include an unmodified or original version of the one or more constraints. Alternatively, the one or more constraints (herein referred to as unmodified or unprocessed constraints) may be processed into a format that can be interpreted by one or more of the AI module 103 and the response generation module 108. In either case, the AI prompt module 113 may provide (e.g., transmit, communicate) the generated AI prompt to at least one of the response generation module 108 and the AI module 103. In one non-limiting example, the AI prompt module 113 assesses the AI prompt, modifies it (optional), and provides or relays the AI prompt and information related to the constraints to the response generation module 108. In other cases, the response generation module 108 may generate one or more intermediary responses, based on receiving the AI prompt and constraint information from the AI prompt module 113 (or alternatively, the AI module 103). The response generation module 108 may be configured to concatenate the one or more intermediary responses for the one or more constraints and transmit the personalized response to the AI module 103, which can then relay it to the user device. In some other cases, the response generation module 108 can directly transmit the personalized response to the user device (e.g., remote platform 144, user device 205-c).

In some other cases, the AI module 103 may be configured to generate one or more intermediary responses for the one or more constraints and transmit the one or more intermediary responses to the response generation module 108. In such cases, the response generation module 108 may be configured to concatenate the intermediary responses and generate the personalized response.

In yet other cases, the response generation module 108 may transmit the intermediary responses to the AI module 103, where they are concatenated to generate the personalized response. The AI module may transmit this personalized response to the response generation module 108, following which it may be modified (optional) or directly transmitted to the user device. Thus, as described above, the various modules of the computing platform 199 are configured to work in conjunction with each other, including at least the AI module 103, response generation module 108, and AI prompt module 113.

In some examples, the AI module 103 may be configured to coordinate with the learning principles module 106, for example, to assess whether the generated intermediary responses incorporate the correct/appropriate cognitive scientific principles. In some circumstances, the learning principles module 106 may transmit one or more instructions to the AI module 103 for modifying at least one of the one or more intermediary responses, adding one or more additional intermediary responses (e.g., based on detecting that a cognitive scientific learning principle that should influence the final personalized response is undetectable in the intermediary responses). In other cases, the learning principles module 106 and/or the ruleset module 102 may instruct the AI module 103 to remove at least one of the plurality of intermediary responses, for instance, due to redundancy; if at least one of the intermediary responses violates a scientific learning principle; or if at least one of the intermediary responses is associated with a scientific learning principle that is not applicable to that user dataset. Discussed above are just some non-limiting examples of techniques that can be used for generating the personalized responses transmitted to the user devices (i.e., in communication with the AI educational guidance system 100) and should not be construed as limiting the scope and/or spirit of the disclosure.

In some implementations, generating the personalized response is based at least in part on one or more of: analytics data for one or more of a question, a quiz, a topic, a module, a practice assignment, and a practice exam; interaction history data for a user associated with the user device; learner history data for the user associated with the user device; and an understanding level of the user, wherein the understanding level comprises a quantitative score corresponding to a user's familiarity and understanding of the UI associated with the e-learning system.

In some implementations, at least one constraint of the one or more constraints is associated with a scientific learning principle. In some cases, a scientific learning principle may be referred to as a cognitive scientific learning principle, a cog sci learning principle, or a cog sci principle. In some instances, the terms “scientific learning principle,” “cognitive scientific learning principle”, “cog sci learning principle”, and “cog sci principle” may be used interchangeably throughout the disclosure. In accordance with aspects of the disclosure, constraints are limitations or structures applied to generative AI (or genAI) that force the genAI to abide by cog sci principles. In some embodiments, the AI module 103 may be an example of and/or may implement one or more aspects of genAI.

In one non-limiting example, the AI prompt (e.g., received from the AI prompt module 113) may comprise a constraint, where the constraint is associated with a cognitive scientific learning principle. As noted above, constraints applied to genAI (e.g., AI module 103) can help force the genAI to abide by cog sci principles. For instance, the constraint included within (or embedded within) the AI prompt can be associated with the interleaving effect. In such cases, the AI prompt may cause the AI module 103 to generate educational content comprising interleaved learning material (i.e., covering different topics, chapters, etc.) As an example, the AI prompt comprising a constraint associated with the interleaving effect cog sci learning principle may force the AI module 103 (or genAI) to abide by the interleaving effect cog sci learning principle, for instance, by instructing the AI module 103 to generate a mathematics practice assignment that includes addition, subtraction, multiplication, and division questions, where each successive question is of a different type than the one preceding it. For instance, if the 1st question is a multiplication question, the 2nd question should be an addition, subtraction, or division question. Similarly, if the 2nd question is an addition question, the 3rd question should be one of a subtraction, multiplication, or division question. In one non-limiting example, the AI prompt may further include another constraint that instructs the AI module to suppress questions on a particular topic until all other topics have been included at least once. In this case, if the 1st question is a multiplication question and the 2nd question is an addition question, the 3rd question should be one of a subtraction or division question since a multiplication question has already been included at least once.

The term “interleaving effect” refers to a concept in cognitive psychology that has been thoroughly researched and studied over decades, and is purported to enhance long term retention, critical thinking skills, and/or knowledge transfer (i.e., apply knowledge gained in one subject or context to another, different subject or context). However, classrooms and existing LMSs, alike, hardly (if ever) integrate the interleaving effect into their learning/teaching techniques for a multitude of reasons, including its unintuitive nature and the complexity involved in appropriately structuring the different topics or subjects. Numerous cog sci research studies have demonstrated the benefits of harnessing the interleaving effect in the educational environment (both in-person learning and digital learning). Despite its numerous drawbacks, the alternative to interleaving (i.e., massing/blocking) is far more prevalent because it is simpler to implement and more intuitive to most people (i.e., users/learners, instructors, professors, etc.). More specifically, cog sci research studies have shown that harnessing the interleaving effect (e.g., in lieu of the massing or blocking effect) may facilitate in enhancing one or more of: long-term memory retention, critical thinking, brain's ability to differentiate/discriminate between different concepts or topics, and/or strengthen memory associations.

The UI display module 111 is configured to display one or more questions via a user interface on the user device, where each of the one or more questions is selected from a group consisting of: a question with a text field for receiving an answer; a multiple-choice question; a True-False question; or a Matching question. The UI display module 111 is also configured to display the personalized response(s) on the user device. It should be noted that the types of questions (e.g., multiple-choice question, matching question, etc.) listed above and elsewhere in the disclosure are exemplary only and not intended to limit the scope and/or spirit of the present disclosure. That is, other question types besides the ones described herein are contemplated in different embodiments.

Additional examples of user datasets, rulesets, and personalized responses

In some implementations, the user device (e.g., remote platform 144) may be associated with a user or learner, where the user is one of a new user or a repeat user. Furthermore, each of the one or more user datasets may be associated with one of (1) the user answering a question, (2) the user incorrectly answering a question, (3) the user correctly answering a question, or (4) the user providing an off-topic input, where the off-topic input (e.g., an off-topic typed text input) is unrelated to one or more of a learning module displayed on the user device, a question displayed on the user device, a pre-defined topic, and the e-learning system.

In some implementations, the one or more user datasets comprise a first user dataset. Furthermore, when the first user dataset is associated with a new user accessing a learning module, the personalized response comprises a first personalized response associated with a first ruleset. Alternatively, when the first user dataset is associated with a repeat user accessing a learning module, the personalized response comprises a second personalized response associated with a second ruleset, where the second personalized response is different from the first personalized response and the second ruleset is different from the first ruleset.

In another example, the one or more user datasets comprise a third user dataset. Furthermore, when the third user dataset is associated with a user incorrectly answering a question, the personalized response comprises a third personalized response associated with a third ruleset. Alternatively, when the third user dataset is associated with a user correctly answering a question, the personalized response comprises a fourth personalized response associated with a fourth ruleset, where the third personalized response is different from the fourth personalized response and the third ruleset is different from the fourth ruleset.

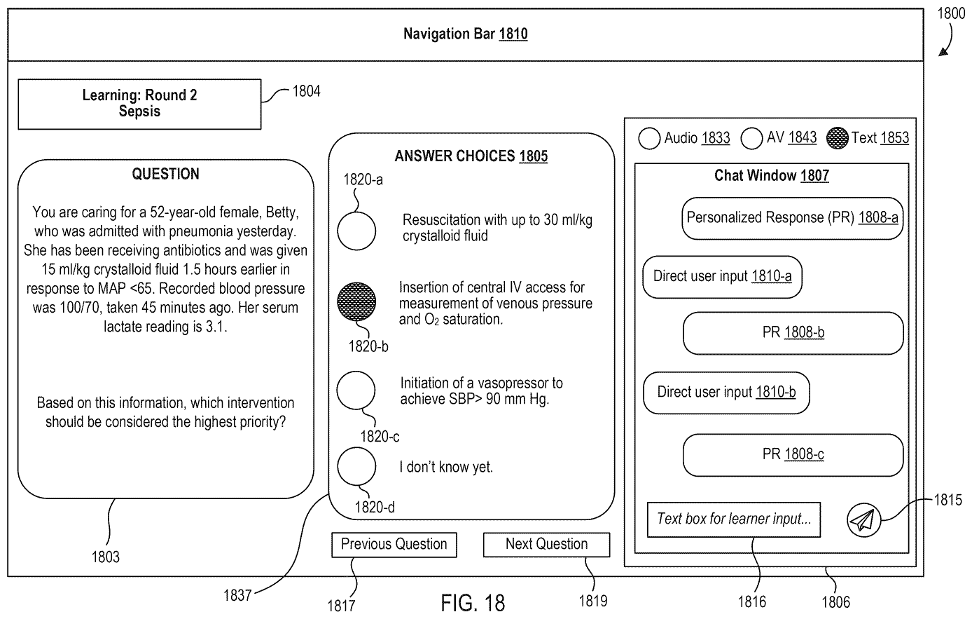

In some examples, the one or more user datasets may also include a fifth user dataset, where the fifth user dataset is associated with a user indicating that they do not know the answer to a question. The AI educational guidance system 100 may allow the user to indicate this lack of knowledge or understanding related to a question using a variety of means, such as, but not limited to, entering text (e.g., “I don't know”, “I am not sure”, “No idea”, to name a few non-limiting examples) into a text box, selecting a checkbox, selecting a radio button, selecting an icon (e.g., a flag icon, an icon showing a confused emoji face), or through any other applicable means known or contemplated in the art. One such example is shown in the UI interface 1800 and described below in relation to FIG. 18. In this way, the AI educational guidance system 100 can utilize information associated with a user's interaction with one or more questions to determine a user's confidence level, a user's understanding level of the educational material, and/or whether a user has a false sense of their understanding level of the educational material. As described herein, a user may also indicate their self-assessed confidence level while answering questions, which may or may not correspond to the confidence level determined by the system (e.g., based on assessing a user's interaction with questions). For example, a first user may indicate a “high” self-assessed confidence level for each question from a set of 10 questions and correctly answer only 3 out 10 questions (i.e., a false sense of confidence), while a second user may indicate a “low” self-assessed confidence level for 4 questions (3 of which were answered incorrectly) and indicate a “high” confidence level for 6 questions (even though they answered 7 questions correctly). In this case, the AI educational guidance system 100 can determine a first confidence level (e.g., low, and false confidence) for the first user and a second confidence level (e.g., medium-high, and accurate confidence). In one non-limiting example, the AI educational guidance system 100 may be configured to generate one or more additional personalized responses based on comparing a user's self-assessed confidence level to the confidence level determined by the system.

In some examples, the AI educational guidance system 100 may implement one or more additional techniques to further enhance the educational experience for the user. For example, the AI educational guidance system 100 may be configured to transmit or communicate to the user device one or more of: a correct answer, an explanation for why the correct answer is the correct or right answer, an explanation for why the answer (i.e., wrong answer) selected by the user is the incorrect or wrong answer, and/or any other applicable additional information (e.g., source information from a textbook; a URL or web link for a video uploaded to a 3rd party website, such as YouTube, that supplements the source information; a white paper; and/or an academic journal article, to name a few non-limiting examples). In some cases, this may be referred to as the user “encountering corrective feedback” or “encountering educational material” via the AI educational guidance system 100. While not necessary, the AI educational guidance system 100 may be configured to utilize this technique when the user has provided (e.g., selected, clicked on, typed, spoken, etc.) a wrong answer to a question and after a certain amount of time (e.g., 5 minutes, 30 minutes, etc.) has elapsed from when the system received the wrong or incorrect answer choice. In some cases, the amount of time may be pre-defined (e.g., automatically by the system, manually input by an instructor or professor), or calculated by the system based on one or more of the source information, educational module, educational course, educational-level of the course (e.g., middle-school level course, graduate degree course), quiz, learner history, difficulty level of the question, and/or any other applicable attributes associated with the question and/or the user.

In another example, the one or more user datasets comprises a sixth user dataset. Furthermore, when the sixth user dataset is associated with the off-topic input (e.g., off-topic text input), the personalized response is associated with a ruleset for re-engaging a learner. As can be appreciated, other types of off-topic inputs besides text-based inputs are contemplated in different embodiments, and the examples listed herein are not intended to limit the scope and/or spirit of the disclosure. For instance, an off-topic input can include an audio input (e.g., voice or speech input associated with an unrelated topic, such as a user asking the AI educational guidance system 100 about the NASA moon landings while taking a biology lesson) received from the user device. In other cases, an off-topic input can include an off-topic visual input (e.g., screenshare, video) received from the user device. One non-limiting example of an off-topic visual input can include a user using the screenshare feature and requesting the AI educational guidance system 100 to identify the name of a pop-culture celebrity while taking a chemistry lesson.

In some cases, the one or more datasets comprises a first user dataset and a second user dataset. In one non-limiting example, the second user dataset is received after the first user dataset. Furthermore, transmitting the personalized response comprises transmitting the personalized response after receiving the first user dataset and before receiving the second user dataset. In some implementations, generating the personalized response comprises generating a first personalized response for a first user dataset. In some implementations, the response generation module 108 is configured to generate a second personalized response associated with the second user dataset.

In some implementations, the plurality of user datasets further comprises a third user dataset. In some implementations, the response generation module 108 (or alternatively, the response determination module 104) is configured to determine that no personalized response is required for the third user dataset. In some examples, the third user dataset may be related to a user interaction with the e-learning system. In such cases, the system 100 is configured to suppress generating a personalized response in response to applying one or more rulesets to the third user dataset.

In some implementations, one of the first or the second user dataset is related to a user interaction with UI associated with the e-learning system. In some implementations, another of the first or the second user dataset is related to a direct user input to a conversational education agent. In some implementations, the user interaction with the e-learning system comprises the user making at least one selection via the UI displayed on the user device. In some implementations, the direct user input may comprise a chat message or text input, although other types of direct user inputs (e.g., audio and/or video inputs) are also contemplated in different embodiments.

In some implementations, each of the one or more user datasets is associated with one of: an answer choice selection for a multiple-choice question; a text input into the text field for a question; an option selection for a True-False question; or one or more match selections for a Matching question.

In some cases, a user dataset may be related to a first chat message, where the first chat message is associated with the user requesting an answer to the displayed question. In some other cases, a user dataset may be related to a second chat message, where the second chat message may be associated with the user requesting a hint (e.g., what formula should I use for a mathematics question, remove two wrong answer choices out of the four answer choices in a multiple-choice question) while attempting to answer the displayed question. In some cases, a hint request from a user may not be limited to a chat message, and other modes of question are also contemplated in different embodiments. For example, a user dataset may be related to an audio file (or audio data), a video file (e.g., containing a short video of a user directly asking the answer to the question), etc.

Alternatively, the user dataset may be related to a user interaction with the UI, where the user interaction may include the user selecting (e.g., clicking via a mouse, selecting via a touchscreen interface) a “Hint Request” button using the user device. In such cases, the personalized response may comprise trimming down the number of answer choices (e.g., for a multiple-choice question) or displaying a clue or hint on the user device. In one non-limiting example, the hint or clue may include an equation for a mathematics question that may help get the user started on the question. In another example, the hint or clue may include the system posing a substantially simpler question having a similar answer choice as the question that the user requested the hint on, for instance, for a geography question stating, “Of the countries bordering Germany, which country has the largest land area?”, the AI-generated hint may include a question like “What country is Paris the capital of?”. In another example, the hint or clue may include the system providing a conceptually relevant statement to guide the user toward correct answers and away from incorrect ones, for instance, for an earth science question stating, “What causes the seasons to change?”, the AI-generated hint may include a statement like “Keep in mind that it is summer in North America when it is winter in Australia.”.

In some other cases, a user dataset may be related to a user input (e.g., chat message), where the user input may request additional clarification and/or details on the displayed question. For instance, for a mathematics question related to quadratic formulas (e.g., x2=64, what is ‘x’?), the user input may include the user requesting clarification on whether the system is looking for the positive number solution (i.e., x=8), the negative number solution (i.e., x=−8), either (i.e., x=8 or x=−8), or both (i.e., x=8 and x=−8).

In some implementations, the educational-content-specific dataset includes content data and analytics information for an educational course. Furthermore, the content data and analytics information comprises one or more of: learning material for the educational course; a difficulty level for the educational course; a difficulty level per learner module for one or more learner modules associated with the educational course; a difficulty level per question for one or more questions associated with the educational course; a difficulty level per quiz for one or more quizzes associated with the educational course; an average submission time per question for one or more first-time users of the educational course; and/or an average submission time per question for one or more repeat users of the educational course (to name a few non-limiting examples).

In some implementations, the learner-specific dataset includes information related to one or more of: 1) a learner history for a user associated with the user device; 2) an interaction history for the user with the e-learning system; 3) an interaction history for the user with the AI educational guidance system; and/or 4) an interaction history for the user with a user interface (UI) displayed on the user device; and/or an interaction history for the user with the user device.

As noted above, in some implementations, the one or more user datasets comprise a first user dataset related to the user input received at the user device, where the user input comprises a chat message or text input. Additionally, or alternatively, the one or more user datasets comprise a second user dataset related to the user interaction with the e-learning system, where the user interaction comprises a user making at least one selection (e.g., clicking using a mouse, tapping or selecting via a touchscreen interface, verbally, indicating using a hand gesture, to name a few non-limiting examples) on the user device.

In some implementations, the one or more user datasets comprise a first user dataset associated with a first user interaction with the e-learning system and a second user dataset associated with a second user interaction with the e-learning system.

In some implementations, each of the first and second user interactions comprises one of: an interaction with a user interface (UI) displayed on the user device, the UI associated with the e-learning system; user audio received from a microphone of the user device; user video received from a camera of the user device; or a screenshare provided by the user from the user device.

In some implementations, the user device is associated with a user, where the user is one of a new user or a repeat user. In some implementations, each of the one or more user datasets is associated with one of the user answering a question; the user incorrectly answering a question; the user correctly answering a question; or the user providing an off-topic input. In one non-limiting example, providing an off-topic input may comprise the user typing an off-topic text input, where the off-topic text input is unrelated to one or more of a learning module displayed on the user device, a question displayed on the user device, a pre-defined topic, and the e-learning system. As noted elsewhere in the disclosure, other types of off-topic inputs besides an off-topic text input are contemplated in different embodiments.

In some implementations, the one or more user datasets comprise a first user dataset. Furthermore, when the first user dataset is associated with a new user accessing a learning module, the personalized response comprises a first personalized response associated with a first ruleset. Alternatively, when the first user dataset is associated with a repeat user accessing a learning module, the personalized response comprises a second personalized response associated with a second ruleset, where the second personalized response is different from the first personalized response and the second ruleset is different from the first ruleset.

In another example, when the first user dataset is associated with a user incorrectly answering a question, the personalized response comprises a first personalized response associated with a first ruleset. Alternatively, when the first user dataset is associated with a user correctly answering a question, the personalized response comprises a second personalized response associated with a second ruleset, where the second personalized response is different from the first personalized response and the second ruleset is different from the first ruleset.

In another example, when the first dataset is associated with the off-topic text input, the personalized response is associated with a ruleset for re-engaging a learner.

In some examples, the one or more user datasets comprise a first user dataset, the first user dataset comprising timestamp data.

In some cases, the timestamp data is associated with a first user interaction with the e-learning system. In some embodiments, duration identification module 112 is configured to identify, based on the timestamp data, that the first user interaction corresponds to a user requesting feedback on educational content within a first threshold duration of accessing the educational content. The duration identification module 112 may transmit an indication to the ruleset module 102, where the indication includes an alert to notify the ruleset module 102 that the first user interaction corresponds to a user requesting feedback soon after accessing the educational content. In such cases, the ruleset module 112 is configured to access a first ruleset corresponding to a first scientific learning principle, where the first scientific learning principle comprises a feedback delay effect. In some embodiments, the response generation module 108 is configured to generate a personalized response employing the first scientific learning principle. For example, the personalized response may inform the user that the e-learning system will display the correct answer and additional feedback on the educational content after a particular duration (e.g., 10 minutes, 30 minutes, 1 hour, etc.), after the user has answered a pre-defined number of additional questions (e.g., 5 questions, 10 questions, etc.), after the user has completed the quiz or module, or a combination thereof.

In some implementations, computing platform(s) 199, remote computing platform(s) 144, and/or external resources 130 may be operatively linked via one or more electronic communication links. For example, such electronic communication links may be established, at least in part, via a network 150 such as the Internet and/or other networks. It will be appreciated that this is not intended to be limiting, and that the scope of this disclosure includes implementations in which computing platform(s) 199, remote platform(s) 144, and/or external resources 130 may be operatively linked via some other communication media.

A given remote platform 144 may include one or more processors configured to execute computer program modules. The computer program modules may be configured to enable an expert or user associated with the given remote platform 144 to interface with system 100 and/or external resources 130, and/or provide other functionality attributed herein to remote platform(s) 144. By way of non-limiting example, a given remote platform 144 and/or a given computing platform 199 may include one or more of a server, a desktop computer, a laptop computer, a handheld computer, a tablet computing platform, a NetBook, a Smartphone, and/or any other applicable computing platform.

External resources 130 may include sources of information outside of system 100, external entities participating with system 100, and/or other resources. In some implementations, some or all of the functionality attributed herein to external resources 130 may be provided by resources included in system 100.

Computing platform(s) 199 may include electronic storage 132, one or more processors 134, and/or other components. Computing platform(s) 199 may include communication lines, or ports to enable the exchange of information with a network and/or other computing platforms. Illustration of computing platform(s) 199 in FIG. 1 is not intended to be limiting. Computing platform(s) 199 may include a plurality of hardware, software, and/or firmware components operating together to provide the functionality attributed herein to computing platform(s) 199. For example, computing platform(s) 199 may be implemented by a cloud of computing platforms operating together as computing platform(s) 199.

Electronic storage 132 may comprise non-transitory storage media that electronically stores information. The electronic storage media of electronic storage 132 may include one or both of system storage that is provided integrally (i.e., substantially non-removable) with computing platform(s) 199 and/or removable storage that is removably connectable to computing platform(s) 199 via, for example, a port (e.g., a USB port, a firewire port, etc.) or a drive (e.g., a disk drive, etc.). Electronic storage 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 132 may include one or more virtual storage resources (e.g., cloud storage, a virtual private network, and/or other virtual storage resources). Electronic storage 132 may store software algorithms, information determined by processor(s) 134, information received from computing platform(s) 199, information received from remote platform(s) 144, and/or other information that enables computing platform(s) 199 to function as described herein.

Processor(s) 134 may be configured to provide information processing capabilities in computing platform(s) 199. As such, processor(s) 134 may include one or more of a digital processor, an analog processor, a digital circuit designed to process information, an analog circuit designed to process information, a state machine, and/or other mechanisms for electronically processing information. Although processor(s) 134 is shown in FIG. 1 as a single entity, this is for illustrative purposes only. In some implementations, processor(s) 134 may include a plurality of processing units. These processing units may be physically located within the same device, or processor(s) 134 may represent processing functionality of a plurality of devices operating in coordination. Processor(s) 134 may be configured to execute modules 101, 102, 103, 104, 105, 106, 108, 109, 110, 111, 112, 113, and/or other modules. For instance, processor(s) 134 may be configured to execute modules 101, 102, 103, 104, 105, 106, 108, 109, 110, 111, 112, 113, and/or other modules by software; hardware; firmware; some combination of software, hardware, and/or firmware; and/or other mechanisms for configuring processing capabilities on processor(s) 134. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 101, 102, 103, 104, 105, 106, 108, 109, 110, 11, 112, and/or 113 are illustrated in FIG. 1 as being implemented within a single processing unit, in implementations in which processor(s) 134 includes multiple processing units, one or more of modules 101, 102, 103, 104, 105, 106, 108, 109, 110, 11, 112, and/or 113 may be implemented remotely from the other modules. The description of the functionality provided by the different modules 101, 102, 103, 104, 104, 105, 106, 108, 109, 110, 112, and/or 113 described below is for illustrative purposes, and is not intended to be limiting, as any of modules 101, 102, 103, 104, 105, 106, 108, 109, 110, 11, 112, and/or 113 may provide more or less functionality than is described. For example, one or more of modules 101, 102, 103, 104, 105, 106, 108, 109, 110, 11, 112, and/or 113 may be eliminated, and some or all of its functionality may be provided by other ones of modules 101, 102, 103, 104, 105, 106, 108, 109, 110, 111, 112, and/or 113. As another example, processor(s) 134 may be configured to execute one or more additional modules that may perform some or all of the functionality attributed below to one of modules 101, 102, 103, 104, 105, 106, 108, 109, 109, 110, 111, 112, and/or 113.

Turning now to FIG. 2A, which illustrates an example of a process flow 200-a associated with the AI educational guidance system 100 in FIG. 1, where the AI educational guidance system 100 is configured to be used with an electronic learning (e-learning) system 225, in accordance with various aspects of the disclosure. FIG. 2A shows a platform server 201-a (e.g., AI educational guidance system 100 in FIG. 1), a data store 291-a connected to server 201-a using dataflow 250-d, one or more AI servers 211-a, an Application Programming Interface (API) 202-a, and one or more computing devices 205 (e.g., computing devices 205-b, 205-c, 205-d, 205-e, and 205-f). In some embodiments, the API 202-a may be optional (shown as optional by the dashed lines). In such cases, the platform server 201-a may communicate with AI server(s) 211-a using dataflow 250-c. In some cases, the platform server 201-a may be configured to communicate with API 202-a using communication link 251-a. Additionally, the API 202-a may communicate with AI server(s) 211-a using communication link 251-b. In some embodiments, the platform server 201-a may be communicatively coupled to, or may include an optional conversational educational agent 231 (shown as optional by the dashed lines). Furthermore, as shown in FIG. 2A, each of the user devices 205-c, 205-d, and 205-e are electrically, logically, and/or communicatively coupled to the e-learning system 225 using communication link 261.

In some embodiments, the platform server 201-a, which may be similar or substantially similar to the AI educational guidance system 100 described in relation to FIG. 1, is configured to receive educational content and/or instructional material from one or more human instructors (e.g., user 206-a associated with computing device 205-a, user 206-b associated with computing device 205-b). In this example, the arrows 250-a and 250-b represent the bi-directional flow of data between the computing devices 205-a and 205-b, respectively, and the platform server 201-a. In some embodiments, the platform server 201-a can also receive one or more educational-content-specific datasets. In some embodiments, an educational-content-specific dataset may include learning or source materials (e.g., operational manuals, textbooks, previous exams or quizzes, a white paper, a research article, a scientific journal, etc.) from the one or more human instructors (i.e., user 206-a, user 206-b). While not necessary, in some instances, the platform server 201-a can also receive an indication of a weighting factor (i.e., how much weight should be given to each particular unit of source material during construction of the educational content that is displayed to the learner/student) from a human instructor. As an example, the platform server 201-a may receive, as source material, two biology textbooks from the computing device 205-a, and an indication that the weighting ratio for the 1st and 2nd textbooks should be 70:30. In such cases, of the total content (e.g., questions in a learning module or quiz) displayed to the learners/users, around 70% may be from the 1st textbook while the remaining 30% may be from the 2nd textbook. In one non-limiting example, the human instructors (i.e., users 206-a, 206-b) may be associated with a different course, subject, learner age group or grade, or a different university degree, to name a few non-limiting examples. For instance, the user 206-a may teach a first course (e.g., High School Biology) and the user 206-b may teach a second, different course (e.g., Calculus III for college level students).

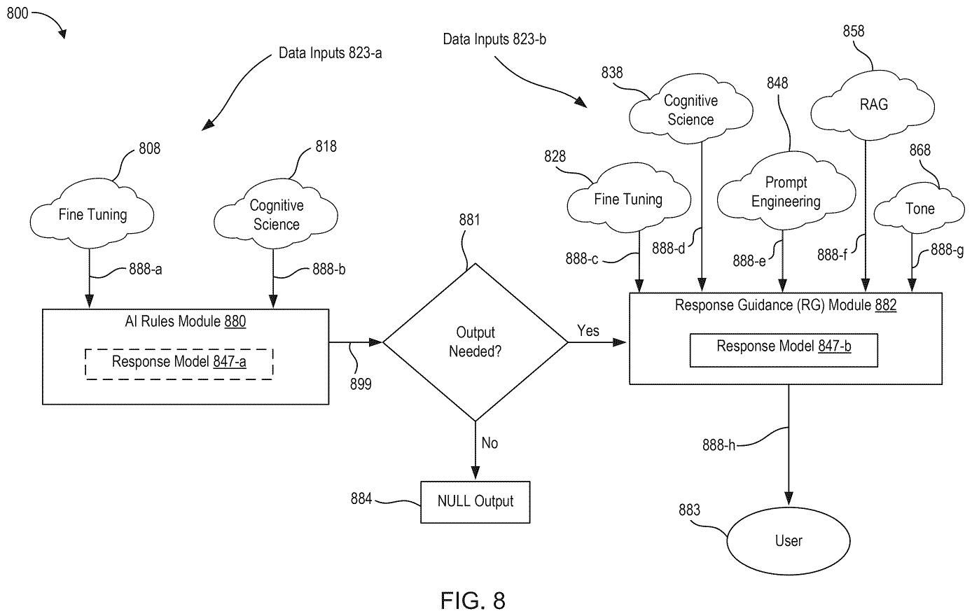

In some embodiments, the platform server 201-a receives one or more datasets (e.g., educational-content-specific datasets) from the computing devices 205-a and 205-b via dataflows 250-a and 250-b, respectively. The platform server 201-a may also receive one or more additional data inputs 275 and a plurality of rulesets 276, further described below in relation to FIG. 8. In some instances, as an alternative, the platform server 201-a can also receive the datasets (e.g., additional data inputs 275, plurality of rulesets 276) directly from the data store 291-a. In some examples, one or more of the plurality of rulesets may be associated with a cognitive scientific learning principle (e.g., spacing effect, interleaving effect). The platform server 201-a may also receive a plurality of user datasets from one or more e-learning systems, such as the e-learning system 225. The e-learning system 225 may be embodied in hardware, software, or a combination thereof. Additionally, the users 206-c, 206-d, and/or 206-e may be able to access the UI (not shown) associated with the e-learning system 225 through their computing devices 205-c, 205-d, and/or 205-e, respectively.

In some instances, the platform server 201-a is configured to receive a plurality of user datasets from the plurality of computing devices 205 (e.g., computing devices 205-c, 205-d, 205-e, and/or 205-f). In some embodiments, a user dataset may be related to a user interaction with the e-learning system 225. Alternatively, a user dataset may be related to a user input directly to an educational agent, further described below in relation to FIG. 2B.

FIG. 2B illustrates another example of a process flow 200-b associated with the AI educational guidance system 100 in FIG. 1, in accordance with various aspects of the disclosure. FIG. 2B shows a platform server 201-b (i.e., AI educational guidance system 100), where the platform server 201-b comprises a conversational educational agent 231. FIG. 2B also illustrates a data store 291-b, one or more AI servers 211-b (also shown as AI servers 211-a in FIG. 2A), an optional API 202-b (shown as optional by the dashed lines), and one or more computing devices 205 (e.g., computing devices 205-f, 205-g, 205-h). In some cases, the platform server 201-b may communicate with AI server(s) 211-b and data store 291-b using dataflows 250-f and 250-g, respectively. For example, the platform server 201-b can directly communicate with AI servers 211-b using dataflow 250-f. In some other cases, communication between the platform server 201-b and AI servers 211-b may involve the use of an API. For instance, as shown in FIG. 2B, the platform server 201-b may be configured to communicate with API 202-b using communication link 251-d. Additionally, the API 202-a may communicate with AI server(s) 211-b using communication link 251-e. In other words, the present disclosure can be implemented via direct communication between the platform server 201-b and the AI servers 211-b or indirect communication (i.e., using the optional API 202-b) between the platform server 201-b and the AI servers 211-b. In some cases, the API 202-b can serve as a backup-link, for instance, if the direct communication link using dataflow 250-f is down or experiencing network issues. Similarly, the direct communication link (i.e., using dataflow 250-f) can also serve as a back-up if one or more of the API 202-b, communication link 251-d, and/or communication link 251-e are out of order. In some instances, the platform server 201-b can be configured to decide which one of the communication options (i.e., with or without API 202-b) should be utilized based on one or more factors, such as, but not limited to, latency, network outages, power outages, and/or estimated power consumption, to name a few non-limiting examples).

In some examples, the platform server 201-b may also provide a chat-based AI educational guidance system, which allows direct user inputs to the conversational educational agent 231. The conversational educational agent 231 may be embodied in hardware, software, or a combination thereof. Furthermore, the conversational educational agent 231 may be implemented within the platform server 201-b. For example, the conversational educational agent 231 may be implemented using one or more of the modules described in relation to FIG. 1, including at least the user dataset module 101, ruleset module 102, AI module 103, user input identification module 105, response determination module 104, and/or response generation module 108.

In some aspects, the platform server 201-b comprising the conversational educational agent 231 may serve as an educational tool to support a human user or learner (e.g., user 206-g, user 206-h). In such cases, one or more learners/users can access the disclosed AI educational guidance tool via a web browser on a computing device (e.g., laptop, smartphone, tablet computer, to name three non-limiting examples), a software program installed on the computing device, or through other applicable means known or contemplated in the art. For example, users 206-g and 206-h may interact with platform server 201-b using their computing devices 205-g and 205-h, respectively. The interaction may include sending/receiving chat messages over communication links 251-f or 251-g.

In some embodiments, the platform server 201-b is configured to receive educational content and source material from a human instructor (e.g., user 206-f associated with computing device 205-f). In this example, the arrow 250-e represents the bi-directional flow of data between the computing device 205-f and the platform server 201-b. In some embodiments, the platform server 201-b can also receive data input(s) 275, where the data input(s) 275 may include educational-content-specific datasets and/or learner-specific datasets. In some embodiments, an educational-content-specific dataset may include learning or source materials (e.g., operational manuals, textbooks, previous exams or quizzes, a white paper, a research article, a scientific journal, etc.). Additionally, or alternatively, an educational-content-specific dataset may include information pertaining to content data and analytics (e.g., average submission time for a question, average time taken by users to complete a module or a quiz, statistical distribution of learner's second attempt durations, difficulty level of a module, difficulty level of a question, difficulty level of a quiz, to name a few non-limiting examples). In some embodiments, a learner-specific dataset may include learner data (e.g., information pertaining to a learner's familiarity or expertise level with the educational content, information pertaining to a learner's speed with respect to other learners, information pertaining to a learner's demographic information, information pertaining to a learner's occupational experience, etc.). In some cases, a learner-specific dataset may also include information pertaining to a learner's interaction history with the educational content (e.g., the learner is attempting to answer a question for a second time), information pertaining to a learning history (e.g., the learner has about 45 minutes of previous experience with the AI educational guidance system), and any other applicable information for a learner.

In some embodiments, the platform server 201-b also receives a plurality of rulesets 276. In some examples, one or more of the plurality of rulesets may be associated with a scientific learning principle (e.g., spacing effect, interleaving effect). The platform server 201-b can also receive at least one user dataset from each of the user devices 205-g and 205-h. Further, the platform server 201-b is configured to access the plurality of rulesets 276, where at least one of the plurality of rulesets is associated with at least one cognitive scientific learning principle. The platform server 201-b is configured to apply at least one ruleset to each of the user datasets. In some embodiments, the user datasets are received from the user devices 205-g, 205-h over communication links 251-f, 251-g, respectively. In some embodiments, the platform server 201-b is configured to generate a personalized response associated with one or more of the plurality of rulesets 276, where generating the personalized response is based on applying the at least one ruleset to the one or more user datasets. In some examples, the platform server 201-b is configured to transmit the personalized response to the user device(s) 205 using communication link(s) 251.

In some embodiments, generating the personalized response is further based on the platform server 201-b applying the at least one ruleset 276 to one or more of the educational-content-specific dataset and the learner-specific dataset. Additional details on generating the personalized response are described above with reference to FIG. 2A, as well as in other portions of the disclosure.

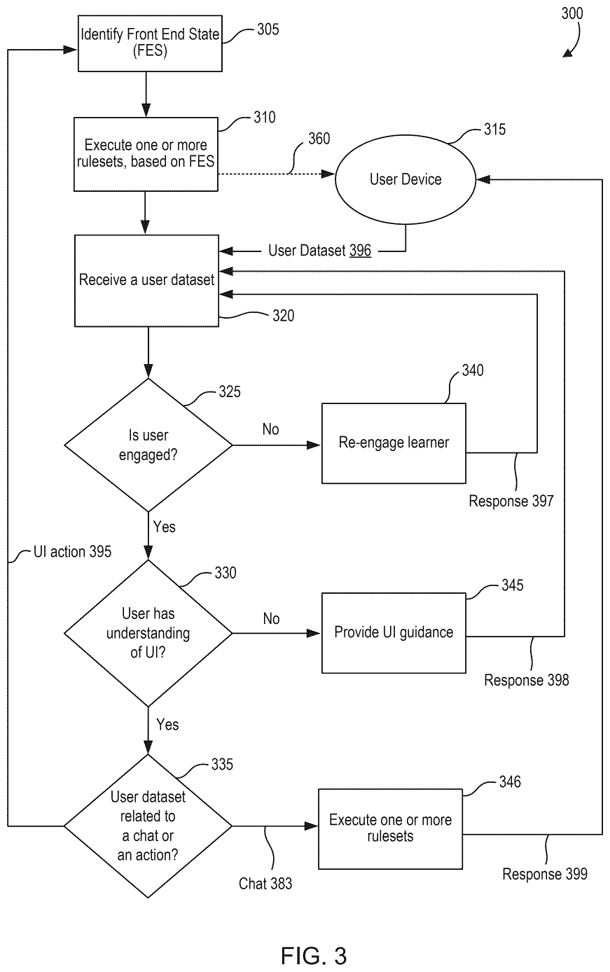

FIG. 3 illustrates an example of a method 300, according to various aspects of the disclosure.

As seen, a first operation 305 of the method 300 may comprise identifying a new front end state. Some non-limiting examples of a front end state may include a user reaching a module intro page, the AI educational guidance system (e.g., AI educational guidance system 100 in FIG. 1) or the LMS (e.g., e-learning system 225, which may be referred to as LMS 225 in some examples) asking the user a new question, the user or learner selecting an answer to a question, the user or learner submitting an answer to a question, to name a few non-limiting examples. In some instances, a new front end state may include receiving a user dataset from a user device. As noted above, a user dataset may be related to a user interaction with a UI associated with an e-learning system (e.g., e-learning system 225 in FIG. 2A). Alternatively, a user dataset may be related to a direct user input to a conversational educational agent 231, as described above in relation to FIG. 2B. In some cases, a new front end state may be reached when the user or learner interacts with the UI associated with the e-learning system, where the UI is displayed on the user device. In such cases, the AI educational guidance system 100 is configured to determine whether to generate and transmit a personalized response to the learner's user device or refrain from transmitting a personalized response to the learner's user device. It should be noted that, the AI educational guidance system 100 is configured to generate and transmit a personalized response to the user device when the user dataset is related to a direct user input (e.g., chat message) to the conversational educational agent. Said another way, if a user or learner interacts with the UI, the AI educational guidance system 100 may or may not generate and transmit a personalized response. However, if a user dataset is related to a direct user input from the user device, the AI educational guidance system will generate and transmit a personalized response to the user device.

In some cases, a second operation 310 comprises executing one or more rulesets, based on the new front end state. In some examples, the AI educational guidance system is configured to access a plurality of rulesets (e.g., rulesets 276) before executing the one or more rulesets. As noted above, in some cases, at least one of the plurality of rulesets is associated with at least one cognitive scientific learning principle.

In some cases, a third operation 320 comprises receiving a user dataset 396 from the user device 315, where the user dataset 396 may be received within a dataflow. In some cases, the user dataset 396 is related to a user interaction with a UI associated with the e-learning system. For example, the user interaction may comprise the user selecting an answer choice to a multiple-choice question, the user clicking on a ‘Next question’ button, the user selecting a button to display a hint for a question, to name a few non-limiting examples. Alternatively, the user dataset 396 may be related to a direct user input (e.g., a chat message, a textual input) to a conversational educational agent (e.g., shown as conversational educational agent 231 in FIG. 2B) of the AI educational guidance system 100. In some aspects, the conversational educational agent (e.g., conversational educational agent 231 in FIG. 2B) serves to support the human user or learner with their educational needs.

In some cases, a fourth operation 325 comprises determining whether the user or learner is engaged with the AI educational guidance system. If not, the method 300 proceeds to operation 340, where operation 340 comprises re-engaging the learner. In some cases, determining whether the user/learner is engaged or not may comprise determining that the chat message received from the user/learner included an off-topic text input. In some other cases, determining whether the user/learner is engaged or not may be based on comparing the timestamp data for a user dataset to a threshold duration, where the threshold duration is associated with a system timeout (e.g., lack of any user interaction with the UI). As an example, the AI educational guidance system may be configured to determine that a user or learner is not engaged when the user does not interact with the UI or input a chat message for a threshold duration (e.g., 3 minutes, 5 minutes, 15 minutes, to name a few non-limiting examples). In some other cases, the AI educational guidance system 100 may be configured to determine that the user or learner is not engaged when the timestamp data indicates that the user/learner has selected an answer choice almost immediately after the question was displayed in the UI. For instance, the AI educational guidance system 100 may compare the timestamp data for a user responding to a particular question to the average time taken by other users/learners for that same question. In such cases, if the timestamp data is significantly lower (e.g., 50% less than the average, 75% less than the average), then the AI educational guidance system 100 may determine that the learner is not engaged. In some embodiments, re-engaging the learner (operation 340) may comprise generating and transmitting a response 397 to the user device (e.g., response 397 may include a message such as “Let's take a break and resume this module at another time. Good job today!”).

If the user is engaged, the method 300 may proceed to operation 330, where operation 330 comprises determining whether the user/learner has an understanding or familiarity with the UI associated with the e-learning system, such as e-learning system 225. If not, the method 300 proceeds to operation 345, where operation 345 comprises providing UI guidance to the user or learner, where the UI guidance may be initiated by transmitting a personalized response 398 to the user device. If yes, the method 300 proceeds to operation 335, where operation 335 comprises determining whether the user dataset is related to a user input (e.g., chat message or text input) directly to the AI educational guidance system 100, or whether the user dataset is related to a user interaction (e.g., clicking or selecting an option, such as an answer choice or a button, from the user device) with the UI.

If the AI educational guidance system determines at operation 335 that the user dataset is related to a chat message (e.g., chat message 383, also referred to as textual input 383), the method 300 proceeds to operation 346, where operation 346 comprises executing one or more rulesets of the plurality of rulesets. In some cases, at least one of the one or more rulesets may be associated with at least one cognitive scientific learning principle (also referred to as a cog sci principle). In some cases, the method 300 then comprises generating a personalized response 399 (or utterance 399) and transmitting the personalized response 399 to the user device 315. Alternatively, if the AI educational guidance system 100 determines at operation 335 that the user dataset is related to a UI action 395, the method 300 loops back to operation 305.

In some cases, as shown by the dashed arrow in FIG. 3, the AI educational guidance system 100 is configured to generate and transmit a personalized response 360 to the user device 315 associated with the user, where generating and transmitting the personalized response 360 is based on executing the one or more rulesets.

As used herein, the term “unsolicited input” or “unsolicited user input” may refer to a user input corresponding to when a new front-end state (FES) has been reached because the user has interacted with the platform's UI, i.e., the user has not typed a chat message. In such cases, the AI educational guidance system 100 (also shown as platform server 201-a) is configured to determine whether to generate and transmit a personalized response to the user device or remain silent (i.e., refrain from generating and transmitting a personalized response to the user device, suppress transmitting a personalized response). While a user interaction with the UI results in a new front end state, a user typing a chat message (i.e., a direct user input to a conversational educational agent) may or may not result in a new front end state.

As used herein, the term “solicited input” or “solicited user input” may refer to a direct user input. For example, the direct user input may correspond to a user sending a chat message or text input to the AI educational guidance system 100, e.g., via a chat-bot or conversational educational agent associated with the AI educational guidance system 100. FIG. 2A depicts an optional conversational educational agent 231 (shown as optional by the dashed lines), where the optional conversational educational agent 231 is one of: residing or implemented on the platform server 201-a, or alternatively, communicatively coupled to the platform server 201-a. In some embodiments, such as the one described with reference to FIG. 2B, the platform server 201-b comprises the conversational educational agent 231. As noted above, the conversational educational agent 231 can be implemented using hardware, software, or a combination thereof. In such cases, the AI educational guidance system 100 is configured to determine an appropriate personalized response to generate and transmit to the user device (e.g., remote platform 144 in FIG. 1, user or computing devices 205-g, 205-h in FIG. 2B). Typically, the AI educational guidance system 100 is configured to generate and transmit a personalized response to the user whenever it receives a direct chat message or text input from the user device.

As used herein, the term “fine tuning” may refer to providing the AI educational guidance system 100 with a plurality of examples of utterances, personalized responses, outputs, etc., into a response model (e.g., response model 847-a and/or response model 847-b in FIG. 8) associated with the AI educational guidance system. In some aspects, providing such examples (i.e., examples of utterances, personalized responses, and/or outputs) can facilitate training of the response model 847-b, and thereby assist the AI educational guidance system 100 in conversing with the learner and making appropriate decisions when faced with specific scenarios. As an example, the response model 847-b (e.g., implemented within response guidance module 882 in FIG. 8) of the AI educational guidance system may be provided with a plurality of examples (e.g., 20 examples, 50 examples, etc.) of appropriate language to display on the user device when the user arrives on the “Welcome to this module” page. In some aspects, this may allow the AI educational guidance system 100 to display Welcome Messages that have certain language qualities or attributes (e.g., polite, friendly, non-offensive, effective, and/or concise) when a user starts a new module. In another example, the response model of the AI educational guidance system may be provided with a plurality of example responses for scenarios when the AI educational guidance system should transmit unsolicited responses (i.e., personalized responses that are sent despite not receiving any direct chat message or text input from the user). In yet another example, the Response Model of the AI educational guidance system may be provided with a plurality of scenarios/instances where the AI educational guidance system should refrain from generating and transmitting a personalized response to the user device, e.g., despite identifying a user interaction with the UI displayed on the user device. For instance, the AI educational guidance system 100 may be configured to remain silent (i.e., refrain from generating and transmitting a personalized response to the user device, or suppress transmitting a personalized response) when the user simply clicks on a “Next Question” button to proceed from the 2nd to the 3rd question on a ten (10) question module and when the user is engaged with the UI. However, the AI educational guidance system may be configured to generate and transmit a personalized response to the user device when the user clicks on a “Next Question” button to proceed from the 2nd to the 3rd question on a ten (10) question module and when the system detects a lack of user engagement with the UI.

As used herein, the term “Retrieval Augmented Generation” or “RAG” may refer to the generation of one or more vectors out of portions (or chunks) of the educational content to assist the AI educational guidance system 100 in referencing source material (e.g., a textbook in a PDF or e-book format, a 50-slide presentation, a past exam, an outline created for a law school course, to name a few non-limiting examples) when determining what to converse about with the user(s). In some aspects, RAG can help enhance the AI educational guidance system's ability in conversing with the user about the to-be-learned educational material and help it “hallucinate” less. In some other aspects, RAG can also help prevent the AI educational guidance system from conversing (i.e., presenting or displaying information, generating personalizing responses, to name two non-limiting examples) about topics outside the scope of the to-be-learned educational material.

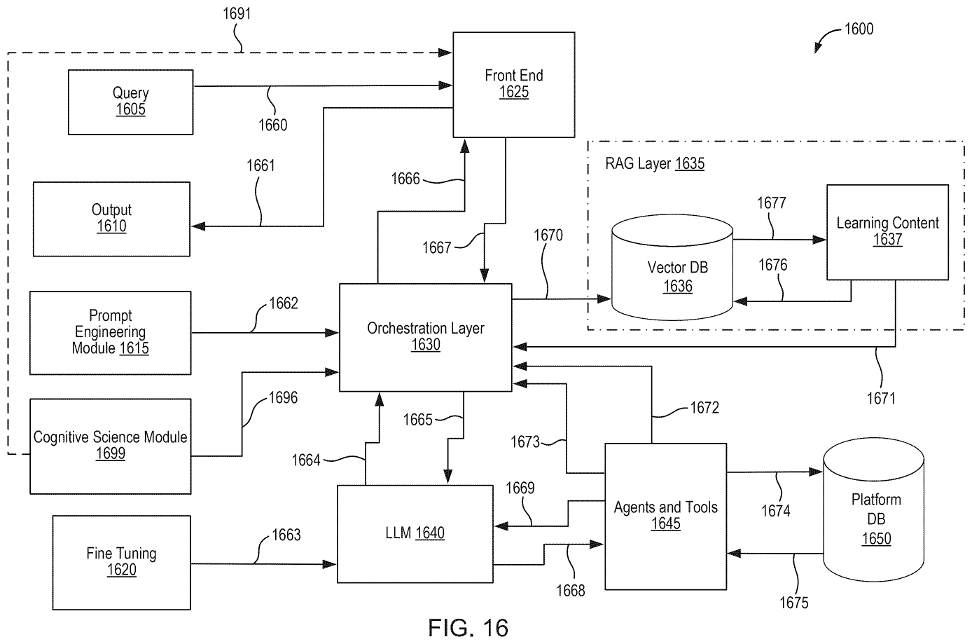

As used herein, the terms “AI Prompt Engineering” or “Prompt Engineering” may be used to refer to the generation of AI prompts (or simply, prompts) for the AI module (e.g., AI module 103) that can help assist the AI module in generating the personalized responses, utterances, outputs, etc., that are transmitted to the user device. In some aspects, AI Prompt Engineering (or Prompt Engineering) refers to the process of generating one or more AI prompts (also referred to as prompts) for the AI module, such as AI module 103, where each of the one or more prompts include constraints for restricting (or even suppressing) the response/output generated by the AI module. In some instances, generating the personalized response is based on generating at least one AI prompt, where generating the at least one AI prompt comprises providing one or more constraints to the AI module. In such cases, the AI module can provide one or more intermediary responses for the one or more constraints. Furthermore, generating the personalized response may be based in part on concatenating the plurality of intermediary responses. In some cases, the one or more constraints may be associated with at least one cognitive scientific learning principle. Said another way, aspects of the present disclosure are directed to constraining Artificial Intelligence (AI) or Large Language Models (LLMs), such as LLM 1640 in FIG. 16, to behave in a way that is more consistent with cognitive scientific learning principles (or cog sci principles), which can help optimize user learning, as compared to the prior art. In doing so, the communication (e.g., personalized responses/utterances) transmitted to the user can facilitate long-term information retention for the user, as well as optimize the user's ability to transfer and apply learned concepts to related situations.

In some ways, a cognitive science-adherent LLM, such as the one disclosed, is not just an LLM that is more polite or sounds more authoritative than an LLM in the prior art. Instead, a cognitive science-adherent LLM is designed to employ scientifically proven and well-established cognitive scientific learning principles in a digital learning environment (e.g., e-learning environment, a learning management system or LMS) which may assist in long-term information retention and more optimized learning for the end-user, as compared to the prior art. In some aspects, the unintuitive nature of these optimal cognitive scientific principles coupled with the complexity involved in implementing them (e.g., in the classroom, in a digital learning system) has resulted in their limited use within the educational environment. In other words, such optimal cognitive scientific learning principles are rarely implemented in instructional materials and/or educational experiences, let alone existing digital learning systems. This has led to a significant paucity in the number of instructional materials and/or educational experiences that adhere to such well-established cognitive scientific learning principles as compared to those that do not, with the former being in the substantial minority. Furthermore, the high prevalence of educational and instructional materials incorporating sub-optimal learning principles has resulted in sub-optimal training of AI (including AI utilizing LLMs), including AI used in existing digital or e-learning systems, because non-science-adherent instructional materials are the majority of those represented in training datasets (i.e., training corpuses). As a result, existing digital or e-learning systems suffer some drawbacks due to their unconstrained reliance on training datasets that incorporate intuitive, popular, but sub-optimal learning principles (e.g., massing instead of spacing), which leads to a sub-optimal learning experience for the user or learner. To alleviate these issues, aspects of the present disclosure are directed to a refined AI educational guidance system that can be configured to be constrained to employ non-intuitive and infrequently used cog sci principles over the more popular intuitive and popular learning principles, because of the demonstrated superiority of the former over the latter.

As an example, the AI educational guidance system 100 employing a cognitive science-adherent LLM may be configured to harness the Pretesting Effect scientific learning principle while instructing a user, where the instruction may be implemented by way of a learning module presented via the UI on the user device. In such cases, the AI educational guidance system (e.g., system 100 in FIG. 1) may automatically generate questions related to the learning material and ask them to a user, even before presenting the associated learning material to the user, thereby priming the user's brain to retain and apply the material in a more optimized manner. As an example, if the AI educational guidance system receives, as source content (i.e., educational content or learning material), an Electromagnetics Course textbook for a sophomore level Electrical Engineering course, the AI educational guidance system may be configured to (a) automatically parse the Electromagnetics Course textbook, (b) automatically generate a high-level intro for the Electromagnetics Course, (c) display the high-level intro for the Electromagnetic Course on the user device, (d) automatically generate one or more questions related to the educational course based on harnessing the Pretesting Effect scientific-learning principle, (e) display the one or more questions on the user device before providing instruction related to the Electromagnetics Course, thereby harnessing the Pretesting Effect scientific learning principle, (f) receive one or more user datasets (e.g., related to direct user inputs, such as chat messages; or related to user interactions with the UI associated with the e-learning system) from the user device, (g) parse the one or more user datasets into the cognitive science adherent LLM (e.g., LLM 1640 in FIG. 16), and (h) generate one or more follow-up personalized responses in response to receiving and parsing the one or more user datasets. As noted above and elsewhere in the disclosure, an LLM can be configured as a cognitive science adherent LLM by the incorporation of one or more constraints into the one or more rulesets that are forced upon the LLM. Said another way, the link between the rulesets (i.e., rulesets associated with at least one cognitive scientific learning principle) and the constraints facilitates the generation of AI prompts that are cognitive science adherent, which in turn enables the generation of personalized responses that are also cognitive science adherent. It should be noted that not all of the steps (a) through (h) may be needed to harness the Pretesting Effect scientific learning principle, and one or more of the steps may be optional in some embodiments. Furthermore, the order in which the steps (a) through (h) are described above is exemplary only, and one or more of the steps may occur out of order, or in a different order, in some embodiments.

Additionally, or alternatively, the AI educational guidance system may be configured to utilize the Delayed Corrective Feedback scientific learning principle, which involves waiting to provide corrective feedback after the user accesses the educational content. In some instances, if a user provides an answer to a question and answers it incorrectly, the AI educational guidance system 100 employing the Delayed Corrective Feedback scientific learning principle is configured to wait for a threshold duration and/or until a threshold number of questions following the initial question are answered by the user before providing corrective feedback to the user. In some examples, delayed corrective feedback may include the AI educational guidance system 100 summarizing the feedback over multiple user attempts on the same or related questions. For example, if the system asks a user “Why do seasons on earth change over the course of a year?” and a user responds “I don't know. Maybe because the earth is farther away from the sun in winter than in summer?” the AI prompt and constraints may cause the system to generate a response such as “All right, thanks” and proceed to displaying another question about a related topic that the user is also learning about. In some cases, the AI educational guidance system 100 may be configured to employ a plurality of cognitive scientific learning principles in parallel, a plurality of cognitive science learning principles in series, or a combination thereof. For instance, in the previous example, where the AI prompt and constraints caused the system to generate an “All right, thanks” response and proceed to another question on a related topic, the AI educational guidance system was harnessing both the Delayed Feedback scientific learning principle and the Interleaving scientific learning principle, where the Interleaving scientific learning principle comprises interspersing related concepts (e.g., shuffling together study on multiple topics in a single learning session), which can also facilitate more optimized learning. After the threshold duration and/or threshold number of questions, the AI educational guidance system may cause the system to: generate a response such as “When we were talking about why seasons on earth change over the course of a year, you suggested it might be related to the earth's distance from the sun. That's a good thought, but it's actually because of the earth's tilt with respect to the sun. In winter, part of the planet is tilted away from the sun and gets less solar energy during the day, so it's colder. In summer, that part of the planet is tilted toward the sun, so it's warmer.”

In further examples, the AI educational guidance system 100 is also configured to harness the Spacing Effect learning principle for determining one or more of the AI prompts, constraints, and/or intermediary responses that are utilized to generate the personalized response presented to the user. As an example, instead of immediately honoring a user's request for an explanation on an educational topic or immediately displaying the answer to a question, as in the prior art (including 3rd party AI chat-bots), the AI educational guidance system 100 may be configured to employ and harness the Spacing Effect learning principle by spreading learning on a particular concept/topic over time, which can also serve to enhance user learning and retention. In one non-limiting example, the AI educational guidance system 100 may be configured to explain the correct reasoning for a particular question after some time (e.g., may be a pre-defined duration, such as at least 1 hour, at least 2 hours, etc., may be a pre-defined number of questions, such as at least 1 question, at least 4 questions, etc., or a combination thereof) has passed since the user was initially displayed that question. It should be noted that, the Spacing Effect learning principle may only be employed when the user asks a question (e.g., What is the correct answer for why the seasons change on earth?) that is directly related to the educational content that the user is learning about, as opposed to a general question about the UI of the educational guidance system or a general question (e.g., What module are we on?) about the course, module, etc. This helps ensure that the Spacing effect is not utilized in situations where its use can adversely impact user experience. In some examples, if the system determines that a user needs to be asked a question again (e.g., if the user was confident and incorrect), instead of immediately asking the same question again, the constraint placed by the Spacing Effect scientific learning principle forces the system to ask the same or a similar question only after a threshold duration (e.g., some number of minutes, for instance, 5 minutes) has passed and/or a threshold number of other questions (e.g., at least 3 unrelated questions) have been asked to the user and/or a threshold number of unrelated explanations (e.g., explanations or deliveries of corrective feedback for other questions) have been encountered by the user.

As used herein, Generation Effect refers to the finding that people learn better when they produce something. While some positive effects can be found by just having the user/learner write something out or say aloud something about a particular topic or concept, these positive effects can be further amplified when the user/learner creates a new or original explanation related to that topic or concept, where the new or original explanation may even include an explanation for why they were wrong when previously answering a question about that topic.

As used herein, Metacognition may refer to a user's assertion or belief regarding their knowledge, familiarity level, etc., on a particular topic or concept. Simply put, Metacognition for a specific user can be assessed based on the user's responses to one or more of the following questions (or variants thereof): 1) “What do you know about what you know?” or 2) “What do you think about what you think?”. As an example, a Metacognitive assertion may be a user saying, “I think I know about 70% of the material in this Astronomy book”. Another example of a Metacognitive assertion may be when that same user says, “I'll probably forget this after a week.” In some examples, tapping into Metacognition can also help learning. In accordance with aspects of the present disclosure, Metacognition can be implemented by collecting self-assessed confidence level(s) on one or more topics, concepts, subjects, etc., from a user.

In certain situations, the AI educational guidance system 100 may also be configured to harness one or more of the Metacognition scientific learning principle and the Generation Effect scientific learning principle, which may comprise generating and displaying personalized responses that help the user or learner explore their own thinking in a manner that facilitates more optimized learning, as compared to the prior art. For instance, returning to the earlier example, instead of directly providing the correct answer to the question “Why do the seasons on earth change?” and/or telling the user why they were incorrect when they responded, “I don't know, maybe because the earth is farther away from the sun in winter than in summer,” the AI educational guidance system 100 may be configured to present the user with another related question that helps the user re-analyze their original thinking by producing more thinking, which in turn can assist a user develop their critical thinking skills. As an example, the AI educational guidance system may be configured to generate and display a personalized response, such as “A few minutes ago, you said that the seasons change because the earth is farther away from the sun in winter than in summer. But if that were true, how can it be summer in the United States at the same time as it is winter in Australia?” which can help guide the user in the right direction or at least help them determine that Earth-to-Sun distance may not be the cause of earth's seasons as they had previously thought. Furthermore, the AI educational guidance system 100 can also provide the user with the correct answer that the seasonal change on earth is associated with the earth being tilted ˜23 degrees on its axis. In some examples, the AI educational guidance system 100 can also display a video or animation showing how the earth's tilt on its axis results in each of the northern and southern hemispheres being tilted towards the sun during their respective summers and away from the sun during their respective winters. In some embodiments, the AI educational guidance system 100 may be configured to generate and display one or more additional questions (e.g., a personalized response posing a question, such as “Why do areas above the Artic Circle and below the Antarctic Circle experience polar night and polar days?”) that further lean on this axis-tilt concept, which can further serve to enhance user learning and retention as compared to the prior art.

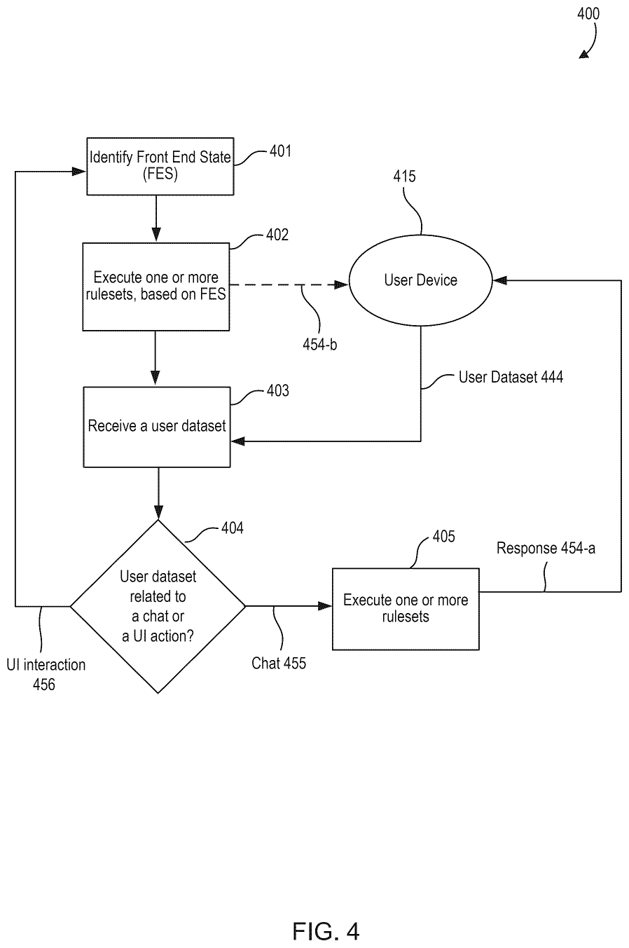

FIG. 4 illustrates an example of a method 400, according to various aspects of the disclosure. As seen, a first operation 401 of the method 400 may comprise identifying a new front end state. Some non-limiting examples of a front end state may include a user reaching a module intro page, the AI educational guidance system or the LMS asking the user a new question, the user or learner selecting an answer to a question, a user or learner submitting an answer to a question, to name a few non-limiting examples. In some instances, a new front end state may include receiving a user dataset from a user device. As noted above, a user dataset may be related to a user interaction with the UI associated with the e-learning system (e.g., e-learning system 225 in FIG. 2A). Alternatively, a user dataset may be related to a direct user input to the conversational educational agent, such as conversational educational agent 231 in FIGS. 2A and/or 2B. In some cases, a new front end state may be reached when the user or learner interacts with the AI educational guidance system's UI. In such cases, the AI educational guidance system is configured to determine whether to generate and transmit a personalized response to the learner's user device or suppress transmitting a personalized response to the learner's user device (i.e., refrain from transmitting a personalized response to the learner's user device). It should be noted that the AI educational guidance system is configured to generate and transmit a personalized response to the user device when the user dataset is related to a direct user input (e.g., chat message) to the conversational educational agent.

In some cases, a second operation 402 comprises executing one or more rulesets, based on the new front end state. In some examples, the AI educational guidance system is configured to access a plurality of rulesets (e.g., rulesets 276) before executing the one or more rulesets. As noted above, in some cases, at least one of the plurality of rulesets is associated with at least one cognitive scientific learning principle.

In some cases, a third operation 403 comprises receiving a user dataset from the user device 415, where the user dataset comprises a chat message 455 (or textual input 455), and where the chat message 455 is received via a dataflow (shown as the arrow connecting decision block 404 and block 405; also shown as dataflow 396 in FIG. 3). In some cases, the user dataset 444 is related to a user interaction with a UI associated with the e-learning system. For example, the user interaction may comprise the user selecting an answer choice to a multiple-choice question, the user clicking on a ‘Next question’ button, the user selecting a button to display a hint for a question, to name a few non-limiting examples. Alternatively, the user dataset may be related to a direct user input (e.g., a chat message) to the conversational educational agent. In some aspects, the conversational educational agent serves to support the human user or learner with their educational needs.

Next, the method 400 may proceed to operation 404, where operation 404 comprises determining whether the user dataset received at operation 403 is related to a user input (e.g., chat message 455) directly to the AI educational guidance system, or related to a UI interaction 456 (e.g., clicking or selecting an option, such as an answer choice or a button, from the user device).

If the AI educational guidance system determines at operation 404 that the user dataset is related to a chat message 455, the method 400 proceeds to operation 405, where operation 405 comprises executing one or more rulesets of the plurality of rulesets. In some cases, at least one of the one or more rulesets may be associated with at least one cognitive scientific learning principle (also referred to as a cognitive science principle, or cog sci principle, or cog sci learning principle, or learning principle). In some cases, the method 400 then comprises generating a personalized response 454-a (or utterance 454-a) and transmitting the personalized response 454-a to the user device 415. Alternatively, if the AI educational guidance system determines at operation 404 that the user dataset is related to a UI interaction 456, the method 400 may loop back to operation 401, where operation 401 comprises identifying that a new front end state has been reached. As noted above, although a user interaction with the UI typically results in a new front end state, a user typing a chat message (i.e., a direct user input to a conversational educational agent) may or may not result in a new front end state.

In some cases, as shown by the dashed arrow in FIG. 4, the AI educational guidance system is configured to generate and transmit an optional personalized response 454-b (i.e., utterance 454-b) to the user device 415, where generating and transmitting the personalized response or utterance 454-b is based on executing the one or more rulesets 402.

In accordance with aspects of the present disclosure, some non-limiting examples of an AI prompt provided to the AI module of the AI educational guidance system may include informing an AI module (1) to introduce/welcome a learner to the educational module or course they are currently taking, (2) that a learner can take a plurality of courses through the educational platform, (3) that a learner does not have to finish the educational course or module in one sitting, (4) that a learner can save their progress and return to the educational course at a later time, (5) about the course that a learner or user is taking and through which educational platform, (6) that the AI module may or may not always have information related to the user's past experience with the UI of the educational guidance system, (7) that the AI module may or may not always have information related to whether the learner or user has used the UI of the educational guidance system for a different course/module in the past, and/or (8) that the AI module may or may not always have information related to the user's progress through the course and the user's past use of the AI educational guidance system.

In accordance with aspects of the present disclosure, some non-limiting examples of an AI prompt woven with a ruleset and provided to the AI module 103 of the AI educational guidance system 100 may include instructing the AI educational guidance system to generate personalized responses (e.g., a message to introduce/welcome a learner to the educational module) that are (1) not repetitive to a repeat learner/user who already has experience with the educational platform, and/or (2) do not leave a first-time user or novice user without adequate knowledge of the educational platform.

In accordance with aspects of the present disclosure, an AI prompt may include one or more variables and corresponding values that can assist the AI educational guidance system 100 with response generation. For example, the AI prompt may comprise a brand_new_learner variable and the AI educational guidance system can use the value provided for said variable during response generation. In one non-limiting example, if brand_new_learner==1, the AI educational guidance system 100 may determine that the user/learner is using the AI educational guidance system for the first time. Similarly, if brand_new_learner==0, the AI educational guidance system 100 may determine that the user/learner has used the educational platform before. In another example, the AI prompt may comprise a prev_module_experience variable, where the value of ‘0’ for the prev_module_experience variable is used to indicate that the user/learner has no previous experience with that module. In such cases, the AI educational guidance system 100 may follow the initial Welcome message with another response/message informing the user regarding what they will be learning from the educational module. Similarly, if the prev_module_experience variable has a value of ‘1’, the system 100 may determine that the user has previous experience with said educational module. In this case, the AI educational guidance system may generate a personalized response to welcome the user back to the module.

In some cases, the guidance system 100 is configured to access one or more rulesets for identifying one or more rules pertaining to a specific scenario. For example, a ruleset may be used to indicate to the system as to how brief or detailed a specific personalized response should be, based on the variables and values provided in the AI prompt. In one non-limiting example, if brand_new_learner==1, the ruleset may dictate that the introductory/welcome response should be at or around 6 sentences in length and should have a warm, friendly, and enthusiastic tone. Alternatively, if brand_new_learner==0, the ruleset may dictate that the welcome message should be <2 sentences in length and should have a somewhat more businesslike tone. In another example, if prev_module_experience==0, the personalized response generated following the introductory/welcome response should be at least 2 but not more than 4 sentences in length. Alternatively, if prev_module_experience==1, the personalized response generated following the introductory/welcome response should be a single sentence.

As noted above, response tuning (e.g., fine tuning 808, fine tuning 828 in FIG. 8) and/or prompt engineering (e.g., prompt engineering 848 in FIG. 8) may be employed to assist the guidance system in automatically generating and transmitting responses to the user device, based on identifying a specific scenario or situation. In one non-limiting example, response tuning and/or prompt engineering may be deployed by providing the AI module (e.g., AI module 103) with a file comprising instructions, sample responses, etc., that the AI module can utilize while generating responses. For example, the AI module may utilize the provided file to construct its responses so that they have a conversational and excited tone when a user/learner is requesting additional information on the educational course, educational module, educational platform, method by which the educational platform can optimize learning, etc. Additionally, or alternatively, the AI module can utilize information in the provided file to generate responses that are tailored to instances where the learner simply wants to get started on the module, without any additional information. In such cases, the AI prompt, ruleset, and/or constraints may cause the AI educational guidance system to generate a personalized response along the lines of “Do you have any further questions before we get started? If not, please select the Next button” followed by displaying a clickable “Next” button in the UI on the user device.

In some instances, a user or learner may provide off-topic text inputs or chat messages that are unrelated to the educational course or module. In such cases, the educational guidance system is configured to access a ruleset (e.g., a ruleset for re-engaging the learner, or bringing the learner back-on-track) and apply the ruleset to generate and transmit a personalized response to the user device.

In some instances, a ruleset may dictate that the AI educational guidance system should periodically generate a personalized response for checking-in with the user if they had any questions or concerns regarding the system, based on detecting that the user has not sent any user inputs (e.g., text input, chat message) to the system for a pre-defined threshold duration.

In some embodiments, the AI educational guidance system is configured to receive informational content, supporting materials, educational content items, primary sources, etc., from an individual for any of an educational course/module, new employee orientation material for a corporation, new student orientation material for a university, etc. In some cases, the informational content may be received as a single file or in multiple files. If received in multiple files, the educational platform may be configured to process and compile the information from the multiple files into a single file and transmit it to the AI educational guidance system. Alternatively, the educational platform may be configured to leave the multiple files in their original form. In either case, an AI prompt may comprise information related to the file(s) associated with the educational course/modules, as well as instructions for generating questions to display via the UI on the user device. In some embodiments, the AI prompt(s) may be associated with a scientific-learning principle ruleset, such as the interleaving effect or spacing effect, in which case the questions assembled by the AI educational guidance system and displayed on the user device may be constrained to match said ruleset. For instance, a ruleset for harnessing the interleaving effect may cause the AI educational guidance system to automatically intersperse questions from different, but related, concepts for display on the user device, where the different concepts are automatically identified from the source material. In some cases, the informational content may comprise educational content, where the educational content is received from a human instructor (e.g., user 206-a, where user 206-a may be a professor, a teaching associate or TA, a high-school teacher). In some other cases, the individual providing the informational content need not be an instructor and the informational content may or may not include educational content. For example, an individual associated with a corporation (e.g., training manager, Chief Learning Officer, etc.) at a corporation may be able to provide, to the AI educational guidance system 100, one or more of: an employee handbook in the form of a PDF file for the corporation, a harassment policy for the corporation as an intranet link or a Word document, and/or orientation materials for the corporation as a PowerPoint presentation. In yet other cases, the AI educational guidance system 100 may be configured to receive informational content via a partially or completely automated process (i.e., implemented at an educational institution, a corporation, a hospital, an industrial facility, a factory, to name a few non-limiting examples).

In some examples, a ruleset for constructing/assembling questions from the source material may include information related to how questions should be constructed (e.g., conversational summary form, True-False question, multiple-choice question, and/or matching question, to name a few), whether the question should be followed with an utterance/output related to how the user should answer the question (e.g., an utterance/output indicating that the user should select only one of the answer choices using the UI should be displayed to the user, whether an utterance/output indicating that the user should type in their answer into a specific text-box should be displayed to the user). Rulesets for constructing/assembling questions from the source material may also be used to place constraints related to the content and language included within the questions (e.g., do not construct the question exactly as it was written in the source material, do not use the phrase “in order to” in any of the multiple-choice question answer choices, do not include information from a field labeled Explanation while constructing a question). In this way, rulesets may also be used to dictate how the AI educational guidance system 100 generates AI prompts and constraints that are then used to generate the personalized responses provided to users. A ruleset associated with a Don't Give Away The Answer scientific-learning principle may be used to ensure that the AI educational guidance system can only answer clarification questions related to a question, but not provide the correct answer to the question. Similarly, a ruleset associated with an off-topic input (e.g., an off-topic text input, an off-topic audio input, an off-topic screenshare input, to name a few non-limiting examples) may be used to help ensure that the AI educational guidance system 100 can generate appropriate responses (e.g., indicate to the user that they are off-topic and not engaged with the question) to bring the user back on topic upon detecting off-topic text inputs or chat messages from the user device. Additionally, or alternatively, rulesets can help ensure that the AI educational guidance system also remains on topic and does not deviate from information presented in the source material. In such cases, if the user types a chat message that is related to the source material (e.g., Middle-Ages Asian History) but not included in the source material (e.g., European and African Middle-Ages History), the AI educational guidance system may be configured to let the user know that the information they requested is not relevant to the current topic being discussed.

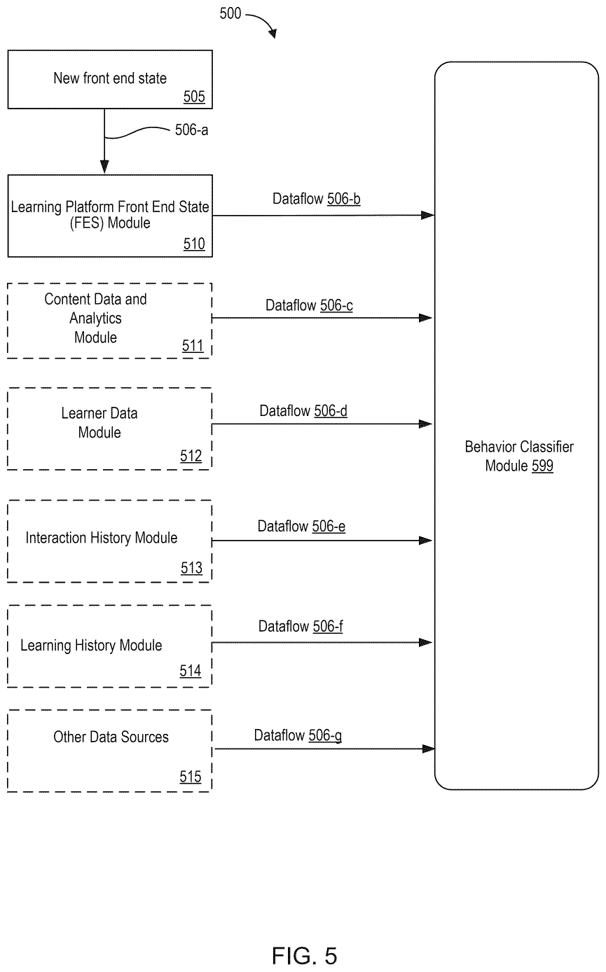

FIG. 5 illustrates an example of a block diagram 500, according to various aspects of the disclosure. Here, block diagram 500 depicts a behavior classifier module 599 that is configured to receive a plurality of inputs. For example, upon identifying a new front end state 505, the information related to the new front end state 505 can be utilized by one or more modules of the system, including a learning platform front end state module 510 (also referred to as learning platform FES module 510), a content data and analytics module 511, a learner data module 512, an interaction history module 513, a learning history module 514, and one or more other data sources 515. In some embodiments, the learning platform FES module 510 receives information related to the new FES 505 via dataflow 506-a.

The learning platform FES module 510, content data and analytics module 511, learner data module 512, interaction history module 513, learning history module 514, and other data sources 515 may communicate with the behavior classifier module 599 using dataflows 506-b, 506-c, 506-d, 506-e, 506-f, and 506-g, respectively.

For example, the learning platform front end module 510 may be configured to provide information related to a state of the front end (e.g., learner has submitted an answer to a question, the answer was selected and submitted within 4 seconds of the question being displayed on the user device) to the behavior classifier module 599.

The content data and analytics module 511 may be configured to provide information related to the average answer submission time for other users answering the same question (e.g., average user takes about 50 seconds to answer the question), distribution of other learners' second attempt durations (e.g., Gaussian distribution with a mean time of 44 seconds and standard deviation of 13 seconds), a difficulty level of the question (e.g., question is fairly difficult as only 30 % of users get it right on their first attempt), to name a few non-limiting examples.

In some embodiments, the learner data module 512 is configured to provide information that may be specific to the learner/user to the behavior classifier module 599, where the information may include the user's familiarity level with the educational course/module (e.g., user seems to be unfamiliar with the course material as they get less than 20% of the questions right on the first attempt), expertise level with the educational course/module (e.g., user demonstrates a high expertise level with the course material as they get less than 5% of the questions wrong on their first attempt and never have to answer a question more than twice), speed compared to other users (e.g., user is on average faster than 78% of other users in the same course/module, user completed this question in the 99th percentile for speed), etc.

In some cases, the learning history module 514 may provide information related to learning history (e.g., user has about 45 minutes of prior experience in the learning platform) to the behavior classifier module 599. Additionally, or alternatively, the interaction history module 513 may be configured to provide information (e.g., this is the user's second attempt to answer the question, this is the user's third attempt to complete the end-of-course questions as they are yet to receive a passing score of 75% or higher for this course) related to the user's interaction with a specific question, module, course, etc.

In some embodiments, the behavior classifier module 599 utilizes the information received via the dataflows 506-b, 506-c, 506-d, 506-e, 506-f, and/or 506-g to determine one or more of: general user attributes (e.g., general academic performance for a user for a range of courses, topics, subjects, concepts, etc.), general course-specific attributes (e.g., difficulty level), course-specific attributes for a particular user (e.g., user is struggling in multi-variable calculus, but has a solid grasp of digital circuits), real-time user-specific attributes (e.g., user is usually engaged and demonstrates good academic performance, but today's academic performance for the user is two standard deviations below their average academic performance), to name a few non-limiting examples. In some embodiments, the real-time user-specific attributes may or may not be specific to a particular course, subject, topic, module, chapter, concept, etc. In some embodiments, the behavior classifier module 599 may be configured to create a comprehensive and personalized behavioral profile for each learner/user of the system. In some cases, the behavior classifier module 599 may be configured to utilize the information received from the various dataflows 506-b through 506-g in isolation, in one or more combinations, and/or as a whole, which can not only help create an overall behavior classification or profile for a user, but also more specific and granular behavior classifications or profiles. For example, the behavior classifier module may be configured to generate a plurality of behavior classifications or behavior profiles for a user by considering numerous factors, including (but not limited to): 1) academic performance of the user for different courses, subjects, concepts, etc., 2) academic performance of the user for different topics or concepts within the same course, 3) variances (if any) of the user's performance for the same topic within the same course based on time of day, 4) variances (if any) of the user's performance for different courses (e.g., user's academic performance is higher when math quizzes are done in the morning, as compared to the afternoon or night, while academic performance on history or literature courses are consistently higher between 9 pm and 1 am, as compared to between 9 am and 6 pm), and/or 5) speed (e.g., typing speed, reading speed, etc.), as well as any other applicable factors, attributes, parameters, information, etc. In some cases, these factors may be assessed and evaluated to generate one or more behavior profiles for a user, including at least a high-level behavior classification or profile for a user (e.g., this user tends to try to take shortcuts) as compared to one or more other users of the system. In some other cases, these behavior classifications may be temporary (e.g., based on a 20% performance degradation over the last 15 minutes of this 3-hour study session, the user appears to need a break).

While not shown in FIG. 5, in some examples, the behavior classifier module 599 may be configured to relay the behavior classification or behavior profile information to the AI educational guidance system 100. Additionally, the AI educational guidance system 100 may be configured to utilize the information collected from the behavior classifier module 599 to further personalize (i.e., make unique) the personalized response(s) transmitted to the user, for instance, based on the course or subject (as a whole), the user's learning history and/or learner data for one or more courses or subjects (e.g., electrical engineering course; a specific topic, such as digital circuits, within electrical engineering; user-specific data for an electrical engineering course, as compared to user-specific data for a humanities or literature course), user-course-time specific data (e.g., user-specific data for a particular course, module, quiz, etc., if taken at 2 am vs 8 am), and user-specific data for a particular learning session (e.g., the user is really hitting their stride now that they're 45 minutes into the experience). In this way, the information received from the behavior classifier module 599 may help the AI educational guidance system 100 generate personalized responses that are more granular in nature and tailored to the one or more behavior classifiers or profiles for the user. In one non-limiting example, the AI educational guidance system 100 may be configured to transmit a short and succinct personalized response to a user during late night hours as compared to mid-morning to early afternoon hours for a chemistry course, based on detecting that the engagement or patience level for the user changes over the course of the day. In other cases, and based on the time of day, the AI educational guidance system 100 may be configured to suggest that a user take a quiz or module associated with a first course (e.g., History of the USSR under Stalin) over a second, different course (e.g., Women's Studies), due to the wide variance in scores, academic performance, engagement level, etc., when the second course is taken at a particular time of day, day of week, etc. Additionally, or alternatively, the AI educational guidance system 100 may determine, based on the information gleaned from the analysis performed by the behavior classifier module 599, that a user's academic performance is more consistent and/or accurate based on the topic, subject, concept, etc., associated with a third course or module taken within a certain time frame (e.g., immediately before, within 4 hours, on the same day, etc.). For instance, a first user may demonstrate more consistent performance results, higher engagement level, better academic performance, etc., when they take quizzes or modules related to courses that have minimal to no relation with each other (e.g., literature course on the writings of Ayn Rand, followed by a calculus course). Alternatively, a second, different user may demonstrate more consistent performance results when they take quizzes or modules related to courses that are within the same general field (e.g., math and sciences, but not literature or the arts), even though the quizzes may have little to no overlap. In still other cases, the AI educational guidance system 100 may be configured to suggest that the user modify their interactions (e.g., because the user is starting to rush) or their metacognition (e.g., because the user is trending toward being more overconfident).

In addition to the above, the personalized responses generated by the AI educational guidance system 100 for the same user may optionally harness different cognitive scientific learning principles, based on the behavior classification or profile for that user.

It should be noted that the examples listed above with regards to the behavior classifier module 599 and its role in optimizing the personalized responses generated by the AI educational guidance system 100 are exemplary only and not intended to limit the scope and/or spirit of the disclosure.

In some embodiments, one or more of the modules depicted in FIG. 5 may be optional (shown as optional by the dashed lines). Furthermore, the modules in FIG. 5 may be implemented using hardware, software, or a combination thereof. In some cases, the modules in FIG. 5 may be similar or substantially similar to one or more of the modules discussed in relation to FIG. 1 above.

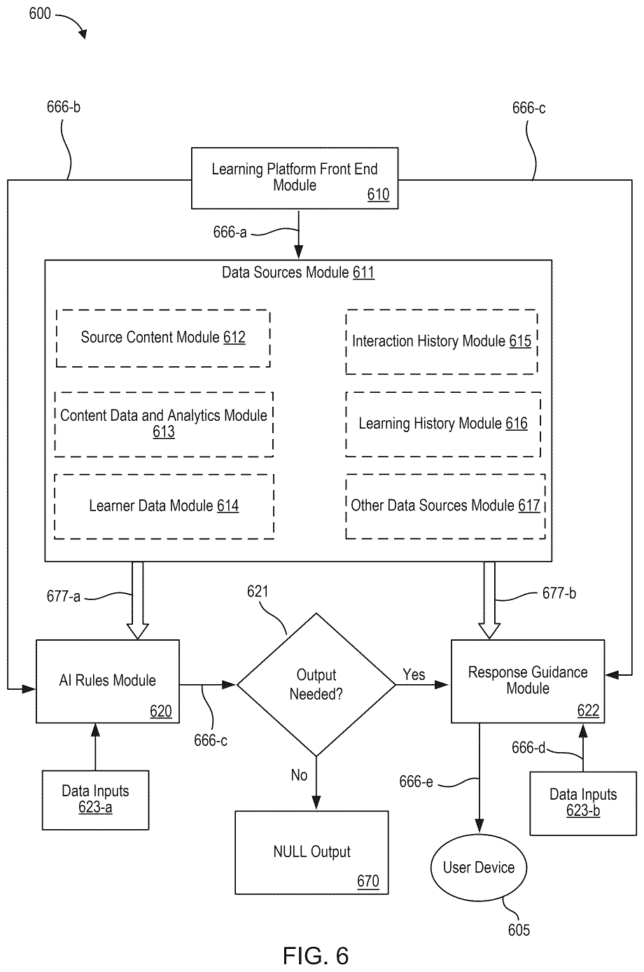

Turning now to FIG. 6, which illustrates an example of a process flow 600, according to various aspects of the disclosure.

In some embodiments, the learning platform front end module 610 is configured to identify a new front end state (FES) and transmit information related to the new FES to one or more of the data sources module 611, AI rules module 620, and response guidance (RG) module 622 via dataflows 666-a, 666-b, and 666-c, respectively.

Dataflows 666-a and 666-b are used to convey the information from the learning platform front end module 610 to the AI rules module 620 and response guidance module 622, respectively. For example, the learning platform front end module 610 may provide at least a portion of the learning platform front end information to each of the AI rules module 620 and response guidance module 622, respectively, where the learning platform front end information may be similar or substantially similar to the learning platform front end information discussed above in relation to FIG. 5.

In some embodiments, the AI rules module 620 is also configured to receive information from data sources module 611, as shown by arrow 677-a. Additionally, the response guidance module 622 is configured to receive information from data sources module 611, as shown by arrow 677-b. In some embodiments, the data sources 611 may include information related to source content 612, content data and analytics 613, learner data 614, interaction history 615, learning history 616, and/or any other applicable data sources 617.

Furthermore, the AI rules module 620 can also receive one or more data inputs 623-a, further described below with reference to FIG. 8. In some cases, the response guidance module 622 can also receive one or more data inputs 623-b via dataflow 666-d, further described below with reference to FIG. 8.

Decision operation 621 comprises utilizing the information received from AI rules module 620 to determine whether a personalized output/response is needed. If yes, the response guidance module 622 is configured to generate a personalized response/output using one or more of the information provided by the data sources 611, the information received from the learning platform front end module 610, and/or data inputs 623-b. Additionally, the response guidance module 622 is configured to transmit the personalized response to the user device 605 via dataflow 666-e. Alternatively, if the decision operation 621 determines that no output response is needed, the flowchart 600 proceeds to operation 670 (NULL Output). As used herein, the term “NULL Output” refers to the lack of a personalized response transmitted to the user device. In other words, the system refrains from (or suppresses) transmitting a personalized response in response to receiving a user dataset (e.g., a user dataset related to a user interaction with the UI) from the user device.

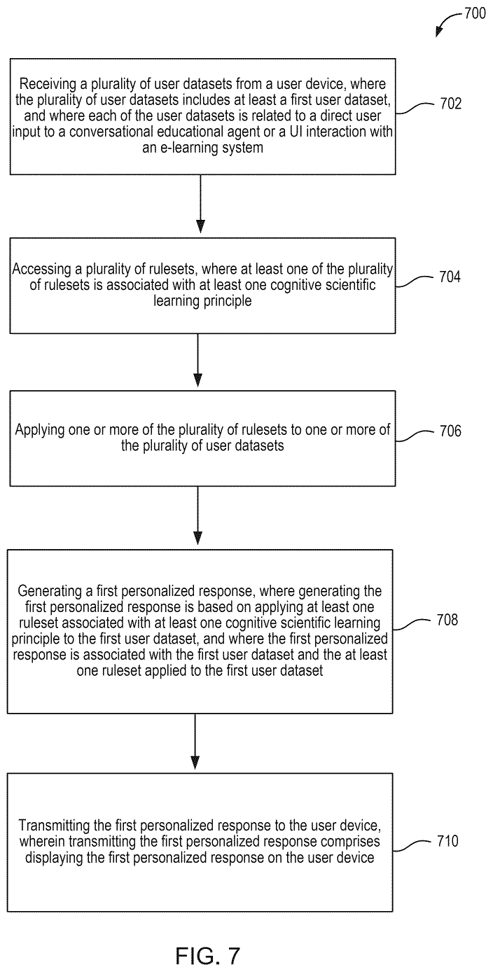

FIG. 7 illustrates an example of a method 700 for guiding learning using cognitive scientific learning principles, in accordance with various aspects of the present disclosure. The operations of method(s) 700 presented below are intended to be illustrative. In some implementations, method 700 may be accomplished with one or more additional operations not described, and/or without one or more of the operations discussed. Additionally, the order in which the operations of method 700 are illustrated in FIG. 7 and/or described below is not intended to be limiting.

In some implementations, method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700.

A first operation 702 comprises receiving a plurality of user datasets from a user device, where the plurality of user datasets includes at least a first user dataset, and where each of the user datasets is related to a direct user input to a conversational educational agent or a UI interaction with an e-learning system, such as, but not limited to, the e-learning system 225 in FIG. 2A.

A second operation 704 comprises accessing a plurality of rulesets, where at least one of the plurality of rulesets is associated with at least one scientific learning principle (e.g., a cognitive scientific learning principle), and where the at least one cognitive scientific learning principle comprises one or more of a spacing effect, a pretesting effect, a delayed corrective feedback effect, a retrieval practice effect, an interleaving effect, and a generation effect. It should be noted that other types of cognitive scientific learning principles are contemplated in different embodiments, and the examples listed herein are not intended to limit the scope and/or spirit of the present disclosure.

A third operation 706 comprises applying one or more of the plurality of rulesets to one or more of the plurality of user datasets.

A fourth operation 708 comprises generating a first personalized response, where generating the first personalized response is based on applying at least one ruleset associated with at least one cognitive scientific learning principle to the first user dataset, and where the first personalized response is associated with the first user dataset and the at least one ruleset applied to the first user dataset.

A fifth operation 710 comprises transmitting the first personalized response to the user device. In one non-limiting example, transmitting the first personalized response comprises displaying the first personalized response on the user device. It should be noted that transmitting the first personalized response to the user device need not be limited to displaying the first personalized response (e.g., in the form of text) on the user device. For instance, in some embodiments, transmitting the first personalized response may result in an audio and/or video output being played on the user device, transmitting a voice message to the user device, placing a phone call to the user device, and/or printing or faxing the first personalized response via a printer or fax machine communicatively coupled to the user device. Other techniques known or contemplated in the art for transmitting the first personalized response to the user device can be utilized in different embodiments without limiting the scope and/or spirit of the present disclosure.

FIG. 8 illustrates an example of a schematic diagram 800 showing a plurality of data inputs 823, according to various aspects of the present disclosure. In some examples, the data inputs 823 (e.g., data inputs 823-a, data inputs 823-b) may be similar or substantially similar to the data inputs 623-a and 623-b described above with reference to FIG. 6. In some aspects, the illustration in FIG. 8 is a more detailed view of the AI rules module 620, decision operation 621, response guidance module 622, data inputs 623-a, and data inputs 623-b, described above in relation to FIG. 6.

As seen, the block diagram 800 comprises an AI rules module 880 and a response guidance module 882. The AI rules module 880 is configured to receive data inputs 823-a, where the data inputs 823-a comprise fine tuning data 808 and cognitive science data 818. In some implementations, the AI rules module 880 may also comprise an optional response model 847-a, described in further detail below. In this example, the AI rules module 880 is configured to receive the fine tuning data 808 via dataflow 888-a, and the cognitive science data 818 via dataflow 888-b. Furthermore, response guidance module 882 (or RG module 882) is configured to receive one or more of: fine tuning data 828 (also referred to as fine tuning constraints 828) via dataflow 888-c, cognitive science data 838 (also referred to as cognitive science constraints 828) via dataflow 888-d, prompt engineering data 848 (also referred to as prompt engineering constraints 848) via dataflow 888-e, retrieval augmented generation data 858 (also referred to as RAG data 858) via dataflow 888-f, and tone data (also referred to as tone constraints 868, tone constraints data 868, tone guidance constraints 868, or even tone adjustments 868) via dataflow 888-g. It should be noted that the fine tuning data 808 received by the AI rules module 880 may be the same as or different from the fine tuning data 828 received by the response guidance module 882. Additionally, or alternatively, the cognitive science data 818 received by the AI rules module 880 may be the same as or different from the cognitive science data 838 received by the response guidance module 882.

As used herein, fine tuning may include providing fine tuning data 828 to the AI educational guidance system (e.g., system 100), where providing the fine tuning data 828 comprises providing a response model 847 of the RG module 882 with a plurality of examples of utterances, personalized responses, outputs, etc. In some embodiments, one or more of the RG module 882 and the response model 847-b may be associated with the AI educational guidance system. As shown in FIG. 8, the response guidance module 882 of the system (e.g., system 100) may be configured to receive the fine tuning data 828 via dataflow 888-c, where the fine tuning data 828 may include a plurality of examples of personalized responses, utterances, etc. In this way, the AI educational guidance system, such as system 100, can be configured to provide a more optimized personalized response to support a user's long-term retention of educational material and a user's ability to apply educational concepts when required. Furthermore, the fine tuning data 828 can also serve to provide the AI educational guidance system with a plurality of rulesets that are specific to determining whether a personalized response (e.g., personalized response transmitted to the user 883 via dataflow 888-h) is required or not. For instance, fine tuning data 808 provided to the AI rules module 880 may include information related to example rulesets and example user datasets as well as information related to whether a personalized response should be generated or not when one or more example rulesets are applied to an example user dataset. In this way, the AI educational guidance system, such as system 100, can be configured to determine whether a personalized response should be generated or not for user datasets received in the future. In some embodiments, the AI rules module 880 is configured to apply one or more rulesets to a user dataset to determine whether a personalized response (e.g., personalized response transmitted to the user 883 via dataflow 888-h) should be generated in response to receiving the user dataset For example, AI rules module 880 may transmit information to a module e.g., response determination module 104 and/or ruleset module 102) using dataflow 899, where the module is configured to effectuate the operations of decision block 881. At decision block 881, the system may determine that no output or personalized response is needed, in which case the method 800 comprises suppressing generating an output (as shown by the NULL Output 884).

In some other cases, the decision block 881 may output an indication to the RG module 882 that an output or personalized response should be transmitted to the user 883 associated with the user device (e.g., user device 605 in FIG. 6). As shown in FIG. 8, the personalized response may be transmitted to the user 883 (shown and described as user device 605 with reference to FIG. 6), where the personalized response or output is transmitted via dataflow 888-h (or communication link 888-h). Thus, in some aspects, a personalized response is associated with a user dataset and one or more rulesets, as the application of the one or more rulesets to the user dataset enables the system to determine whether a personalized response is appropriate for a particular scenario.

In some instances, providing such examples (i.e., examples of rulesets, datasets, utterances, personalized responses, and/or outputs) can facilitate training of the response model 847-b and assist the AI educational guidance system (e.g., system 100) in talking/chatting with the learner and making appropriate decisions when faced with specific scenarios. As an example, the response model 847-b of the RG module 882 may be provided with a plurality of examples (e.g., 20 examples, 50 examples, etc.) of appropriate language to display on the user device when the user arrives on the “Welcome to this module” page. Such a design may enable the AI educational guidance system (e.g., system 100) to display Welcome Messages that have certain language qualities or attributes (e.g., polite, friendly, non-offensive, effective, and/or concise) when a user starts a new module. In another example, the response model 847-b may be provided with a plurality of example responses for scenarios when the AI educational guidance system should transmit unsolicited responses (i.e., personalized responses that are sent absent of any direct chat message or text input from the user).

As noted above, in some embodiments, the AI rules module 880 may include an optional response model 847-a, that can be configured to determine whether (or not) a personalized response should be generated and transmitted to the user. In one such implementation, the response model 847-a of the AI rules module 880 may be provided with a plurality of scenarios/instances where the AI educational guidance system should refrain from generating and transmitting a personalized response to the user device (e.g., despite identifying a user interaction with the UI displayed on the user device). For instance, the AI educational guidance system may be configured to remain silent (i.e., refrain from generating and transmitting a personalized response to the user device, or suppress transmitting a personalized response) when the user simply clicks on a “Next Question” button to proceed from the 2nd to the 3rd question on a ten (10) question module and when the guidance system 100 has detected that the user is engaged with the UI. In such cases, the AI rules module 880 may transmit, via dataflow 899, an indication that no personalized response may be needed.

In some embodiments, the AI rules module 880 may not include the response model 847-a, in which case the response model 847-b of the RG module 882 may be configured to determine whether the AI educational guidance system should transmit or suppress transmitting a personalized response to the user device. Similar to the optional response model 847-a, the response model 847-b of the RG module 882 may be provided with a plurality of scenarios/instances where the AI educational guidance system should refrain (i.e., NULL output 884) from generating and transmitting a personalized response to the user device (e.g., despite identifying a user interaction with the UI displayed on the user device). For instance, the AI educational guidance system may be configured to remain silent (i.e., refrain from generating and transmitting a personalized response to the user device, or suppress transmitting a personalized response) when the user simply clicks on a “Next Question” button to proceed from the 2nd to the 3rd question on a ten (10) question module and when the guidance system 100 has detected that the user is engaged with the UI.

In other cases, however, the AI educational guidance system may be configured to generate and transmit a personalized response to the user device when the user clicks on a “Next Question” button to proceed from the 2nd to the 3rd question on a ten (10) question module and guidance system 100 has detected that the user is not engaged with the UI. As previously noted, the guidance system 100 can be configured to detect a user's engagement with the UI using timestamp data, although other techniques (e.g., detecting via a camera whether the user is looking at the screen, detecting via a camera and/or microphone whether the user is talking to someone else, monitoring keystroke patterns) are also contemplated in different embodiments.

In some examples, cognitive science data 818 provided to the AI rules module 880 may include cognitive science related data that can help the AI rules module 880 automatically and/or autonomously generate rulesets for applying to user datasets. As noted above, the guidance system 100 (or a module of the guidance system 100) is configured to access a plurality of rulesets upon receiving a user dataset, where one or more of the rulesets is associated with at least one cognitive science learning principle. In other words, the cognitive science data 838 provided to the RG module 882 and/or response model 847 can assist in generation of personalized responses that are based on cognitive science (or scientific learning principles), which can help in long-term retention of information, as compared to prior art systems that may or may not be based on cognitive science. In some implementations, the AI rules module 880 may also be configured to rely on other types of data, such as, but not limited to, fine tuning data 808. For instance, the AI rules module 880 (or the AI educational guidance system 100) can be configured to inferentially or autonomously generate one or more additional rulesets, where each of the one or more additional rulesets may be based on at least one example user dataset.

In some examples, retrieval augmented generation data 858 can be provided to the RG module 882 and/or response model 847, which can enable the RG module 882 to make data vectors from the educational content. In some cases, data vectors produced from the educational content may assist the guidance system 100 in referencing educational content/source material when deciding what portion of the educational content should be discussed next. In some examples, each of the plurality of data vectors may be associated with a portion (or chunk) of the educational content.

In some cases, prompt engineering data 848 (or AI prompt engineering data 848) provided to the RG module 882 may assist in the generation of AI prompts, which in turn can assist the AI module in generating the personalized responses, utterances, outputs, etc., that are provided by the RG module 882 for display on the user device. In some aspects, AI Prompt Engineering (or Prompt Engineering) refers to the process of generating one or more prompts for the AI module, where each of the one or more prompts include constraints for restricting (or even suppressing) the response/output generated by the AI module. In some examples, the prompt engineering data 848 provided to the RG module 882 can assist the RG module 882 in generating AI prompts along with their constraints, which can then be used to generate the personalized response displayed on the user device 605.

As noted above, in some instances, generating the personalized response is based on generating at least one AI prompt, where generating the at least one AI prompt comprises providing one or more constraints to the AI module. In such cases, the AI module can provide one or more intermediary responses for the one or more constraints. Furthermore, generating the personalized response may be based in part on concatenating the plurality of intermediary responses. In some cases, the one or more constraints may be associated with at least one scientific learning principle. Said another way, aspects of the present disclosure are directed to constraining Artificial Intelligence (AI) or Large Language Models (LLMs) to behave in a way that is more consistent with scientific learning principles (or cognitive science learning principles), which can help optimize user learning, as compared to prior art systems employing LLMs or other generative AI components/modules without such constraints. In doing so, the communication (e.g., personalized responses/utterances) transmitted to the user can facilitate long-term information retention for the user, as well as optimize the user's ability to transfer and apply learned concepts to related situations in the future.

Tone data 868 may serve to ensure that the personalized response generated by the guidance system 100 may have an appropriate tone (e.g., polite, polite but stern, friendly, and enthusiastic, friendly, and verbose, friendly but not verbose, to name a few) that is suitable for the user dataset. For example, as noted above, the personalized response generated by the guidance system 100 may differ based on the user dataset, since there is not one personalized response that is appropriate for all scenarios. In some cases, the personalized response may be more or less verbose depending on whether brand_new_learner==0 or 1, prev_module_experience==0 or 1, to name two non-limiting examples.

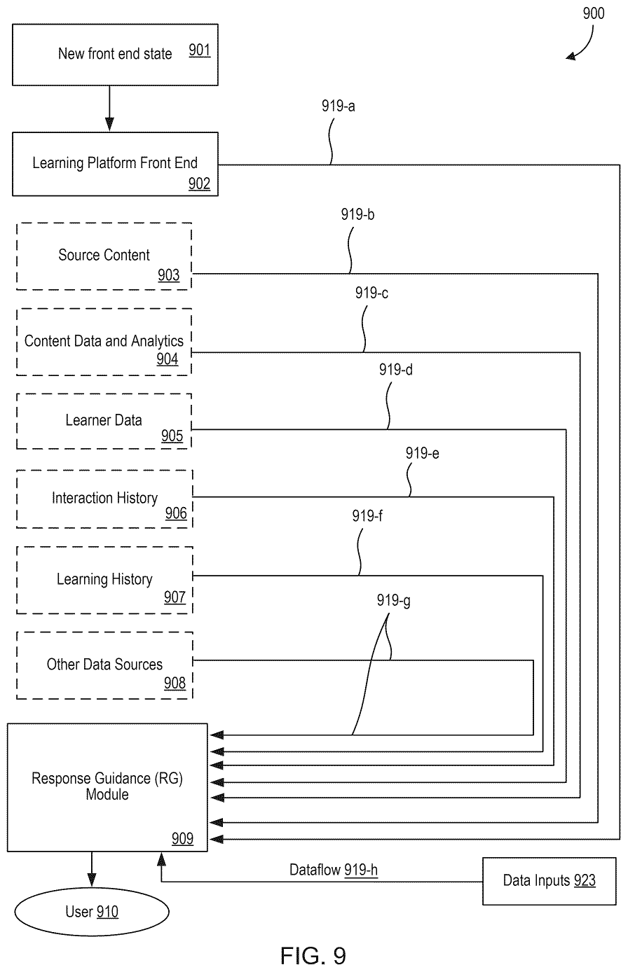

FIG. 9 illustrates an example of a block diagram 900 showing an RG module 909 receiving a plurality of data inputs, according to various aspects of the disclosure. In some embodiments, block diagram 900 implements one or more aspects of the block diagrams 500 and/or 600 described above with reference to FIGS. 5 and/or 6, respectively. In some embodiments, the RG module 909 may also implement one or more aspects of the RG module 882 described above in relation to FIG. 8. While not shown in FIG. 9, in some implementations, the RG module 909 may comprise a response model, where the response model may be similar or substantially similar to the response model 847-b described in relation to FIG. 8. In some examples, the RG module 909 may transmit a personalized response to the user 910, as described herein and elsewhere throughout the disclosure.

In some embodiments, after a new front end state (FES) is reached at operation 901, the RG module 909 is configured to receive information from one or more of the: learning platform front end module 902 via dataflow 919-a, source content module 903 via dataflow 919-b, content data and analytics module 904 via dataflow 919-c, learner data module 905 via dataflow 919-d, interaction history module 906 via dataflow 919-e, and learning history module 907 via dataflow 919-f. Additionally, the RG module 909 may also receive information from one or more other data sources 908 via dataflow 919-g and data inputs 923 via dataflow 919-h, where the data inputs 923 may be similar to the data inputs 823-a and/or 823-b described above. As can be appreciated, the RG module 909 need not receive information from all of the data sources (i.e., learning platform front end 902, source content 903, content data and analytics 904, learner data 905, interaction history 906, learning history 907, and other data sources 908) depicted in FIG. 9. In other words, one or more of the data sources depicted in FIG. 9 may be optional in some embodiments. Furthermore, as shown in FIG. 9, the RG module 909 may also be configured to receive a plurality of data inputs 923, where the data inputs 923 may be similar or substantially similar to the data inputs 823 discussed in relation to FIG. 8. Some non-limiting examples of data inputs 923 may include fine tuning data (e.g., fine tuning data 808, fine tuning data 828), cognitive science data (e.g., cognitive science data 818, cognitive science data 838), prompt engineering data (e.g., prompt engineering data 848), retrieval augmented generation data (e.g., RAG data 858), and tone data (e.g., tone data 868). However, other types of data inputs are contemplated in different embodiments and the examples listed herein are not intended to limit the scope and/or spirit of the present disclosure.

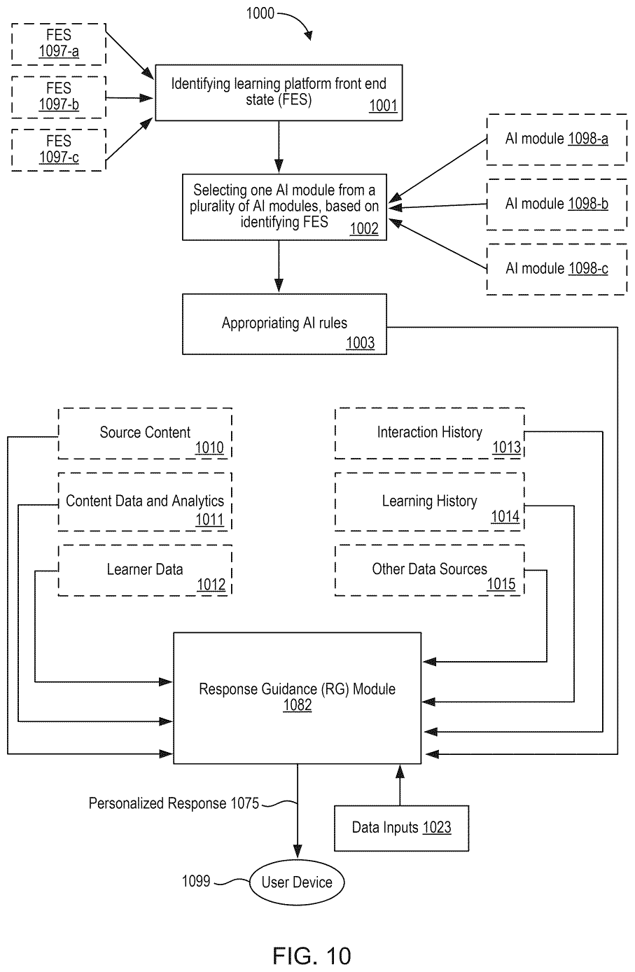

FIG. 10 illustrates an example of a process flow 1000, according to various aspects of the disclosure. In some embodiments, a plurality of AI modules may be utilized, one AI module for each front-end state (FES). As noted above, different types of FESs can be identified by the guidance system 100. Some non-limiting examples of FESs can comprise module introduction FES (or module intro FES), before question display FES, before question is answered FES, after answer is selected FES, after submission of answer is attempted FES, after answer is submitted FES, when static content (or a page) is displayed FES, next page FES, transition to explanation FES, reveal explanation FES, and module outro FES, to name a few non-limiting examples.

As shown in FIG. 10, the process flow 1000 comprises determining a learning platform FES (operation 1001). A second operation 1002 of the process flow 1000 comprises using an AI selector to select an AI module from a plurality of AI modules, where selecting the AI module is based on identifying the learning platform FES. For example, the AI module 1098-a may be associated with a first FES 1097-a, the AI module 1098-b may be associated with a second FES 1097-b, and the AI module 1098-c may be associated with a third FES 1097-c. In such cases, if the learning platform FES identified at operation 1001 is FES 1097-a, the AI selector is configured to select the AI module 1098-a, and so on.

Next, a third operation 1003 comprises selecting appropriate AI rules to a response guidance module of the AI educational guidance system (e.g., system 100).

The RG module 1082 may be similar or substantially similar to the RG modules described in relation to FIGS. 6, 8, and/or 9. The RG module 1082 may receive information related to one or more of source content 1010, content data and analytics 1011, learner data 1012, interaction history data 1013, learning history data 1014, and other data sources 1015. The RG module 1082 also receives information from data inputs 1023 (similar or substantially similar to data inputs 823-a and/or 823-b described in relation to FIG. 8).

The RG module 1082 is configured to generate and transmit the personalized response 1075 to the user device 1099.

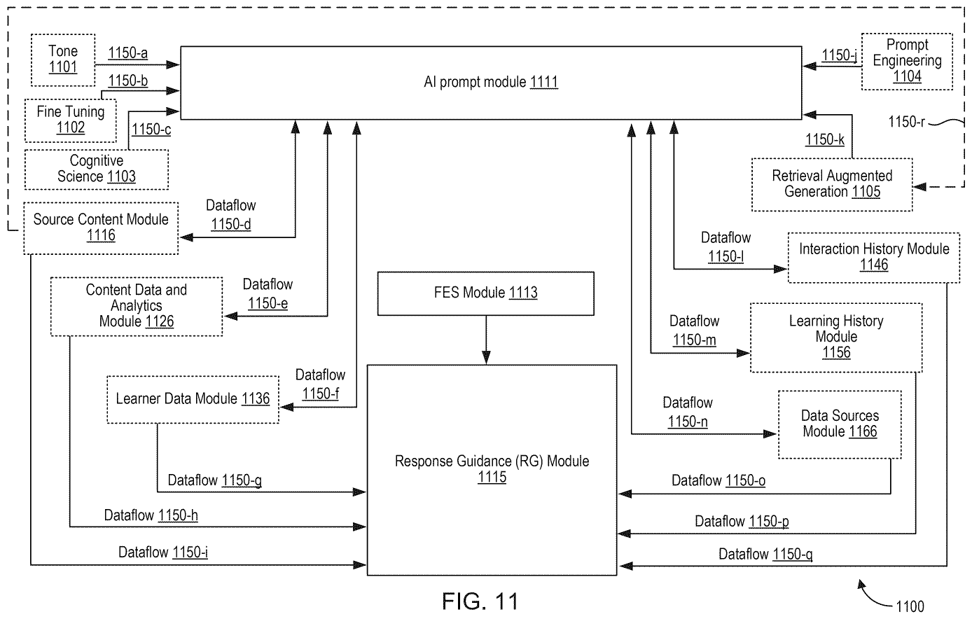

FIG. 11 illustrates an example of a block diagram 1100, according to various aspects of the disclosure.

In this example, FIG. 11 shows a FES module 1113, a response guidance module 1115, and an AI prompt module 1111, where the AI prompt module 1111 may be similar or substantially similar to the AI prompt module 113 described above in relation to FIG. 1. The AI prompt module 1111 may receive a plurality of data inputs via a plurality of dataflows (DFs), such as tone data 1101 via DF 1150-a, fine tuning data 1102 via DF 1150-b, cognitive science data 1103 via DF 1150-c, prompt engineering data 1104 via DF 1150-j, and/or retrieval augmented generation (RAG) data 1105 via DF 1150-k. The plurality of data inputs depicted in FIG. 11 may implement one or more aspects of the data inputs 823-a and 823-b, described above with reference to FIG. 8.

In some embodiments, the AI prompt module 1111 may be electronically, logically, and/or communicatively coupled to a plurality of modules of an AI educational guidance system (e.g., AI educational guidance system 100 in FIG. 1). For example, the AI prompt module 1111 may be configured to receive data from one or more of: source content module 1116 via DF 1150-d, content data and analytics module 1126 via DF 1150-e, and learner data module 1136 via DF 1150-f.

In some embodiments, retrieval augmented generation (RAG) module 1105 may be configured to receive data from source content module 1116 via dataflow 1150-r. In some examples, the RAG module 1105 may be configured to process and store, or simply store, the data received from the source content module 1116. Furthermore, the RAG module 1105 may relay the RAG data to the AI prompt module 1111 via dataflow 1150-k, as shown in FIG. 11.

Furthermore, the RG module 1115 may be in communication with one or more of the: source content module 1116 using DF 1150-i, content data and analytics module 1126 using DF 1150-h, learner data module 1136 using DF 1150-g, data sources module 1166 using DF 1150-o, learning history module 1156 using DF 1150-p, and interaction history module 1146 using DF 1150-q. It should be noted that the DFs 1150-g, 1150-h, 1150-o, 1150-p, and 1150-q may be similar or substantially similar to DFs 506-b through 506-f described above in relation to FIG. 5. The learning history module 1156 may be in communication with AI prompt module 1111 using dataflow 1150-m. The interaction history module 1146 may be in communication with AI prompt module 1111 using dataflow 1150-l. The data sources module 1166 may be in communication with AI prompt module 1111 using dataflow 1150-n.

In some embodiments, the AI prompt module 1111 may be a part of the RG module 1115. In other cases, however, the AI prompt module 1111 may be a separate component, as shown in FIG. 11. The AI prompt module 1111 may be configured for prompt input/shaping (i.e., generate an AI prompt) based on receiving one or more of the tone data 1101, fine tuning data 1102, cognitive science data 1103, prompt engineering data 1104, and/or retrieval augmented generation data 1105. In some examples, prompt input/shaping may be further based on communications with one or more of the modules (e.g., source content module 1116, content data and analytics module 1126, learner data module 1136, interaction history module 1146, learning history module 1156, and/or data sources module 1166).

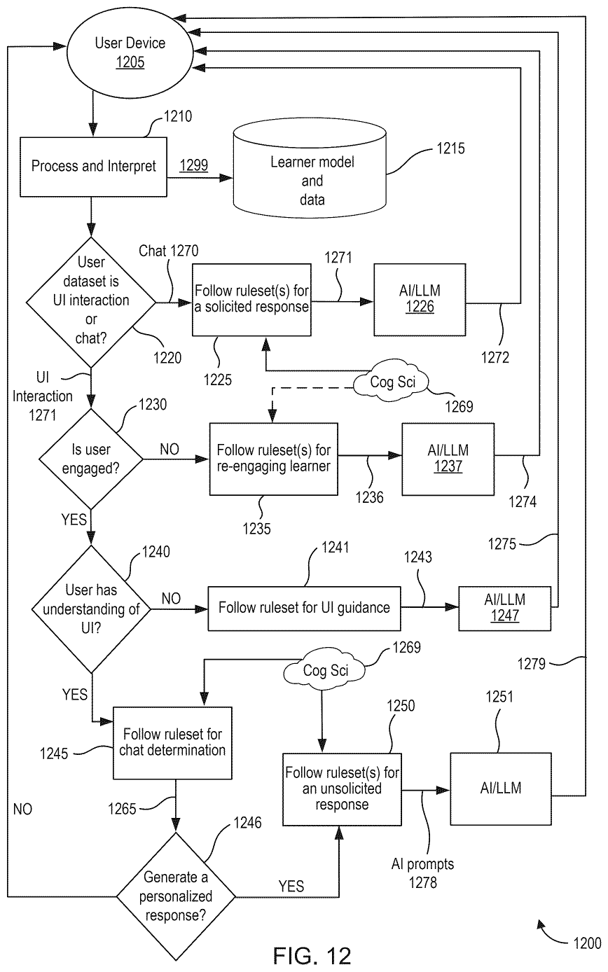

FIG. 12 illustrates an example of a process flow 1200, according to various aspects of the disclosure.

A first operation comprises receiving one or more user datasets from a user device (1205), where each of the user datasets is related to a direct user input to a conversational educational agent, or a user interaction with a UI associated with an e-learning system.

A second operation (1210) comprises processing and interpreting each of the one or more user datasets. In some instances, information related to the learner, as well as their progress in the educational module or course may be stored in at least one database, such as a learner model database 1215. As shown in FIG. 12, the information related to the learner and progress may be input and stored in the learner model database 1215 via dataflow 1299.

Decision operation (1220) comprises determining, for each one of the one or more user datasets, whether the user dataset is related to a chat message (e.g., a direct user input to a conversational educational agent) or an action (e.g., a user interaction with the UI). If the user dataset is related to a chat message/conversational input, as shown by arrow 1270, the process flow proceeds to operation 1225. Operation 1225 comprises following/executing one or more rulesets for generating a prompt to an AI/LLM system 1226 (or any other applicable AI-based system, genAI system, LLM-based system, Large-Knowledge-Model-based system, or a system employing a combination of LLM and a Knowledge Model, to name a few non-limiting examples), where the prompt (or AI prompt) is related to generating a solicited response. In some examples, at least one of the one or more ruleset(s) may be related to a cognitive scientific learning principle 1269. In such cases, information related to the cognitive scientific learning principle(s) 1269 may be utilized in generating the AI prompt, where the AI prompt may be generated upon determining that a user dataset is related to a chat message. Additionally, the output from operation 1225 may be relayed to the LLM 1226 via dataflow 1271. The LLM 1226 may utilize the AI prompt received via dataflow 1271 and output a personalized response 1272, where the personalized response 1272 is transmitted to the user device 1205 for display on the user device.

In some other cases, the AI educational guidance system, such as system 100 or system 1700, may identify that the user data is related to a user interaction with a UI associated with the e-learning system (shown by UI interaction 1271). In such cases, the process flow 1200 proceeds to determination operation 1230, where determination operation 1230 comprises determining whether the user is engaged with one or more of: the UI associated with the e-learning system (e.g., e-learning system 225, e-learning system 1725); the overall educational experience provided by the e-learning system and/or the AI educational guidance system; or the educational content (e.g., freshman level biology course). If the AI educational guidance system determines that the user is not engaged with the e-learning system (e.g., user is randomly selecting answer choices instead of fully reading and understanding the question displayed on the user device, which may be detected based on timestamp data), the process flow 1200 proceeds to operation 1235.

Operation 1235 comprises re-engaging the learner using one or more personalized responses, auditory cues (or audio outputs), visual cues (or visual outputs displayed on the user device), or any other applicable techniques. For example, as shown in FIG. 12, operation 1235 comprises following one or more ruleset(s) for re-engaging the learner. Specifically, but without limitation, operation 1235 comprises following/executing one or more ruleset(s) for generating a prompt, such as an AI prompt, to an AI/LLM system 1237 (or any other applicable AI-based system, LLM-based system, Large-Knowledge-Model-based system, or a system employing a combination of LLM and a Knowledge Model, to name a few non-limiting examples). Optionally, at least one of the one or more rulesets (shown as optional by the dashed arrow from 1269 to 1235) for re-engaging the learner may be related to a cognitive scientific learning principle 1269. In such cases, information related to the cognitive scientific learning principle(s) 1269 may be utilized in generating the AI prompt, where the AI prompt may be generated based on following the one or more ruleset(s) for re-engaging the learner. Additionally, the output (e.g., the AI prompt) from operation 1235 may be relayed to the AI/LLM 1237 via dataflow 1236. The AI/LLM 1237 may utilize the AI prompt received via dataflow 1236 and output a personalized response 1274, where the personalized response 1274 is transmitted to the user device 1205 and subsequently communicated to the user associated with the user device 1205. In some embodiments, the output of the AI/LLM 1237 may be in the form of a personalized response (i.e., personalized response 1274), and may be configured for display on the user device. Alternatively, the personalized response 1274 may include an audio signal for playback through an audio source (or audio output) connected to the user device, a video signal for playback through an internal video output source of the user device and/or an external video output source coupled to the user device, or through any other means. In one non-limiting example, the personalized response 1274 (i.e., the personalized response transmitted using dataflow 1274) may be specifically designed to guide the user back-on-track to re-engage with the learning material. In some cases, transmitting the personalized response 1274 may comprise transmitting an audio signal that can be played through an audio output device (e.g., speakers, headsets) implemented within or connected to the user device. The audio signal may also be designed to assist with back-on-track guidance of the user with the learning material. In yet other cases, back-on-track guidance can be implemented by displaying one or more images, videos, etc., on the user device. As an example, the user may be able to take a short break (e.g., 3-5 minutes, 10-15 minutes, to name two non-limiting examples) from the learning material by viewing a video, playing an interactive game (e.g., built into the e-learning system), or through any other means, which can also help assist in re-engaging the user with the e-learning system. In some cases, the user may be guided to other types (e.g., videos associated with the educational course or module) of educational content than the type (e.g., quiz) they are currently accessing, which can also help with back-on-track guidance.

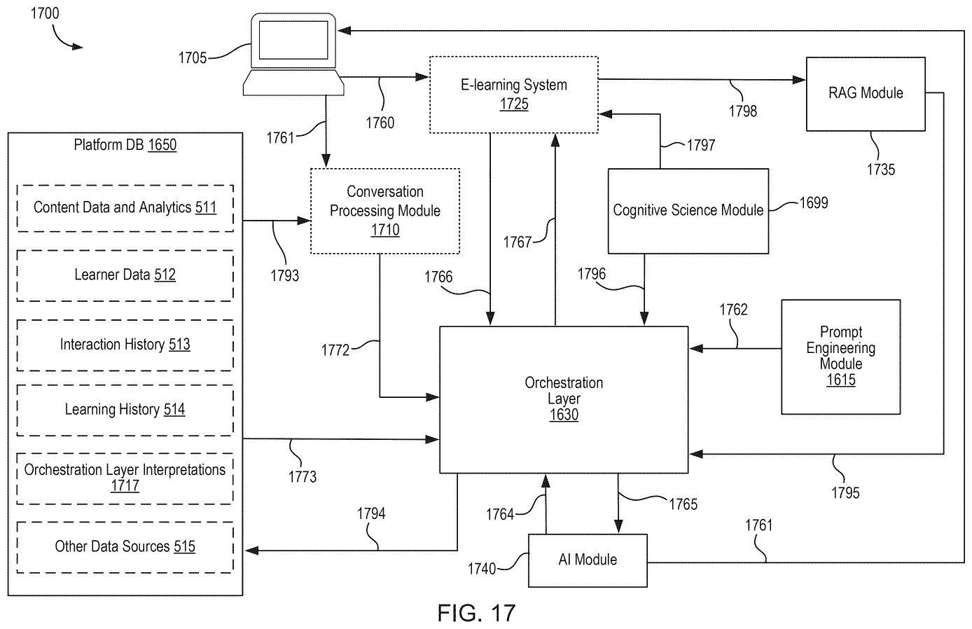

If the user is engaged with the e-learning system, the process flow 1200 proceeds to decision block 1240. At decision block 1240, the AI educational guidance system is configured to determine whether the user understands or is familiar with the UI associated with the e-learning system (e.g., e-learning system 1725 in FIG. 17). If not, the system is configured to provide UI guidance related information to the user associated with the user device 1205, where providing UI guidance related information may comprise following at least one ruleset for UI guidance. In some cases, the output of operation 1241 may comprise transmitting an AI prompt to AI/LLM 1247 using dataflow 1243. Additionally, the AI/LLM 1247 may be configured to generate and transmit a personalized response to the user device 1205, where the personalized response is transmitted to the user device 1205 using dataflow 1275. In some instances, the personalized response transmitted via dataflow 1275 pertains to providing the user with UI guidance. In some cases, the UI guidance may be implemented using a video tutorial, an audio tutorial, and/or through any other applicable means known or contemplated in the art.

Next, if the user understands and/or is familiar with the UI associated with the e-learning system, the guidance system (e.g., the AI educational guidance system 100 in FIG. 1) is configured to follow one or more ruleset(s) for determining whether to converse or chat with the user (operation 1245). As used herein, following one or more ruleset(s) includes accessing the one or more rulesets and then executing (e.g., using one or more hardware processors configured with machine-readable instructions) the one or more rulesets. One or more of the rulesets utilized for the chat determination operation (1245) may be associated with cognitive scientific learning principles 1269 (or cog sci principles 1269).

In some cases, the AI educational guidance system relays the information determined from execution of operation 1245 to decision block 1246 using dataflow 1265. Decision block 1246 comprises determining whether to generate a personalized response (i.e., the chat message). In some examples, operation 1245 and decision block 1246 may be combined into a single decision block. If YES, process flow 1200 proceeds to operation 1250, where operation 1250 comprises following one or more ruleset(s) for generating an unsolicited response. Here, as well, one or more of the rulesets for generating the unsolicited response may be associated with at least one cognitive scientific learning principle 1269.

In some examples, the at least one cognitive scientific learning principle 1269 may comprise a plurality of cognitive scientific learning principles (or cog sci principles), a plurality of sets of cog sci principles (i.e., each set including at least one cog sci principle), or a combination thereof. In some embodiments, the cog sci principle(s) associated with operation 1245 and operation 1250 may be different and/or may be associated with different sets of cog sci principles. Similarly, the cog sci principle(s) associated with operation 1225 and operation 1235 may be different and/or may be associated with different sets of cog sci principles. In some examples, the different sets of cog sci principles may include entirely different cog sci principles. Alternatively, two or more sets of cog sci principles may have at least one cog sci principle in common.

Process flow 1200 then proceeds to providing one or more AI prompts 1278 to the AI/LLM 1251 for generating and transmitting the personalized response 1279 to the user device 1205. In some embodiments, the personalized response is an unsolicited personalized response (i.e., since the response is generated based on the user dataset being related to a user interaction with the UI, as opposed to a direct user input to the conversational educational agent).

Conversely, if the output of decision block 1246 is NO, process flow 1200 may loop back to the first operation and the process described above in relation to FIG. 12 may repeat one or more times. In some embodiments, the AI educational guidance system 100 can optionally suppress generating and transmitting (i.e., refrain from transmitting) an unsolicited personalized response to the user device 1205 prior to looping back to the first operation.

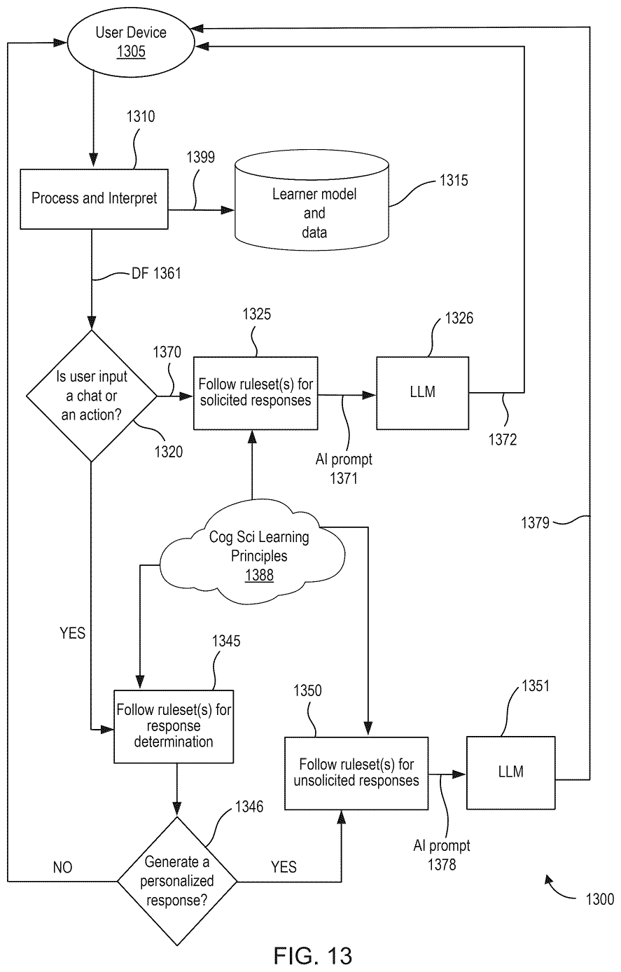

FIG. 13 illustrates another example of a process flow 1300, according to various aspects of the disclosure.

As used herein, the terms “Large Language Model,” “LLM”, “generative AI”, and “genAI” may be used interchangeably throughout the disclosure. For example, LLM 1351 may be referred to as genAI 1351, in some embodiments.

A first operation comprises receiving one or more user datasets from a user device (1305), where each of the user datasets is related to a direct user input to a conversational educational agent, or a user interaction with a UI associated with an e-learning system.

A second operation (1310) comprises processing and interpreting each of the one or more user datasets. In some instances, information related to the user/learner, as well as their progress in the educational module or course, may be stored in at least one database, such as a learner model database 1315. As shown in the FIG. 13, the information related to the learner and progress may be input and stored in the learner model database 1315 via dataflow 1399. Additionally, operation 1310 may also include transmitting the processed and interpreted information related to the user dataset(s) to a module (e.g., user dataset module 101 and/or user input identification module 105 in FIG. 1), where the module is configured to effectuate the actions associated with decision operation (1320), as described below.

Decision operation (1320) comprises determining, for each one of the one or more user datasets, whether the user dataset is related to a chat message (e.g., a direct user input to a conversational educational agent) or an action (e.g., a user interaction with the UI). If the user dataset is related to a chat message/conversational input, as shown by arrow 1370, the process flow proceeds to operation 1325. Operation 1325 comprises following/executing one or more rulesets for generating an AI prompt 1371 to the LLM 1326, where the AI prompt 1371 is related to generating a solicited response. In some examples, at least one of the one or more ruleset(s) may be related to at least one of the plurality of cognitive scientific learning principles 1388. In such cases, the cognitive scientific learning principle(s) 1388 may be utilized to generate the AI prompt 1371. In this example, the AI prompt 1371 may be generated upon determining that a user dataset is related to a chat message. The LLM 1326 (also referred to as genAI 1326) utilizes the AI prompt 1371 received via the output of operation 1325 and outputs a personalized response 1372, where the personalized response 1372 is transmitted to the user device 1305 for output (e.g., video output, audio output, text or chat message, to name a few non-limiting examples) on the user device 1305, or to another device (e.g., headphones, monitor, etc.) connected to the user device 1305.

In some other cases, the AI educational guidance system (e.g., system 100 in FIG. 1) may identify that the user dataset is related to a user interaction with a UI associated with the e-learning system.

Next, the AI educational guidance system is configured to follow one or more ruleset(s) for determining whether to converse or chat with the user (operation 1345). As used herein, following one or more ruleset(s) includes accessing the one or more rulesets and then executing the one or more rulesets (e.g., using one or more hardware processors configured with machine-readable instructions). One or more of the rulesets utilized for the chat determination operation (1345) may be associated with the cognitive scientific learning principles 1388.

Decision block 1346 comprises determining whether to generate a personalized response (e.g., a chat message). In some examples, operation 1345 and decision block 1346 may be combined into a single decision block. If yes, process flow 1300 proceeds to operation 1350, where operation 1350 comprises following one or more ruleset(s) for generating an unsolicited response. Here, as well, one or more of the rulesets for generating the unsolicited response may be associated with at least one cognitive scientific learning principle of the cognitive scientific learning principles 1388.

Process flow 1300 then proceeds to providing one or more AI prompts 1378 to the LLM 1351 (also referred to as genAI 1351) for generating and transmitting the personalized response 1379 to the user device 1305. In some embodiments, the personalized response is an unsolicited personalized response (i.e., since the response is generated based on the user dataset being related to a user interaction with the UI, as opposed to a direct user input to the conversational educational agent).

Conversely, if the output of decision block 1346 is NO, process flow 1300 may loop back to the first operation and the process described in relation to FIG. 13 may repeat one or more times, as depicted. In some embodiments, the AI educational guidance system 100 can optionally suppress generating and transmitting (i.e., refrain from transmitting) an unsolicited personalized response to the user device 1305 prior to looping back to the first operation.

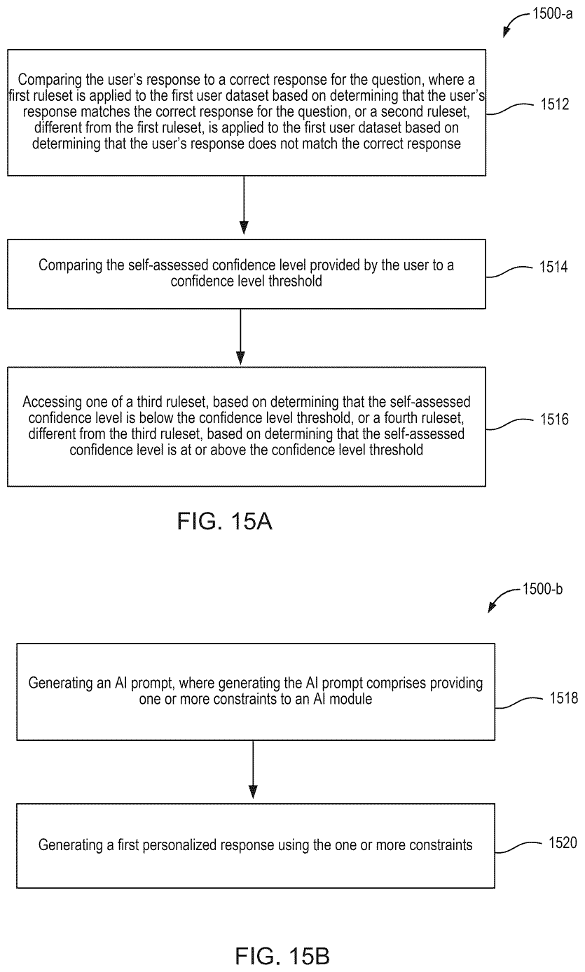

Turning now to FIGS. 15A and 15B, which illustrate method(s) 1500 for guiding learning using cognitive scientific learning principles, in accordance with various aspects of the present disclosure. The operations of method(s) 1500 presented below are intended to be illustrative. In some implementations, method(s) 1500 may be accomplished with one or more additional operations not described, and/or without one or more of the operations discussed. Additionally, the order in which the operations of method(s) 1500 are illustrated in FIGS. 15A and 15B described below is not intended to be limiting.

In some implementations, method(s) 1500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method(s) 1500 in response to instructions stored electronically on an electronic storage medium. The one or more processing devices may include one or more devices configured through hardware, firmware, and/or software to be specifically designed for execution of one or more of the operations of method(s) 1500.

FIG. 15A illustrates an example of a computer-implemented method 1500-a for guiding learning using cognitive scientific learning principles, in accordance with various aspects of the disclosure.

As described above in relation to at least FIG. 1, in some embodiments, each of the plurality of user datasets (e.g., received at operation 702 in FIG. 7) may be associated with one of: (1) a user responding to a question, (2) the user answering a question, (3) the user incorrectly answering a question, (4) the user correctly answering a question, (5) the user submitting an answer to a question, (6) the user providing a self-assessed confidence level for an answer choice selected by the user, (7) the user providing a self-assessed confidence level for a set of answer choices selected by the user, or (8) the user providing an off-topic input, wherein the off-topic input is unrelated to one or more of a learning module displayed on the user device, a question displayed on the user device, a pre-defined topic, and the e-learning system.

In this example, the plurality of user datasets received from the user device may comprise a first user dataset and a second user dataset. Furthermore, the first user dataset may be associated with a user's response to a question displayed on the user device, and the second user dataset of the plurality of user datasets may be associated with a self-assessed confidence level provided by the user, based on the user's response to the question. It should be noted that the first and the second user datasets described above may be different in different embodiments, and the examples described with relation to FIG. 15A are exemplary only.

As seen in FIG. 15A, a first operation 1512 of method 1500-a comprises comparing the user's response to a correct response for a question. In some instances, a first ruleset is applied to a first user dataset based on determining that the user's response matches the correct response to the question. Alternatively, a second ruleset, different from the first ruleset, is applied to the first user dataset based on determining that the user's response does not match the correct response.

A second operation 1514 of method 1500-a comprises comparing the self-assessed confidence level provided by the user to a confidence level threshold.

A third operation 1516 comprises accessing one of a third ruleset, based on determining that the self-assessed confidence level is below the confidence level threshold, or a fourth ruleset, different from the third ruleset, based on determining that the self-assessed confidence level is at or above the confidence level threshold.

In some implementations, the first personalized response (e.g., first personalized response generated at operation 708 in FIG. 7) is further associated with the second user dataset, where the second user dataset is associated with the self-assessed confidence level provided by the user. Furthermore, the first personalized response is also associated with (1) one of the first ruleset or the second ruleset, and (2) one of the third ruleset or the fourth ruleset.

FIG. 15B illustrates an example of a computer-implemented method 1500-b for guiding learning using cognitive scientific learning principles, in accordance with various aspects of the disclosure.

Operation 1518 of method 1500-b comprises generating an AI prompt, where generating the AI prompt comprises providing one or more constraints to an AI module of the AI educational guidance system.

Operation 1520 comprises generating a first personalized response (e.g., operation 708 in FIG. 7) using the one or more constraints.

In some examples, generating the first personalized response is further based on providing a plurality of constraints to the AI module (e.g., AI module 103 in FIG. 1), where at least one constraint of the plurality of constraints is associated with a cognitive scientific learning principle. In such cases, the AI educational guidance system 100, platform server 201-a, platform server 201-b, and/or AI educational guidance system 1700 may be configured to utilize one or more of the plurality of constraints, including the at least one constraint associated with the cognitive scientific learning principle, to generate the first personalized response.

FIG. 16 illustrates a block diagram 1600 of an AI architecture that can be utilized to implement the AI educational guidance systems 100 and/or 1700 described in relation to FIGS. 1 and/or 17, respectively, in accordance with various aspects of the disclosure.

As seen in FIG. 16, the block diagram 1600 comprises an orchestration layer 1630 that is electrically, logically, and/or communicatively coupled to various other components of the AI architecture. The AI architecture may include a query module 1605, an output module 1610, a prompt engineering module 1615, a cognitive science module 1699, a fine tuning module 1620, an LLM module 1640, an agents and tools module 1645, a platform database 1650, a retrieval augmented generation (RAG) layer 1635, and a front end module 1625. The RAG layer 1635 may include a vector database 1636 (or vector DB 1636) and a learning content module 1637.

The query module 1605 may communicate with the front end module 1625 using communication link 1660.

The front end module 1625 may be configured to communicate with the output module 1610 using communication link 1661.

The front end module 1625 may be in bi-directional communication with orchestration layer 1630 using communication links 1666 and 1667.

The prompt engineering module 1615 may be configured to communicate with the orchestration layer using communication link 1662.

The cognitive science module 1699 may be configured to communicate with the orchestration layer 1630 using communication link 1696. In some embodiments, the cognitive science module 1699 may (optionally) also be in communication with the front end module 1625 using communication link 1691 (shown as optional by the dashed lines).

The fine tuning module 1620 may be configured to communicate with the LLM module 1640 (also referred to as generative AI module 1640, or simply, genAI module 1640) using communication link 1663. In some implementations, the fine tuning module 1620 is configured to provide the LLM module 1640 with fine tuning data (or fine tuning constraints), where the fine tuning data consists of a plurality of examples of utterances, personalized responses, outputs, etc. In this way, the AI educational guidance system, such as system 100, can be configured to provide a personalized response more optimized to support a user's long-term retention of educational material and a user's ability to apply educational concepts when required. As previously noted, fine tuning data (or fine tuning constraints) may also serve to provide the LLM module, such as LLM module 1640, with a plurality of rulesets that are specific to determining whether a personalized response is required or not. Additionally, fine tuning data (e.g., fine tuning data 808, fine tuning data 828) provided by the fine tuning module 1620 to the LLM module 1640 may include information related to example rulesets and example user datasets as well as information related to whether a personalized response should be generated or not when one or more example rulesets are applied to an example user dataset. In this way, the AI educational guidance system, such as system 100, can be configured to determine whether a personalized response should be generated or not for user datasets received in the future.

The LLM module 1640 may be in bi-directional communication with the orchestration layer 1630 using communication links 1664 and 1665. Additionally, the LLM module 1640 may also be in bi-directional communication with the agents and tools module 1645 using communication links 1668 and 1669.

Besides the LLM module 1640, the agents and tools module 1645 may be in bi-directional communication with the orchestration layer 1630 using communication links 1672 and 1673, as well as the platform database (DB) 1650 using communication links 1674 and 1675. The agents & tools module 1645 may be configured to determine learner or user sentiment, retrieve learner history from the platform DB 1650, retrieve content data from the platform DB 1650, retrieve interaction history from the platform DB 1650, and/or determine a current state (e.g., a current front-end state or FES).

In some embodiments, the front end module 1625 module may be configured to receive query-related information (e.g., a user query, such as “Could you help me understand the correct answer?”) from the query module 1605 via communication link 1660. Additionally, the front end module 1625 may be configured to transmit an output to the output module 1610, where the output is in response to the query received from the query module 1605. One non-limiting example of an output that may be displayed by the output module 1610 on the user device may be a text output (e.g., “I see you chose the first answer choice . . . but did you consider the third answer choice?”).

As shown in FIG. 16, the vector DB 1636 may be in bi-directional communication with the learning content module 1637 using communication links 1676 and 1677. The vector DB may also be in communication with the orchestration layer 1630 using communication link 1670, while the learning content module 1637 may be in communication with the orchestration layer 1630 using communication link 1671.

In some examples, the orchestration layer 1630 serves to orchestrate and manage the data communicated by the disparate modules of the AI educational guidance system using the various communication links shown in FIG. 16. The orchestration layer may be configured to transmit the final AI prompt to the LLM module 1640 (also referred to as AI/LLM module 1640 or genAI module 1640, in some embodiments) using communication link 1665, where the final AI prompt is used to generate the final version of the personalized response transmitted to the user device.

FIG. 17 illustrates a block diagram 1700 of a system implementation of the AI architecture described in relation to FIG. 16, in accordance with various aspects of the present disclosure.

As seen, FIG. 17 shows an orchestration layer 1630, a platform DB 1650, a user device 1705, an e-learning system 1725, a RAG module 1735, an AI module 1740, a prompt engineering module 1615, a cognitive science module 1699, and a conversation processing module 1710. The orchestration layer 1630, platform DB 1650, prompt engineering module 1615, and AI module 1740 may be similar or substantially similar to the orchestration layer 1630, platform DB 1650, prompt engineering module 1615, and LLM module 1640 described above in relation to FIG. 16. Additionally, the e-learning system 1725 may be similar or substantially similar to the e-learning system 225 described above in reference to FIG. 2A. Furthermore, the RAG module 1735 may implement one or more aspects of the RAG layer 1635 described above with reference to FIG. 16.

In this example, the platform DB 1650 is configured to transmit data related to one or more content data and analytics 511, learner data 512, interaction history data 513, and learning history data 514 to the conversation processing module 1710 using communication link 1793. The platform DB 1650 is also configured to transmit data related to one or more of content data and analytics 511, learner data 512, interaction history data 513, and learning history data 514 to the orchestration layer 1630 using communication link 1773. In some embodiments, the platform DB 1650 may also transmit data related to orchestration layer interpretations 1717, as well as data collected from one or more other data sources 515 to the conversation processing module 1710 and orchestration layer 1630 using communication links 1793 and 1773, respectively. It should be noted that the content data and analytics 511, learner data 512, interaction history data 513, and learning history data 514 may be similar or substantially similar to the ones described above with reference to FIG. 5. In some embodiments, the platform DB 1650 may also receive data related to one or more of training feedback, AI prompts, and conversations from the orchestration layer 1630 (also referred to as orchestration module 1630, in some embodiments) via communication link 1794.

The conversation processing module 1710 may receive conversational input data (e.g., a user dataset related to a direct user input to a conversational educational agent) from user device 1705 using communication link 1761. Additionally, the conversation processing module 1710 is configured to transmit data related to one or more of user/learner behavior (e.g., whether the user is randomly guessing answer choices), a confidence level of the user, and/or a correctness level for the user (e.g., what proportion of questions is the user answering correctly vs incorrectly) to the orchestration layer 1630 using communication link 1772.

The user device 1705 may be configured to transmit user input data (e.g., a user dataset related to a user interaction with a UI associated with the e-learning system) to the e-learning system 1725 using communication link 1760.

Similar to the conversation processing module 1710, the e-learning system 1725 is also configured to transmit data related to one or more of user/learner behavior (e.g., whether the user is randomly guessing answer choices), a confidence level of the user, and/or a correctness level for the user (e.g., what proportion of questions is the user answering correctly vs incorrectly) to the orchestration layer 1630 using communication link 1766. Additionally, the orchestration layer 1630 may transmit UI-specific data (e.g., appearance of a button on the UI associated with the e-learning system) to the e-learning system 1725 via communication link 1767. The e-learning system 1725 is also configured to receive rulesets and heuristics-related data from the cognitive science module 1699 via communication link 1797. Furthermore, the cognitive science module 1699 may also transmit rulesets and heuristics-related data to the orchestration layer 1630 using communication link 1796. In some implementations, the e-learning system 1725 is configured to transmit content related data to the RAG module 1735 using communication link 1798.

The RAG module 1735 may be configured to transmit rapidly searchable vectors to the orchestration layer 1630 using communication link 1795.

The orchestration layer 1630 and AI module 1740 (or language generating AI module/system 1740) may be in bi-directional communication. For example, the AI module 1740 may be configured to receive an AI prompt from the orchestration layer 1630 using communication link 1765 and may be configured to transmit a conversational output to the orchestration layer 1630 using communication link 1764. In some instances, the AI module 1740 is also configured to transmit the conversation output (e.g., personalized response) to the user device 1705 using communication link 1761, which allows the personalized response to be displayed on the user device 1705.

In some embodiments, the prompt engineering module 1615 may transmit one or more AI prompt modifications to the orchestration layer 1630 using communication link 1762, where the AI prompt modifications may be used to modify the actual AI prompt sent from the orchestration layer 1630 to the AI module 1740.

In some aspects, the system implementation and AI architecture described in relation to FIGS. 16 and 17 may facilitate one or more of: (1) the cognitive science algorithm to help guide the learner/user through a structured adaptive learning process, (2) assisting the orchestration layer 1630 in informing the AI tutor of learner content (i.e., intersection of knowledge, confidence, and effort), (3) providing structured and dynamic prompts to the AI tutor, (4) implementing one or more retrieval augmented generation or RAG layers, and (5) implementing a closed feedback loop between the user device and the AI educational guidance system, which allows feedback of user-system conversation data to the orchestration layer, which in turn can assist in optimizing future algorithm dynamics. In some cases, with regards to (3) above, providing structure and dynamic AI prompts to the AI tutor may comprise providing scenario and behavior specific prompts. For example, a first scenario may comprise determining whether the learner is guessing or understands the educational material (i.e., Doubtful but Right). If guessing, the AI prompt may be constructed in such a way that the conversational output transmitted to the user device may be aimed at teaching the learner (e.g., from the basics). If partly accurate, the AI prompt may be constructed in such a way that the conversational output transmitted to the user device may be aimed at guiding the learner with the portions of the learning material that they are missing or have not fully grasped yet. If the learner has full mastery or knowledge of the learning material, the AI prompt may be constructed in such a way that the conversational output transmitted to the user device may be aimed at reinforcing the learner's confidence.

FIG. 18 illustrates an example of a user interface (UI) 1800, where the UI 1800 can be utilized in conjunction with one or more of an AI educational guidance system and/or an e-learning system, according to various aspects of the disclosure.

The UI 1800 may be accessed using a user device. As noted above, a user device can also be referred to as a user equipment (UE), a computing device, a computing platform, a computing system, a remote computing platform, or a personal computing device, to name a few non-limiting examples. For example, a user device used to access the UI 1800 may implement one or more aspects of the computer system 1400 described below in relation to FIG. 14. Some non-limiting examples of user devices may include laptops, desktop computers, smartphones, tablet computers (e.g., with only Wi-Fi capabilities, with both Wi-Fi and cellular technology, such as 4G or 5G capabilities), All-In-One Computers, Netbooks, and Chromebooks. In some embodiments, the UI 1800 can be accessed using a variety of web browsers (e.g., Safari, Google Chrome, Opera Mobile) installed on different types of user devices (e.g., MacBook by Apple, a Toshiba laptop running Windows 11, and a Samsung Galaxy S24 Ultra running the Android mobile operating system (OS)) with different wired and/or wireless communication capabilities.

As noted above, the AI educational guidance system, such as AI educational system 100 in FIG. 1, is configured to receive a plurality of user datasets from a user device (e.g., remote platform 144 in FIG. 1). FIGS. 2A and 2B also depict user devices relaying user datasets to the respective platform servers. For example, FIG. 2A depicts the platform server 201-a receiving user dataset(s) from a user device 205-c via an e-learning system 225 and communication link 251-c. Additionally, FIG. 2B depicts the platform server 201-b directly receiving one or more user dataset(s) from a user device 205-g using communication link 251-f.

In the example shown in FIG. 18, the UI 1800 comprises a navigation bar 1810, where the navigation bar 1810 may include a plurality of buttons (not shown for sake of simplicity of illustration), such as, but not limited to, a back button, a forward button, a close window button, a minimize window button, a maximize window button, a pause button (e.g., if the user is taking a timed quiz), a resume button, and any other applicable buttons. It should be noted that the navigation bar 1810 (also referred to as navigation tab 1810) may also include status information (e.g., to indicate that the user is 25% of the way through the learning experience) and/or links to other sub-sections within the educational course, module, quiz, exam, etc., in some embodiments.

In this example, the UI 1800 displays an information box 1804, where the information box 1804 includes information related to the educational task (e.g., Learning: Round 2, regarding the topic “Sepsis”) for the user. The UI 1800 also includes a question window 1803, where the question window is used to display a question for the user. In some embodiments, the question presented within the question window 1803 is associated with or related to the educational task displayed within the information box 1804.

The UI 1800 further displays an answer window 1837. In this example, the answer window 1837 displays a plurality of answer choices 1805 and the question presented within the question window 1803 is formed as a multiple-choice question, however this is not intended to be limiting. For instance, the answer choices 1805 includes a first answer choice (i.e., “Resuscitation with up to 30 ml/kg crystalloid fluid) that can be selected using a first radio button 1820-a, a second answer choice (i.e., ”Insertion of central IV access for measurement of venous pressure and O₂ saturation.) that can be selected using a second radio button 1820-b, a third answer choice (i.e., “Initiation of a vasopressor to achieve SBP>90 mm Hg”) that can be selected using a third radio button 1820-c, and a fourth answer choice (i.e., “I don't know yet”) that can be selected using a fourth radio button 1820-d. In this case, the user has selected the second answer choice by selecting (e.g., clicking, tapping, etc.) the second radio button 1820-b (the dark shading of radio button 1820-b is meant to illustrate the selection of that second answer choice).

As shown on the right side in FIG. 18, the UI 1800 further includes a direct user input window 1806, where the direct user input window 1806 comprises a plurality of radio buttons. When selected, the audio radio button 1833 enables the user to directly converse (e.g., using audio or speech input) with the system or platform (e.g., AI educational guidance system 100 in FIG. 1, platform server 201-a, platform server 201-b) of the present disclosure. In some embodiments, the AV radio button 1843 enables the AI educational guidance system to receive one or more user datasets from the user device, where user datasets include both audio and video information. In some cases, the AV radio button 1843 may include a video data feed from a webcam, a video data feed from a smartphone camera, a pre-recorded video, etc., from the user device. In other cases, the user may select the AV radio button 1843 to transmit user datasets comprising screenshare data and audio data overlayed over the screenshare data from their user device. In either case, the UI 1800 serves as a front-end interface of the system or platform and is configured to receive a plurality of inputs (e.g., user datasets), where each of the user datasets is related to a direct user input to a conversational educational agent or a UI interaction with an e-learning system. For example, the user selection of the second answer choice (e.g., by clicking on radio button 1820-b) may be an example of a UI interaction with an e-learning system. Similarly, the user selecting one of the previous question button 1817 or the next question button 1819 may also be examples of UI interactions with the e-learning system, and thereby, examples of user datasets. In some implementations, these UI interactions (e.g., a user selecting an answer) result in a new front end state (e.g., a question displayed with an answer choice selected). Additional details on front end states are described at least in relation to FIG. 3.

In this instance, the user has selected a text radio button 1853, which allows the user to chat or converse with the AI educational guidance system 100 (or the conversational educational agent 231 and/or 271, described above in relation to FIGS. 2A and/or 2B) using a chat window 1807 of the UI 1800. As shown, the chat window 1807 depicts a text box 1816 that is configured to receive a direct user input or learner input, where the direct user input or learner input is a text message, a chat message, etc. Additionally, the chat window 1807 also includes a transmit message button 1815, which allows the user to transmit the text input or chat message to the AI educational guidance system. The chat window 1807 displays a plurality of personalized responses (PRs), including a first PR 1808-a, a second PR 1808-b, and a third PR 1808-c. Additionally, the chat window 1807 also displays a first direct user input 1810-a and a second direct user input 1810-b. In some cases, the first PR 1808-a may be an unsolicited PR. Alternatively, the first PR 1808-a may be a PR generated and transmitted by the AI educational guidance system in response to a previously received direct user input (not shown in chat window 1807). In some cases, PR 1808-b and PR 1808-c may be generated and transmitted by the AI educational guidance system in response to receiving the direct user input 1810-a and 1810-b, respectively.

It should be noted that the UI 1800 depicted in FIG. 18 is exemplary only and not intended to limit the scope and/or spirit of the present disclosure. That is, other variants and/or configurations of the UI are contemplated in different embodiments. In some examples, the visual appearance or look of the UI may vary based on the front end state, type of user device, educational course, module, quiz, practice assignment, user's familiarity level with the UI (if applicable), display screen size (e.g., 7 inch tablet, 32 inch wide-screen monitor), aspect ratio, mobile or desktop website, mobile or desktop app, and/or network connection strength (e.g., some UI display elements, such as high-def video, may be unavailable if network speed or bandwidth is below a threshold, such as 50 mbps, 100 mbps, etc.), to name a few non-limiting examples.

FIG. 14 illustrates a diagrammatic representation of one embodiment of a computer system 1400, within which a set of instructions can execute for causing a device to perform or execute any one or more of the aspects and/or methodologies of the present disclosure. Specifically, but without limitation, the computer system 1400 is configured for guiding user learning using cognitive scientific learning principles, in accordance with one or more implementations. The components in FIG. 14 are examples only and do not limit the scope of use or functionality of any hardware, software, firmware, embedded logic component, or a combination of two or more such components implementing embodiments of this disclosure. Some or all of the illustrated components can be part of the computer system 1400. For instance, the computer system 1400 can be a general-purpose computer (e.g., a laptop computer) or an embedded logic device (e.g., an FPGA), to name just two non-limiting examples.

Moreover, the components may be realized by hardware, firmware, software, or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 1400 includes at least a processor 1401 such as a central processing unit (CPU) or a graphics processing unit (GPU) to name two non-limiting examples. Any of the subsystems described throughout this disclosure could embody the processor 1401. The computer system 1400 may also comprise a memory 1403 and a storage 1408, both communicating with each other, and with other components, via a bus 1440. The bus 1440 may also link a display 1432, one or more input devices 1433 (which may, for example, include a keypad, a keyboard, a mouse, a stylus, etc.), one or more output devices 1434, one or more storage devices 1435, and various non-transitory, tangible computer-readable storage media 1436 with each other and/or with one or more of the processor 1401, the memory 1403, and the storage 1408. All of these elements may interface directly or via one or more interfaces or adaptors to the bus 1440. For instance, the various non-transitory, tangible computer-readable storage media 1436 can interface with the bus 1440 via storage medium interface 1426. Computer system 1400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers. In some implementations, the terms “non-transitory, tangible computer-readable storage media,” “non-transitory, tangible computer-readable storage medium,” “non-transient, tangible computer-readable storage media,” and “non-transient, tangible computer-readable storage medium,” may be used interchangeably throughout the disclosure.

Processor(s) 1401 (or central processing units (CPUs)) optionally contains a cache memory unit 1402 for temporary local storage of instructions, data, or computer addresses. Processor(s) 1401 are configured to assist in execution of computer-readable instructions stored on at least one non-transitory, tangible computer-readable storage medium. Computer system 1400 may provide functionality as a result of the processor(s) 1401 executing software embodied in one or more non-transitory, tangible computer-readable storage media, such as memory 1403, storage 1408, storage devices 1435, and/or storage medium 1436 (e.g., read only memory (ROM) 1405). Memory 1403 may read the software from one or more other non-transitory, tangible computer-readable storage media (such as mass storage device(s) 1435, 1436) or from one or more other sources through a suitable interface, such as network interface 1420. Any of the subsystems herein disclosed could include a network interface such as the network interface 1420. The software may cause processor(s) 1401 to carry out one or more processes or one or more steps of one or more processes described or illustrated herein, such as the process flows and methods described in relation to FIGS. 3, 4, 6, 7, 9-13, and/or 15A-15B. Carrying out such processes or steps may include defining data structures stored in memory 1403 and modifying the data structures as directed by the software. In some embodiments, an FPGA can store instructions for carrying out functionality as described in this disclosure. In other embodiments, firmware includes instructions for carrying out functionality as described in this disclosure.

The memory 1403 may include various components (e.g., non-transitory, tangible computer-readable storage media) including, but not limited to, a random-access memory component (e.g., RAM 1404) (e.g., a static RAM “SRAM”, a dynamic RAM “DRAM, etc.), a read-only component (e.g., ROM 1405), and any combinations thereof. ROM 1405 may act to communicate data and instructions unidirectionally to processor(s) 1401, and RAM 1404 may act to communicate data and instructions bidirectionally with processor(s) 1401. ROM 1405 and RAM 1404 may include any suitable non-transitory, tangible computer-readable storage media. In some instances, ROM 1405 and RAM 1404 include non-transitory, tangible computer-readable storage media for carrying out a method, such as methods and process flows described with reference to FIGS. 3, 4, 6, 7, 9-13, and/or 15A-15B. In one example, a basic input/output system (BIOS) 1406, including basic routines that help to transfer information between elements within computer system 1400, such as during start-up, may be stored in the memory 1403.

Fixed storage 1408 is connected bi-directionally to processor(s) 1401, optionally through storage control unit 1407. Fixed storage 1408 provides additional data storage capacity and may also include any suitable non-transitory, tangible computer-readable media described herein. Storage 1408 may be used to store operating system 1409, EXECs 1410 (executables), data 1411, API applications 1412 (application programs), and the like. Often, although not always, storage 1408 is a secondary storage medium (such as a hard disk) that is slower than primary storage (e.g., memory 1403). Storage 1408 can also include an optical disk drive, a solid-state memory device (e.g., flash-based systems), or a combination of any of the above. Information in storage 1408 may, in appropriate cases, be incorporated as virtual memory in memory 1403.

In one example, storage device(s) 1435 may be removably interfaced with computer system 1400 (e.g., via an external port connector (not shown)) via a storage device interface 1425. Particularly, storage device(s) 1435 and an associated machine-readable medium may provide nonvolatile and/or volatile storage of machine-readable instructions, data structures, program modules, and/or other data for the computer system 1400. In one example, software may reside, completely or partially, within a machine-readable medium on storage device(s) 1435. In another example, software may reside, completely or partially, within processor(s) 1401.

Bus 1440 connects a wide variety of subsystems. Herein, reference to a bus may encompass one or more digital signal lines serving a common function, where appropriate. Bus 1440 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1400 may also include an input device 1433. In one example, a user of computer system 1400 may enter commands and/or other information into computer system 1400 via input device(s) 1433. Examples of an input device(s) 1433 include, but are not limited to, an alpha-numeric input device (e.g., a keyboard), a pointing device (e.g., a mouse or touchpad), a touchpad, a touch screen, and/or a stylus in combination with a touch screen, and any combinations thereof. Input device(s) 1433 may be interfaced to bus 1440 via any of a variety of input interfaces 1423 (e.g., input interface 1423) including, but not limited to, serial, parallel, game port, USB, FIREWIRE, THUNDERBOLT, or any combination of the above.

In particular embodiments, when computer system 1400 is connected to network segment 1430 (or simply, network 1430), computer system 1400 may communicate with other devices, such as mobile devices, IoT devices, servers, and/or enterprise systems, connected to network 1430. Communications to and from computer system 1400 may be sent through network interface 1420. For example, network interface 1420 may receive incoming communications (such as requests or responses from other devices, for instance, user instructions or commands, query requests, etc., from a user device) in the form of one or more packets (such as Internet Protocol (IP) packets) from network 1430, and computer system 1400 may store the incoming communications in memory 1403 for processing. Computer system 1400 may similarly store outgoing communications in the form of one or more packets in memory 1403 and communicated to network 1430 from network interface 1420. Processor(s) 1401 may access these communication packets stored in memory 1403 for processing.

Examples of the network interface 1420 include, but are not limited to, a network interface card, a modem, and any combination thereof. Examples of a network 1430 or network segment 1430 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 1430, may employ a wired and/or a wireless mode of communication. In general, any network topology known and/or contemplated in the art may be used.

Information and data can be displayed through a display 1432. Examples of a display 1432 include, but are not limited to, a liquid crystal display (LCD), an organic liquid crystal display (OLED), a cathode ray tube (CRT), a plasma display, and any combinations thereof. The display 1432 can interface to the processor(s) 1401, memory 1403, and fixed storage 1408, as well as other devices, such as input device(s) 1433, via the bus 1440. The display 1432 is linked to the bus 1440 via a video interface 1422, and transport of data between the display 1432 and the bus 1440 can be controlled via the graphics control 1421.

In addition to a display 1432, computer system 1400 may include one or more other peripheral output devices 1434 including, but not limited to, an audio speaker, a printer, etc. Such peripheral output devices may be connected to the bus 1440 via an output interface 1424. Examples of an output interface 1424 include, but are not limited to, a serial port, a parallel connection, a USB port, a FIREWIRE port, a THUNDERBOLT port, and any combinations thereof.

In addition, or as an alternative, computer system 1400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an integrated circuit or IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory (e.g., RAM 1404), flash memory, ROM memory (e.g., ROM 1405), EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor 1401 (also shown as processor 134 in FIG. 1) such that the processor 1401 can read information from, and write information to, the non-transitory, tangible computer-readable storage medium. In the alternative, the non-transitory, tangible computer-readable storage medium may be integral to the processor 1401. The processor 1401 and the non-transitory, tangible computer-readable storage medium may reside in an ASIC. In some examples, the ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 1400 shown in FIG. 14 such as, but not limited to, the network 1430, processor 1401, memory 1403, etc., may comprise a cloud computing system. In one such system, front-end systems such as input devices 1433 may provide information to back-end platforms such as servers (e.g., computer system(s) 100 and/or 1700, etc.) and storage (e.g., memory 1403). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

Processor 1401, also shown as processor 134 in FIG. 1, may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1401 may be configured to operate a memory array using a memory controller. In other cases, a memory controller may be integrated into the processor. The processor 1401 or processor 134 may be configured to execute computer-readable instructions stored in memory to perform various functions (e.g., functions or tasks supporting guiding user learning using cognitive scientific learning principles, such as, using a conversational educational agent or an e-learning system). Memory 1403, also shown as electronic storage 132 in FIG. 1, may include random access memory (RAM) and read only memory (ROM). The memory may store computer-readable, computer-executable software including instructions that, when executed, cause the processor 1401 to perform various functions described herein. In some cases, the memory may contain, among other things, a basic input/output system (BIOS) which may control basic hardware and/or software operation such as the interaction with peripheral components or devices.

Software may include code to implement aspects of the present disclosure, including code for creating and/or managing an AI educational guidance system using a computing platform (e.g., system 100 in FIG. 1, platform server 201-a described in relation to FIG. 2A, platform server 200-b described in relation to FIG. 2B, and/or system 1700 in FIG. 17). Software may be stored in a non-transitory computer-readable medium such as system memory or other memory. In some cases, the software may not be directly executable by the processor but may cause a computer (e.g., when compiled and executed) to perform functions described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A digital response generation system, comprising:
one or more hardware processors configured by machine-readable instructions to:
train a response generation model using training data comprising:
examples of user inputs and corresponding appropriate responses;
a plurality of rulesets, wherein at least one of the plurality of rulesets is associated with at least one cognitive scientific learning principle and an associated outcome of the at least one cognitive scientific learning principle, and
user interaction historical data indicating effectiveness of different response types;
receive a plurality of user datasets from a user device, wherein the plurality of user datasets includes at least a first user dataset, and wherein each of the plurality of user datasets is related to:
a direct user input to a conversational educational agent; or
a user interaction with a user interface (UI) associated with an electronic learning (e-learning) system, wherein the e-learning system is configured to measure a user's confidence level;
access the plurality of rulesets, wherein the at least one cognitive scientific learning principle comprises one or more of:
a spacing effect,
a pretesting effect,
a delayed corrective feedback effect,
a retrieval practice effect,
an interleaving effect, and
a generation effect;
generate, using the trained response generation model, a first personalized response, by:
identifying one or more cognitive scientific learning principles relevant to the first user dataset;
selecting one or more rulesets of the plurality of rulesets associated with the identified one or more cognitive scientific learning principles relevant to the first user dataset, and
generating response content that implements the selected one or more rulesets of the plurality of rulesets,
wherein the first personalized response is associated with the first user dataset and the selected one or more rulesets of the plurality of rulesets; and
transmit the first personalized response to the user device.

2. The digital response generation system of claim 1, wherein the one or more hardware processors are further configured to receive a plurality of data inputs, wherein each of the plurality of data inputs comprises one of an educational-content-specific dataset or a learner-specific dataset.

3. The digital response generation system of claim 2, wherein the one or more hardware processors are further configured to:
generate additional response content that implements the selected one or more rulesets of the plurality of rulesets, wherein the additional response content is associated with at least one of the plurality of data inputs; and
wherein the first personalized response is further associated with one or more of the educational-content-specific dataset or the learner-specific dataset.

4. The digital response generation system of claim 2, wherein each educational-content-specific dataset includes content data and analytics information for an educational course or educational module, wherein the content data and analytics information comprising one or more of:
learning material for the educational course or the educational module;
a difficulty level for the educational course or the educational module;
a difficulty level per learner module for one or more learner modules associated with the educational course or the educational module;
a difficulty level per question for one or more questions associated with the educational course or the educational module;
a difficulty level per quiz for one or more quizzes associated with the educational course or the educational module;
submission time per question for one or more first-time users of the educational course or educational module; and
submission time per question for one or more repeat users of the educational course or the educational module.

5. The digital response generation system of claim 2, wherein each learner-specific dataset includes information related to one or more of:
a learner history for a user associated with the user device; and
a user interaction history for the user with one or more of the UI, the e-learning system, and the digital response generation system.

6. The digital response generation system of claim 1, wherein the one or more hardware processors are further configured to:
generate a second personalized response associated with a second user dataset, wherein the first personalized response and the second personalized response are associated with different rulesets of the plurality of rulesets.

7. The digital response generation system of claim 1, wherein receiving the plurality of user datasets comprises receiving a second user dataset, and wherein the one or more hardware processors are further configured by machine-readable instructions to:
apply one or more rulesets to the second user dataset; and
suppress generating a personalized response in response to applying the one or more rulesets to the second user dataset.

8. The digital response generation system of claim 1, wherein,
the plurality of user datasets comprises the first user dataset and a second user dataset,
one of the first or the second user dataset is related to a user interaction with the UI associated with the e-learning system,
another of the first or the second user dataset is related to a direct user input to the conversational educational agent,
the user interaction with the UI associated with the e-learning system comprises a user making at least one selection on the user device, and
the direct user input comprises one of:
a textual input from the user device,
an audio input from the user device,
a video input from the user device, or
a screenshare from the user device.

9. The digital response generation system of claim 1, wherein the user device is associated with a user, and wherein the user is one of a new user or a repeat user, and wherein each of the plurality of user datasets is associated with one of:
the user responding to a question; or
the user answering the question; or
the user incorrectly answering the question; or
the user correctly answering the question; or
the user submitting an answer to the question; or
the user providing a first self-assessed confidence level for an answer choice selected by the user; or
the user providing a second self-assessed confidence level for a set of answer choices selected by the user; or
the user providing an off-topic input, wherein the off-topic input is unrelated to one or more of a learning module displayed on the user device, the question displayed on the user device, a pre-defined topic, and the e-learning system.

10. The digital response generation system of claim 9, wherein,
when the first user dataset is associated with a new user accessing a learning module, the first personalized response is associated with a first ruleset, and
when the first user dataset is associated with a repeat user accessing the learning module, the first personalized response is associated with a second ruleset different from the first ruleset.

11. The digital response generation system of claim 9, wherein,
when the first user dataset is associated with the user incorrectly answering the question, the first personalized response is associated with a first ruleset, and
when the first user dataset is associated with the user correctly answering a question, the first personalized response is associated with a second ruleset different from the first ruleset.

12. The digital response generation system of claim 9, wherein the first user dataset is associated with the user's response to the question, and a second user dataset is associated with the first self-assessed confidence level provided by the user, based on the user's response to the question, and wherein the one or more hardware processors are further configured to:
compare the user's response to a correct response for the question, wherein:
a first ruleset is applied to the first user dataset based on determining that the user's response matches the correct response for the question; or
a second ruleset, different from the first ruleset, is applied to the first user dataset based on determining that the user's response does not match the correct response;
compare the first self-assessed confidence level provided by the user to a confidence level threshold; and
access one of:
a third ruleset, based on determining that the first self-assessed confidence level is below the confidence level threshold, or
a fourth ruleset, different from the third ruleset, based on determining that the first self-assessed confidence level is at or above the confidence level threshold; and
wherein the first personalized response is further associated with the second user dataset associated with the first self-assessed confidence level provided by the user, and:
one of the first ruleset or the second ruleset; and
one of the third ruleset or the fourth ruleset.

13. The digital response generation system of claim 9, wherein, when the first dataset is associated with the off-topic input, the first personalized response is associated with a ruleset for re-engaging a learner.

14. The digital response generation system of claim 1, wherein the first user dataset comprises timestamp data.

15. The digital response generation system of claim 14, wherein the timestamp data is associated with a user requesting feedback on educational content within a threshold duration of accessing the educational content, and wherein the at least one cognitive scientific learning principle associated with the first personalized response comprises one or more of the delayed corrective feedback effect and the spacing effect.

16. The digital response generation system of claim 14, wherein the one or more hardware processors are further configured to:
compare the timestamp data to a user disengagement threshold duration; and
access, based on the comparing, a first ruleset for re-engaging a learner, wherein the first personalized response is associated with the first ruleset.

17. The digital response generation system of claim 1, wherein measuring the user confidence level is based at least in part on assessing one or more of:
a plurality of user interactions with educational content displayed via the UI on the user device, and wherein the educational content comprises one or more questions associated with one or more educational courses and educational modules; and
one or more direct user inputs to the conversational educational agent.

18. The digital response generation system of claim 1, wherein generating the first personalized response comprises:
generating an AI prompt, wherein generating the AI prompt comprises providing one or more constraints to an AI module; and
generating the first personalized response using the one or more constraints.

19. The digital response generation system of claim 18, wherein at least one constraint of the one or more constraints is associated with a cognitive scientific learning principle.

20. The digital response generation system of claim 1, wherein generating the first personalized response comprises:
generating an AI prompt, wherein generating the AI prompt comprises providing a plurality of constraints to an AI module, wherein at least one constraint of the plurality of constraints is associated with a cognitive scientific learning principle;
receiving, from the AI module, one or more intermediary responses for the one or more constraints; and
utilizing the one or more intermediary responses to generate the first personalized response.

21. The digital response generation system of claim 20, wherein the one or more intermediary responses comprise a plurality of intermediary responses, and wherein the one or more hardware processors are further configured to:
concatenate the plurality of intermediary responses to generate the first personalized response.

22. The digital response generation system of claim 1, wherein generating the first personalized response is further based at least in part on receiving one or more of:
analytics data for one or more of a question, a quiz, a topic, an educational module, an educational course, a practice assignment, and a practice exam;
interaction history data for a user associated with the user device;
learner history data for the user associated with the user device; and
a UI-understanding level of the user, wherein the UI-understanding level comprises a quantitative score corresponding to a comprehension level of the user with one or more UI elements of UI associated with the e-learning system.

23. A computer-implemented method for guiding learning using cognitive scientific learning principles, the computer-implemented method comprising:
training a response generation model using training data comprising:
examples of user inputs and corresponding appropriate responses:
a plurality of rulesets, wherein at least one of the plurality of rulesets is associated with at least one cognitive scientific learning principle and an associated educational outcome of the at least one cognitive scientific learning principle, and
user interaction historical data indicating effectiveness of different response types:
receiving a plurality of user datasets from a user device, wherein the plurality of user datasets includes at least a first user dataset, and wherein each of the plurality of user datasets is related to:
a direct user input to a conversational educational agent; or
a user interaction with a user interface (UI) associated with an electronic learning (e-learning) system, wherein the e-learning system is configured to measure a user's confidence level;
accessing the plurality of rulesets, wherein the at least one cognitive scientific learning principle comprises one or more of:
a spacing effect,
a pretesting effect,
a delayed corrective feedback effect,
a retrieval practice effect,
an interleaving effect, and
a generation effect;
generating, using the train generation model, a first personalized response, by:
identifying one or more cognitive scientific learning principles relevant to the first user dataset;
selecting one or more rulesets of the plurality of rulesets associated with the identified one or more cognitive scientific learning principles relevant to the first user dataset; and
generating response content that implements the selected one or more rulesets of the plurality of rulesets,
wherein the first personalized response is associated with the first user dataset and the selected one or more rulesets of the plurality of rulesets; and
transmitting the first personalized response to the user device, wherein transmitting the first personalized response comprises at least one of:
displaying the first personalized response on the user device;
providing haptic feedback to a peripheral device coupled to the user device;
playing an audio signal corresponding to the first personalized response via the user device, wherein the audio signal is played back through an audio output component or a speaker coupled to the user device.

24. The computer-implemented method of claim 23, wherein the user device is associated with a user, and wherein the user is one of a new user or a repeat user, and wherein each of the plurality of user datasets is associated with one of:
the user responding to a question; or
the user answering the question; or
the user incorrectly answering the question; or
the user correctly answering the question; or
the user submitting an answer to the question; or
the user providing a first self-assessed confidence level for an answer choice selected by the user; or
the user providing a second self-assessed confidence level for a set of answer choices selected by the user; or
the user providing an off-topic input, wherein the off-topic input is unrelated to one or more of a learning module displayed on the user device, a question displayed on the user device, a pre-defined topic, and the e-learning system.

25. The computer-implemented method of claim 24, wherein the first user dataset is associated with the user's response to the question, and a second user dataset is associated with the self-assessed confidence level provided by the user, based on the user's response to the question, and wherein the computer-implemented method further comprises:
comparing the user's response to a correct response for the question, wherein:
a first ruleset is applied to the first user dataset based on determining that the user's response matches the correct response for the question; or
a second ruleset, different from the first ruleset, is applied to the first user dataset based on determining that the user's response does not match the correct response;
comparing the self-assessed confidence level provided by the user to a confidence level threshold; and
accessing one of:
a third ruleset, based on determining that the self-assessed confidence level is below the confidence level threshold, or
a fourth ruleset, different from the third ruleset, based on determining that the self-assessed confidence level is at or above the confidence level threshold; and
wherein the first personalized response is further associated with the second user dataset associated with the self-assessed confidence level provided by the user, and:
one of the first ruleset or the second ruleset; and
one of the third ruleset or the fourth ruleset.

26. The computer-implemented method of claim 24, wherein,
when the first user dataset is associated with the user incorrectly answering a question, the first personalized response is associated with a first ruleset, and
when the first user dataset is associated with the user correctly answering a question, the first personalized response is associated with a second ruleset different from the first ruleset.

27. The computer-implemented method of claim 23, wherein the first user dataset comprises timestamp data, wherein the timestamp data is associated with a user requesting feedback on educational content within a threshold duration of accessing the educational content, and wherein the at least one cognitive scientific learning principle associated with the first personalized response comprises one or more of the delayed corrective feedback effect and the spacing effect.

28. The computer-implemented method of claim 23, wherein generating the first personalized response is further based on:
generating an Artificial Intelligence (AI) prompt, wherein generating the AI prompt comprises providing a plurality of constraints to an AI module, wherein at least one constraint of the plurality of constraints is associated with a cognitive scientific learning principle; and
utilizing one or more of the plurality of constraints, including the at least one constraint associated with the cognitive scientific learning principle, to generate the first personalized response.

29. The computer-implemented method of claim 23, wherein generating the first personalized response is further based at least in part on receiving one or more of:
analytics data for one or more of a question, a quiz, a topic, an educational module, an educational course, a practice assignment, and a practice exam;
interaction history data for a user with the UI associated with the e-learning system or an Artificial Intelligence (AI) guidance system;
learner history data for the user associated with the user device; and
a UI-understanding level of the user, wherein the UI-understanding level comprises a quantitative score corresponding to a comprehension level of the user with one or more UI elements of UI associated with the e-learning system.

30. A non-transient computer-readable storage medium having instructions embodied thereon, the instructions being executable by one or more processors to perform a method for guiding learning using a digital response generation system employing cognitive scientific learning principles, the method comprising:
training a response generation model using training data comprising:
examples of user inputs and corresponding appropriate responses;
a plurality of rulesets, wherein at least one of the plurality of rulesets is associated with at least one cognitive scientific learning principle and an associated educational outcome of the at least one cognitive scientific learning principle, and
user interaction historical data indicating effectiveness of different response types;
receiving a plurality of user datasets from a user device, wherein the plurality of user datasets includes at least a first user dataset, and wherein each of the plurality of user datasets is related to:
a direct user input to a conversational educational agent; or
a user interaction with a user interface (UI) associated with an electronic learning (e-learning) system, wherein the e-learning system is configured to measure a user confidence level;
accessing the plurality of rulesets, wherein the at least one cognitive scientific learning principle comprises one or more of:
a spacing effect,
a pretesting effect,
a delayed corrective feedback effect,
a retrieval practice effect,
an interleaving effect, and
a generation effect;
generating, using the trained response generation model, a first personalized response, by:
identifying one or more cognitive scientific learning principles relevant to the first user dataset;
selecting one or more rulesets of the plurality of rulesets associated with the identified one or more cognitive scientific learning principles relevant to the first user dataset; and
generating response content that implements the selected one or more rulesets of the plurality of rulesets,
wherein the first personalized response is associated with the first user dataset and the selected one or more rulesets of the plurality of rulesets; and
transmitting the first personalized response to the user device, wherein transmitting the first personalized response comprises displaying the first personalized response on the user device.
